(19) United States
(12) Patent Application Publication
(10) Pub. No.: US 2007/0112671 A1
(43) Pub. Date: May 17, 2007

(54) Transaction management system and method

(75) Inventor: Nicholas David Wingham Rowan, London (GB)

Correspondence Address: BROOKS KUSHMAN P.C., 1000 TOWN CENTER, TWENTY-SECOND FLOOR, SOUTHFIELD, MI, 48075, US

(73) Assignee: GUARANTEED MARKETS LTD, London (GB)

(21) Appl. No.: 10/596,571

(22) PCT Filed: Dec. 7, 2004
(86) PCT No.: PCT/GB04/05126

§ 371 Date: Jun. 16, 2006

(30) Foreign Application Priority Data
Dec. 17, 2003 (GB) 0329203.4

(51) Int. Cl. G06Q 40/00

(52) U.S. Cl. 705/39

(57) ABSTRACT

The present invention relates to the field of online commerce. In particular it relates to the operation of electronic markets in which there are a plurality of both sellers and buyers.

### FIELD OF THE INVENTION

The present invention relates to the field of online commerce. In particular it relates to the operation of electronic markets in which there are a plurality of both sellers and buyers.

### BACKGROUND OF THE INVENTION

Buying and selling online is conducted through a variety of mechanisms for matching the buyer and seller, These mechanisms include online catalogues, auctions, bid/ask systems, aggregating of buyers, request-for-quote services and bulletin board listings. Each mechanism is strong for certain types of transaction and weak for others.

The mechanisms above can be divided between those that allow immediate purchasing of pre-determined goods or services and those that accommodate irregular purchase requests but require more time for a purchase to complete.

An online catalogue of the type accessed at Amazon.com for example allows goods that have been described by the seller to be displayed to buyers at a price set by the seller. Similarly items auctioned on sites such as ebay.com are described by the seller but he then waits to see what price the market will pay for his offering. Bid/ask services such as that operated by Priceline.com and described in U.S. Pat. No. 5,794,207 require buyers to define a specific item or range of items to be purchased, typically an airline ticket between two points in a given date range, then wait to see if that need will be matched from a seller's database of pre-described offerings.

By contrast a buyer accessing a request-for-quote service such as that operated by guru.com is able to define his particular needs or the moment, a day of web design work at a specified location for instance, and then receive quotes from sellers who, having digested his requirements, quote a price at which they are willing to fulfil his need. This is time consuming for all concerned. Buyers must wait for a range of sellers to reply to their request to be sure of a fair price. Sellers must take the time to understand buyers' requirements and bid, knowing they may not be successful in getting the business.

The time consuming nature of online transactions in which the buyer is able to define his exact needs rather than shopping between various options pre-defined by sellers makes existing mechanisms impracticable for many transactions. They include short notice purchases or small purchases where the sum involved does not merit the attention of sellers or the waiting of buyers.

Ideally, in many markets, a buyer would wish to define his exact requirements of the moment and immediately be given a list of sellers specifically available and ready to meet that need. For instance his need might be “I want a temporary secretary to work from 2.00 to 6.00 this afternoon at my office”. He would then wish to see an immediate list of sellers who were (a) qualified to work as secretaries (b) in the vicinity of his office (c) willing to work this afternoon (d) currently willing to accept assignments at short notice (e) currently willing to accept assignments of only a few hours duration (f) could be contacted in time to receive details of this period of work.

Existing mechanisms are of little use to such a buyer. A bulletin board for instance will reveal a list of possible secretaries who can be emailed to see if they meet the characteristics above. An auction would be too time consuming for the buyer who could more easily phone a temporary worker supply agency. An online catalogue that simply allows the buyer to browse a list of offerings is again too time consuming for this buyer. Bid/ask type services require the buyer to input the price he will pay rather than allowing a market rate to be established.

To overcome this gap in the art the present inventor has previously disclosed elements of an online buyer/seller matching system called “GEMs”. Such a system is defined by an ability to take in a buyer's requirements and immediately construct options specific to his needs based on broader inputs from any number of sellers. Any of these options can then be purchased immediately. Such a system could run a plurality of markets in different sectors, for example such markets might include: bicycle hire, hire of a driving instructor or short notice office cleaning services.

FIG. 1. shows the buyer input screen for such a system as completed by a buyer who is seeking to book a temporary secretary. FIG. 2 shows the options returned immediately by such a system. These are not bulletin board style listings showing potential sellers who may possibly be available and possibly be interested in this transaction. They are specific options built around the buyer's inputs priced and ready for purchase.

Such a system holds considerable information about each seller which can be searched in the light of a specific buyer's enquiry. Each seller displayed on the screen represented at FIG. 2 has previously specified parameters within which they are willing to sell. These may include geographical area, period-of-notice for an assignment and length of assignment. This information is stored. All of those parameters are met by this requirement for each seller on the screen. The system has also checked that the seller is showing availability in an online availability diary this afternoon and that their diary of times when they undertake to be reached, for instance by mobile phone text message or email, would allow them to be notified of this transaction in time. The buyer can choose any one of these sellers and the system will inform the individual of the assignment regarding them as sold and making the required amendments to their availability diary.

Aspects of the GEMs system have been disclosed in publications by the present inventor. An overview of one embodiment of such a system will now be provided to illustrate one form of underlying architecture for the present invention. Referring first to FIG. 3, this shows a generalised embodiment 300 of a system that might underlie the present invention. Such a system would run a number of markets in different sectors, examples of sectors include: secretarial services, office rental and vehicle hire.

A communications network 303 is connected to seller terminals 301a and b and buyer terminals 302a and b and to a system communications interface 304. The communications network may comprise any conventional communications network such as a telephone network or the Internet. The communications network couples the buyer and seller terminals to the system communications interface 304 to provide user interfaces to the system to allow buyers and sellers to request and execute transactions using the system.

The communications interface 304 is coupled to a communications processor 305 which creates screens and messages for communicating with buyer and seller terminals 302 and 301. The communications processor is connected to an application processor 306 for providing transaction management applications. Application processor 306 is also coupled to a system service provider terminal 308 to allow a system service provider/operator direct access to aspects of the system to which access via communications network 303 is restricted for security reasons. Thus service provider terminal 308 may be used for system management, account management, program code updating, setting a mark-up on each transaction within the system for operator revenue purposes and similar functions. In an alternative embodiment service provider terminal 308 may be connected through a wider communications medium such as the Internet.

Application processor 306 is coupled to data store 307 storing system-related data. It is also able to communicate with external servers that perform specific additional tasks for the benefit of system users. Thus application processor 306 can process data for output to buyer and seller terminals 302 and 301 and communications processor 307 can access the data to send and receive messages to and from terminals 302 and 301. Thus data in data store 307 is indirectly accessible via buyer and seller terminals 302 and 301.

The communications interface 304, communications processor 305, the application processor 306 and the data store 307 may all be provided within a single general purpose computer or these functions may be distributed over a plurality of machines in a manner well known to those skilled in the art.

The communications network 303 in this embodiment is the Internet to which are coupled buyer terminals 302a and b and seller terminals 301a and b. Also coupled to Internet 303 is a gateway (not shown) to a mobile phone network 309 (or, more generally, any mobile communications network) which communicates with a mobile station 311, such as a phone handset, using base transceiver station 310.

FIG. 4. illustrates a preferred embodiment for the system's architecture within a central server. Communications processor 305 interacts with communications interface 304 to receive inputs and forward output communications to buyers and sellers. Application server 306 contains software modules allowing new users accessing the system through the communications network to register as sellers 421 or buyers 422, or both. Transaction management module 423 extracts market rules information from the data store to govern information displayed to users in a particular market and the prioritization of searches. Assembly of options module 424 receives lists of relevant sellers after a search and applies rules on their filtering and display. In its simplest embodiment this module sends all sellers returned by the search to the communications processor 305. Price Construction Module 425 takes the list of sellers produced by Assembly of Options Module 424 and constructs the unit price at which each seller will fulfill this buyer's specified needs.

Once a buyer has selected a seller he wishes to purchase, post sale management module 426 compiles the information about the buyer and transaction that is required to inform the seller of all required details of the sale. Payment transfer module 427 ensures value is transferred from buyer to seller according to instructions in the market rules data store. This might involve credit card processing, transfer of digital value, holding sums in escrow or raising of an online invoice. It may entail breaking the transaction down into parts, the completion of each triggering part payment. Typically this could be achieved by means of a timesheet signed by buyer and seller using their system passwords at the end of each week of a booking. All these processes will be familiar to one skilled in the art and can be performed by widely available software.

User maintenance module 428 applies rules to the seller and buyer data store as instructed through the service provider terminal 308. These might include for instance generating email to any user who has not been active in the last 6 months asking that they confirm the email address, and therefore their identity, is still valid.

The data store 307 comprises firstly a database of sellers 431. For each seller this includes unique identifying code, name, password, date of birth, contact details, time and date of registration, unit price to be charged to buyers, history of transactions performed plus earnings and details of how payments are to be transferred. For each seller there is additional data stored which can be changed at any time by the seller to which it pertains. Selling parameters record 431a stores that seller's preferences for sales, for instance how far from their base travel code they are willing to travel. Seller availability record 431b stores data input by the seller about the times when they are available to be sold by the system. Seller contactability record 431c stores data of the times the seller undertakes to be available for contact by the system and the means by which messages should be sent.

Buyer database 432 includes information about each buyer on the system. This includes unique identifying code, name, administrator password, headquarters address, time and date of registration, details of other users within the buyer's account allowed to buy on its behalf (named members of staff for example), how payments are to be collected, history of transactions and payments made and the information to be displayed to sellers, for instance showing locations of the buyer's buildings at which they may be required to work.

Transaction database 433 records details of all transactions on the system. A preferred embodiment of this database includes the following record of any purchase or partly completed purchase: unique identifying code, market in which purchase was made. identity of buyer, identity of seller, time purchase initiated, number of units bought (hours of work for instance), dates units were to be supplied, times of day units were to be supplied, price paid per unit, selling parameters pertaining to this transaction and current status of the transaction which can be only one of the following exemplary list: waiting for seller confirmation/not confirmed/confirmed/in progress/cancelled/completed.

Market rules database 434 stores information pertaining to each market sector. Wording and options required to make up screens or messages for the user are extracted by communications processor 304. Market rules database 434 also stores rules on admission to a market, for instance “only sellers over 18 permitted” or “no more than 50 hours to be sold by any individual seller in one 7 day period”.

In the above-described aspects of the system communication between the system operator or intermediary and/or buyer and/or seller may be by any convenient communication means, but the system is particularly suited to implementation using an electronic communications network such as the Internet, and Intranet, or an Extranet, or wireless mobile communications.

In preferred embodiments the system is implemented on general purpose computer systems using appropriate software. The software may comprise instructions in one or more or HTML, XML, Java, Perl or other programming languages. Thus aspects of the system may be embodied in computer program code, either as separate applications or parts of a single program. As the skilled person will appreciate, such program may comprise source, object or executable code and code may be implemented on a single machine or shared between different hardware platforms. Such program code may be provided on any conventional carrier medium such as tape, disk, CD-ROM, programmed memory or on an electrical or optical signal carrier. The processor implementable instructions of the buyer and seller terminals may be stored on a network server and provided to the terminal as needed, for example as an Internet data page or web page.

Processes used in such a system will now be described. For ease of understanding the operation of the system will be described with reference to a specific example of the system's use, that of providing temporary secretaries to employers. However use of the system is not restricted to this application.

### Listing Goods or Services to be Sold

A new seller will typically enter the system through a portal accessed via the communications network 303 and constructed by the communications interface 304. This page is able to activate the seller registration module 421. Having taken details of the individual or company, this module then offers a selection of markets in which anyone might register to sell. Thus a new seller might be asked “what do you wish to sell” and then offered a first selection list which includes “my time”. This response prompts a second list from which she chooses “formal temporary work” and then “secretarial work”. A seller can choose to sell in multiple market sectors. A seller may not be named as an individual but simply as “secretary from XYZ Agency”. They are then invited to input the pricing data that allows their price for a transaction for which they are applicable to be constructed. In its simplest embodiment this requires only that they specify a flat-rate price for each unit of sale or part thereof. In the temporary work market the unit of sale is hours.

Thus the system knows the individual's name, contact details, including email address and optional mobile phone number, and that she wishes to sell her time as a temporary secretary at, for example. $8.35 an hour. These details are recorded in seller database 431.

At this point the seller registration module 421 asks the questions that allow this user's parameters for any potential sale to be stored in the seller parameter record 431a. A list of parameters relevant to sales in the secretarial market are accessed from the market rules database 434. They may include:
Geography (for example: “My home postal code is X and I will not work more than Y miles from that point”)
Size of purchase (for example: “I will not accept bookings of less than 4 hours” or “I will not accept bookings lasting more than 10 working days”)
Period of notice for purchase (for example: “I only accept bookings where I have at least 24 hours notice of the job”)

Additionally the seller may be able to define specific buyers registered on the buyer database 432 with whom they are unwilling to trade. This is recorded on the seller parameter record 431a.

The new seller is then offered a blank diary of time blocks, possibly in half hour increments, covering each day for the remainder of the current week. She can click through to Further pages covering following weeks. By selecting certain blocks she is able to select the precise times when she is available to work. This is stored in the seller availability diary 431b. By default this diary remains blank with no availability until the seller has input details of her willingness to work.

In a further embodiment the seller is now presented with a second set of diary pages and asked to input times when she undertakes to be contactable by the system. These are periods when she will be logged on to receive email or will have her mobile phone switched on and about her person to receive text messages. This data is stored in the seller contactability record 431c.

Thus it will be clear that the seller database 431 now holds details of the individual's identity (including password), market or markets in which they wish to sell, their unit price, the constraints on any sale they will accept, the times they are available to sell their chosen goods or services sold by the system and the times at which they can be contacted by the system. Any part of this information can be changed at any time by the seller logging on and triggering the user maintenance module 427. This will display current choices stored in the seller's parameter record 431a, availability diary 431b and contactability record 431c. The seller can then choose to overwrite her current preferences.

The above example pertains to a potential seller wishing to sell their time. It will be clear the architecture described could equally accept listings for other services. For example: load space on trucks, domestic storage capacity, sales of organic produce or childcare. In each case the market rules database 434 would provide a list of relevant parameters to be completed by the seller. An example of the selling parameters by which sellers can define their willingness to sell based on a buyer's specific needs for some further markets will now be given.

| MARKET | UNIT OF SALE | SELLING PARAMETERS |
|---|---|---|
| Overnight accommodation | Night | Length of stay/time of arrival/time of departure/ |
| | | number of people in room/smoker or non-smoker/ |
| | | period of notice to hire |
| Hire of agricultural tractors | Hour | Distance to buyer/anticipated hours of work within |
| | | the hire/length of hire/period of notice to hire |
| Local deliveries | Mile | Period of notice to pick up/distance from seller |
| | | postalcode to pick up point/length of journey/ |
| | | distance from seller postalcode to drop-off point/ |
| | | weight of object to be delivered/size of object to be |
| | | delivered |
| Specially commissioned | Kilogram | Smallness of cake/largeness of cake/style of cake |
| home cake baking | | (selected from drop down boxes)/period of notice |
| | | before delivery/delivery method/additional |
| | | trimmings (selected from drop down boxes) |

### The Purchase Process

A new buyer accesses the system through communications interface 304 and is shown a generic welcome page generated by communications processor 305. From this the new buyer is able to trigger buyer registration module 422. This sends pages requesting information, validates that information and uses it to populate a record in buyer database 432. Confirmation of the buyer's means to pay may be obtained through a link to an external agency such as a credit card supplier using communications network 303 before purchasing is allowed. This process is well known to those in the art.

A buyer wishing, and permitted, to make a purchase can trigger the transaction management module 423. This will offer a page such as that shown in FIG. 1. that establishes the following. (a) What he wishes to purchase (for example: the time of a temporary secretary) This information is sent to the market rules database 434 which provides the parameters which must be defined to enable a search of the seller database 431. (b) The quantity he wishes to purchase (for example by defining a period of daily hours which the system can multiply by the number of days input at the next step). (c) The times he wishes to purchase (for example: by defining a start and end date for a booking). (d) The geography in which he wishes the purchase to be realized (for example: place of work is postal code Y).

Transaction management module 423 will ensure all required information is in place before beginning a search. Once the required inputs have been completed the transaction management module creates a record on the transaction database 433. A unique identifier code for this transaction is established at the time of storage. The transaction management module 423 then initiates a search of the seller database 431 based on the buyer inputs. The search is performed by assembly of options module 424. It excludes those sellers who are among any of the following. (a) Not selling the services/goods the buyer wishes to purchase. (b) Not willing to sell in the area defined by the buyer. (c) Not willing to sell the number of units (for example hours) demanded by the buyer. (d) Not willing to sell with the period of notice for this transaction. (e) Not available at the dates and times the buyer requires. (f) Not contactable in the time required before the purchase.

Thus the assembly of options module 424 is able to return a list of any sellers on the database who meet the following conditions. (a) Selling the services or goods required by the buyer. (b) Willing to sell in the geography required. (c) Willing to sell with the period of notice specific to this job. (d) Available for the times and dates required. (e) Contactable in time for this booking.

This list is sent to price construction module 425. In it simplest embodiment, this module looks up the unit price for each seller on the list, such data being held in seller database 431 and multiplies it by the number of units for this sale. Alternatively it may use the selling parameters of the present requirement as outlined in the screen shown in FIG. 1, coupled with a list of pricing preferences from each user, to construct a specific price for this one transaction for each seller. It may also add a mark-up input by the system operator through service provider terminal 308. This provides revenue for the market operator and is retained during any subsequent transfer of payment between buyer and seller. Alternatively the market operator might invoice either party for its transaction fee, or subscription fee, at a future date.

This list of options and their prices is stored in the transaction database 433 against the unique identifier for this query. If no sellers are returned the transaction management module 423 creates a message for the buyer suggesting a change of requirements.

The list of sellers and prices thus stored are now sent by the communications processor 304 and the communications interface 304 to the buyer terminal 302. Before doing so assembly of options module 424 may apply rules such as “display in price order from left to right putting identically priced sellers in alphabetical order” or “only display a maximum of 20 sellers on one screen”. Such rules would be input from service provider terminal 308.

One embodiment of such a page is represented in FIG. 2. If the buyer selects “purchase” on any option or options presented to him. that information is stored in the transaction database 433. A page of information for the seller has to be completed by the buyer and payment is arranged according to instructions in the market rules database 434 by payment transfer module 427. This module will access proprietary software well known to those in the art such as credit card approval, transfer of digital value between users on the system or invoice generation and return a “payment OK” flag to be recorded on Transaction Database 433.

Once payment arrangements have been confirmed the post sale management module 426 is triggered. This performs the following tasks. (a) Confirms the seller is still available. If they have removed their availability or been bought by another conflicting buyer since the search showed them to be available the buyer is advised with a message. (b) Removes the appropriate availability from the seller's record in the seller database 431. (c) Creates a message for the chosen seller revealing the buyer's identity stored in buyer database 432 and adding details of his purchase from the transaction database 432. In a temporary work transaction these would include: place of work, hours of work, days to be worked and information input by the buyer to be passed to the seller. (d) Looks up contact details on the seller database 431 and directs the message to email or mobile phone for instance via the communications processor 304. (e) Monitors that the seller confirms they will undertake the assignment before the start of work time. If they do not a message is generated for the buyer advising that the seller has not confirmed and the buyer may wish to re-book. (f) Triggers release of payment from escrow funds at a specified point based on rules in the market rules database 434 (for example 48 hours after completion of the transaction). In a temporary work market this would be likely to be based on completed timesheets each of which triggers an invoice. Online timesheets may be based on technology such as Web Timesheet from Adeo Software or the Time product from Artologik Software

It will be appreciated that modules listed above could be combined in practice. Their listing is purely illustrative of the functions to be performed and is not intended to define the system's structure.

### Benefits of the System

This is a “spot market” online. Existing systems for buyer/seller matching tend not to allow immediate purchasing from an infinite number of sellers who may have entered the market only minutes earlier. Online bulletin boards offer listings of sellers who may be available for a general need. Internet auctions require time consuming bidding. Using bid/ask systems the buyer must define parameters of the potential purchase which has to be matched by a precise offering defined by the seller.

“GEMs” type markets such as that just described provide a list of named sellers any one or whom can be booked immediately for a buyer's specific requirements. Unlike online catalogues these markets are able to construct a specific offering for a buyer's needs based on much more general inputs by a plurality of potential sellers.

There are potential enhancements to a system as described above that are already in the public domain:

Grading of Sellers Embodiment.

In this embodiment user maintenance module 428 promotes sellers up a ladder of grades as they successfully complete specified numbers of trades. Buyers can view relevant sellers produced by the search listed by their grades in the market. Grading data is stored on the seller database 431. Users may move automatically through grades as the user maintenance module 427 periodically sweeps the seller database checking number of units sold in each market.

Contract Construction Embodiment.

The system might hold a form of words for contracts specific to each type of purchase in the market rules database (236) and insert the specific transaction details to create an agreement between the two parties. This is pre-signed online with a password by the seller before being listed and by a buyer as they confirm they wish to make a purchase.

Transaction Status Embodiment

Market Rules Database 434 may contain rules governing the status of a transaction as stored in Transaction Database 433 and displayed to all users involved in a particular transaction. Thus the times at which each transaction in a particular market change from one status to another, and any requirements of such change, are able to vary between market sector. This allows (a) a user to be given an immediate overview of all transactions in which they are involved with status, possibly color coded, instantly displayed for simplicity (b) the system itself can compute percentages of transactions at any particular point in their progression. Information on the requirements of each status are input through Service Provider Terminal 308. An exemplary table of transaction status definitions is contained in FIG. 8a.

WIPO patent application WO 02/091100 discloses in detail a GEMs system that allows the transactions of high grade sellers to be economically underwritten by the system operator. Underwritten transactions might have a monetary amount attached that specifies the maximum that can be spent on a replacement purchase. This document is incorporated herein by way of reference material.

### OBJECT OF THE INVENTION

The markets described above make small purchases, often at short notice, efficient in multiple market sectors. Inevitably some of these transactions will go wrong, a minicab will not turn up as expected, a temporary worker will not behave professionally or a hired office will not be available for unforeseen reasons. Such problems are (a) likely to occur at short notice with immediate resolution required (b) could be an early indication of wider problems that will impact on many more transactions (c) need to be resolved in such a way that the party who has breached their contractual commitment is identified and can then be potentially downgraded so only reliable traders continue to climb the market grades. There therefore exists a need for specialized technology that can respond to problems in such markets.

It is known that a variety of methods for rating users of online services exist. Online auction services such as that accessible at www.ebay.com typically invite feedback about a seller from a buyer on completion of a transaction. The limitations of such systems are well known and include (a) a fear of posting negative feedback for fear of “retaliatory” rating by another user (b) the ease with which users can organise groups of supporters to boost their feedback (c) the period in which a seller who has accumulated positive ratings can run bogus transactions while dealing with buyers who implicitly trust the seller. Similarly, services such as that run by www.openratings.com invite feedback on suppliers that is then made available to other companies who may purchase from that supplier. As with all such ratings systems the process is time consuming for the buyer and entails subjective ranking with little incentive for a wronged buyer to report bad service beyond a concern for the interests of the wider community.

It is also known that Alternative Dispute Resolution (ADR) that avoids the cost of court action has evolved in many form in recent decades. Forms of ADR include arbitration, mediation, negotiation, fact finding processes, trials by “jury” and early intervention by a neutral player. With reference specifically to online dispute resolution, the art includes services such as www.theclaimroom.com or www.resolutionroom.com which allow the parties involved in a dispute to conduct an online dialogue in the presence of a mediator who will seek to resolve differences of opinion and arrive at a settlement that is acceptable to both parties. Similar services such as that offered at www.squaretrade.com allow users to display a symbol signifying a commitment to undergoing mediation in case of dispute.

U.S. Pat. No. 6,330,551 discloses a means of reaching a settlement by two parties inputting a series of figures which they might consider acceptable settlement in a dispute, such figures being used as a basis of settlement in distinct stages of negotiation. Such a service is offered by www.cybersettle.com. Other online dispute resolution (ODR) services offer “blind bidding” where two sides input a range of figures and an algorithm constructs a settlement at a median if the figures come within, perhaps, 30% of each other. In the UK, wwvw.wecansettle.com offers a similar service. U.S. Pat. No. 5,495,412 outlines a system of dispute resolution whereby each party defines a relative level of satisfaction for a particular outcome in the form of a numerical value. The invention disclosed then calculates the outcome that gives the highest combined satisfaction rating.

Services such as www.cresolution.com or www.intellicourt.com allow users to present their case through on screen forms to an arbitrator who will act as a judge rather than seeking conciliation as an outcome. A jury model is utlized by www.i-courthouse.com which invites any user to serve as “juror” in a panel that pronounces judgments on cases submitted by other users.

In many jurisdictions, the official court system has created a “cybercourt” which takes in statements from plaintiffs and defendants either in preparation for a courtroom hearing or as an alternative to a case being heard in front of a judge. This is explained at: www.bu.edu/law/scitech/volume8/Exon.pdf with an example of such a service at www.courtservice.gov.uld/mcol/. U.S. Pat. No. 5,895,450 discloses a method of automating court processes with the possibility of automated feedback into the lawmaking process.

Such technologies tend to (a) be useful only after a transaction is in the past and has definitively failed (b) rely on the willingness of both parties to co-operate, having little use if either refuses (c) deal with failed transactions individually with no capacity For identifying problems in the wider market that might span multiple transactions (d) typically have high administration costs which makes them worthwhile only on bigger transactions (e) in the case of mediation systems, focus on a reasonable compromise solution rather than establishing one party is guilty (f) be based on purchases of standardised products such as collectables or office supplies rather than hard to standardisc services such as the quality of a temporary worker (g) allow only for cases where the seller has failed with no procedure for dealing with misbehaviour by a buyer (h) require the complaint initiator to input all details of the alleged transaction failure (i) deal with only one transaction at a time, being ill suited for purchases which involved a plurality of buyers purchasing from the same seller at the same time an example being group overnight accommodation.

By contrast a problem resolution system for “GEMs” markets needs to (a) be immediately useful at the point where a transaction is in trouble but may not yet have failed (b) identify guilty traders and thereby leverage the benefits of a system of graded markets that includes the ability to downgrade users who do not comply with the contractual standards of their grade (c) immediately identify patterns of problems affecting transactions attached to a particular seller, buyer, geographic area or market sector (d) be capable of clearing a dispute from the system at very low cost (e) allow sellers to complain about a buyer (f) enforce the reliability of said markets by proactively resolving disputes so users can not ignore unresolved problems while knowing that any entries they input about a problem may be viewed by an arbitrator with power to downgrade them at any time (g) recognise that the system itself already holds key contractual data about the transaction alleged to have failed (h) be able to deal with transactions that involve multiple buyers, for example seats for a coach journey.

### SUMMARY OF THE INVENTION

According to a first aspect of the invention, there is provided a transaction management system for managing the purchase of a service by a buyer from a seller, the system comprising:
a data store for storing seller data comprising, for each of a plurality of sellers:
   a seller identifier;
   a seller grade dependent on at least one of the number of successfully completed transactions involving the seller and the number of disputed problems associated with transactions involving the seller; and
   seller offer data indicating at least one service offered for sale and an availability record for the service;
a program store storing processor implementable instructions; and
a processor coupled to the data store and to the program store for implementing the stored instructions; wherein the stored instructions comprise instructions for controlling the processor to:
   implement a buyer interface to receive a purchase inquiry from a buyer, the purchase inquiry comprising a plurality of purchase criteria;
   output seller offer data for a plurality of sellers able to meet the purchase criteria; and
   receive a purchase request from the buyer accepting a said offer, thereby creating a transaction;
wherein the data store is further for storing transaction data comprising, for each of a plurality of transactions, a transaction identifier, a transaction status, a buyer identifier and a seller identifier;
wherein the stored instructions further comprise instructions for controlling the processor to implement a problem report interface to receive a problem report for a problem associated with a transaction;
and wherein the data store is further for storing problem data comprising, for each of a plurality of problems associated with transactions, a problem identifier, a transaction identifier and a problem report received by the problem report interface.

The invention provides a transaction management system for a market comprising graded sellers. Problems associated with transactions can be reported to the system in the form of problem reports containing information regarding the problem. The system is then able to store problem reports for use in resolving the problems. The content of the stored problem reports may be used in grading sellers.

The problem report interface is preferably implemented to receive the problem report from a buyer and, at the request of the buyer, to create a replacement transaction for the buyer.

Preferably, the data store is further for storing seller extension data comprising, for each of a plurality of sellers, a seller identifier and cancellation charging data. The stored instructions may then further comprise instructions for controlling the processor to award compensation to the seller in dependence on the cancellation charging data for the seller.

Preferably, the problem report interface is further implemented to receive the problem report from a seller and, at the request of the seller, update the seller data for the seller.

Preferably, the data store is further for storing market specific language data comprising, for each of a plurality of market sectors, a market sector identifier and a plurality of generic market terms and corresponding specific market sector terms. The problem report interface is then further implemented to translate between generic market terms and specific market sector terms using the market specific language data.

Preferably, the problem report interface is implemented to receive the problem report at a time from the creation of the transaction. For example this may be before any services have actually been provided in connection with the transaction.

The data store is preferably further for storing alert data comprising, for each of a plurality or alerts, an alert identifier, an alert status and a description of a known problem. The problem report interface is then further implemented to notify the buyer or seller of alert data which is relevant to the problem.

Preferably, the problem report interface is Further implemented to receive an indication of whether the problem will affect other transactions as part of the problem report.

Preferably, the problem report interface is further implemented to receive an indication of liability for the problem as a part of the problem report, the indication being one of the buyer, the seller and a third party. In this case, the stored instructions may further comprise instructions for controlling the processor to: implement a dispute resolution interface if a problem report received from the buyer or seller indicates that the other is liable for the problem, thereby creating a disputed problem; and update the problem data in the data store to cancel the problem if the buyer or seller indicates that they are liable for the problem, thereby resolving the problem.

In the case of a disputed problem, the dispute resolution interface may be further implemented to enable the buyer and seller to enter into a time limited dispute resolution dialogue, wherein the problem data in the data store is updated to cancel the problem if the dispute resolution dialogue resolves the problem within the time limit.

In the case of a disputed problem, the dispute resolution interface may be further implemented to enable the buyer or seller to refer the problem to an arbitrator, and wherein the arbitrator determines liability. Alternatively, a disputed problem may be automatically referred to an arbitrator. The decision to refer a disputed problem to an arbitrator may be dependent on at least one of: the number of transactions affected by the disputed problem; a guaranteed or underwritten status; the presence of a widespread contractual ambiguity requiring clarification; and a grade of at least one of the buyer and seller.

The stored instructions may further comprise instructions for controlling the processor to: implement an arbitrator interface to receive a judgement from the arbitrator, the judgement comprising an indication of liability; and notify the buyer and the seller of the judgement received from the arbitrator.

Preferably, the data store is further for storing case law data comprising a plurality of judgements for disputed problems and problem related information for the problems. The stored instructions may further comprise instructions for controlling the processor to provide relevant case law data to buyers, sellers and arbitrators.

The problem report interface may be implemented to receive an indication of the characteristics of other transactions which will be affected by the problem as part of the problem report. In this case, the stored instructions may further comprise instructions for controlling the processor to: determine the other transactions which will be affected by the problem on the basis of the problem report; and notify buyers and sellers of the other affected transaction of the problem.

Preferably, the seller grade is further dependant on stored data relating to problem transactions. This stored data relating to problem transactions preferably comprises a measure of how early the seller has submitted problem reports for problems associated with their transactions for which they accept liability. It may also comprise a measure of the number of disputed problems associated with the transactions of the seller. The data store may further be for storing buyer data comprising, for each of a plurality of buyers, a buyer identifier and a buyer grade, the buyer grade for each buyer being dependant on stored data relating to problem transactions.

The stored instructions may further comprise instructions for controlling the processor to generate a contract between the buyer and the seller of a transaction, the terms of the contract depending on at least one of a buyer grade and a seller grade of the buyer and seller respectively.

According to another aspect of the invention, there is provided a transaction management system for managing the purchase of an item and/or service by a buyer from a seller, the system comprising:
a data store for storing seller data comprising, for each of a plurality of sellers, a seller identifier;
a program store storing processor implementable instructions; and
a processor coupled to the data store and to the program store for implementing the stored instructions; wherein the stored instructions comprise instructions for controlling the processor to:
   implement a buyer interface to receive a purchase inquiry from a buyer;
   output seller offer data for a plurality of sellers; and
   receive a purchase request from the buyer accepting a said offer, thereby creating a transaction;
wherein the stored instructions further comprise instructions for controlling the processor to implement a problem report interface to receive a problem report for a problem associated with a transaction, and wherein the seller data in the data store Further comprises, for each of the plurality of sellers, a seller grade, wherein the seller grade is dependent on a measure of how early the seller has submitted problem reports for problems associated with their transactions for which they accept liability.

This aspect provides a transaction management system for a market comprising graded sellers. The grade of a seller is dependent on a measure of how early the seller has submitted problem reports for problems associated with their transactions for which they accept liability. For example, late reporters of problems may automatically have low grades.

According to still another aspect of the invention, there is provided a transaction management system for managing the purchase of an item and/or service by a buyer from a seller, the system comprising:
a data store For storing seller data comprising, for each of a plurality of sellers, a seller identifier;
a program store storing processor implementable instructions; and
a processor coupled to the data store and to the program store for implementing the stored instructions; wherein the stored instructions comprise instructions for controlling the processor to:
   implement a buyer interface to receive a purchase inquiry from a buyer;
   output seller offer data for a plurality of sellers; and
   receive a purchase request from the buyer accepting a said offer, thereby creating a transaction;
wherein the stored instructions further comprise instructions for controlling the processor to:
   implement a problem report interface to receive a problem report from the buyer or seller for a problem associated with a transaction, the problem report including an indication of liability for the problem;
   implement a dispute resolution interface if a problem report received from the buyer or seller indicates that the other is liable for the problem, thereby creating a disputed problem; and
   automatically refer a disputed problem to an arbitrator, the decision to refer a disputed problem to an arbitrator being dependent on at least one of:
      the number of transactions affected by the disputed problem;
      a guaranteed or underwritten status;
      the presence of a widespread contractual ambiguity requiring clarification; and
      a grade of at least one of the buyer and seller,
   wherein the arbitrator determines liability.

This aspect provides a transaction management system for a market in which a number of disputed problems exist. Disputed problems may be automatically referred to an arbitrator on the basis of specific criteria. In this way, the number of disputed problems in the market may be minimised.

According to still another aspect of the invention, there is provided a transaction management system for managing the purchase of an item and/or service by a buyer from a seller, the system comprising:
a data store for storing seller data comprising, for each of a plurality of sellers, a seller identifier;
a program store storing processor implementable instructions; and
a processor coupled to the data store and to the program store for implementing the stored instructions: wherein the stored instructions comprise instructions for controlling the processor to:
   implement a buyer interface to receive a purchase inquiry from a buyer;
   output seller offer data for a plurality of sellers; and
   receive a purchase request from the buyer accepting a said offer, thereby creating a transaction;
wherein the stored instructions further comprise instructions for controlling the processor to:
   implement a problem report interface to receive a problem report from the buyer or seller for a problem associated with a transaction and inform the buyer or seller of known problems which are relevant to the transaction:
   request and receive further information about the problem from other buyers and sellers; and
   notify other buyers and sellers of the problem.

This aspect provides a transaction management system for a market in which problems in the market may be reported to the system. The system is then able to inform all affected buyers or sellers of a problem and request and receive further information on a problem from relevant buyers and sellers.

According to still another aspect of the invention, there is provided a transaction management system for managing the purchase of an item and/or service by a buyer from a seller, the system comprising:
a data store For storing seller data comprising, for each of a plurality of sellers, a seller identifier;
a program store storing processor implementable instructions; and
a processor coupled to the data store and to the program store for implementing the stored instructions; wherein the stored instructions comprise instructions for controlling the processor to:
   implement a buyer interlace to receive a purchase inquiry from a buyer;
   output seller offer data for a plurality of sellers; and
   receive a purchase request from the buyer accepting a said offer, thereby creating a transaction;
wherein the stored instructions further comprise instructions for controlling the processor to:
   implement a problem report interface to receive a problem report from the buyer or seller for a problem associated with a transaction, the problem report including an indication of liability for the problem;
   implement a dispute resolution interface if a problem report received from the buyer or seller indicates that the other is liable for the problem, wherein the dispute resolution interface is implemented to:
      enable the buyer and seller to enter into a time limited dispute resolution dialogue; and
      provide the buyer and seller with stored information about relevant transactions and the dispute resolution dialogue.

This aspect provides a transaction management system for a market in which disputed problems in the market may be resolved through a dispute resolution interface.

According to still another aspect of the invention, there is provided a method for managing the purchase of a service by a buyer from a seller, the method comprising:
storing in a data store seller data comprising, for each of a plurality of sellers:
   a seller identifier;
   a seller grade dependent on at least one of the number of successfully completed transactions involving the seller and the number of disputed problems associated with transactions involving the seller; and
   seller offer data indicating it least one service offered for sale and an availability record for the service;
implementing a buyer interface to receive a purchase inquiry from a buyer, the purchase inquiry comprising a plurality of purchase criteria;
outputting seller offer data for a plurality of sellers able to meet the purchase criteria; and
receiving a purchase request from the buyer accepting a said offer, thereby creating a transaction;
further storing in the data store transaction data comprising, for each of a plurality of transactions, a transaction identifier, a transaction status. a buyer identifier and a seller identifier;
implementing a problem report interface to receive a problem report for a problem associated with a transaction;
further storing in the data store problem data comprising, for each of a plurality of problems associated with transactions, a problem identifier, a transaction identifier and a problem report received by the problem report interface.

This is the method implemented by the system of the invention.

According to still another aspect of the invention. there is provided a method for managing the purchase of an item and/or service by a buyer from a seller. the method comprising:
storing in a data store seller data comprising, for each of a plurality of sellers, a seller identifier;
implementing a buyer interface to receive a purchase inquiry from a buyer;
outputting seller offer data for a plurality of sellers;
receiving a purchase request from the buyer accepting a said offer, thereby creating a transaction; and
implementing a problem report interface to receive a problem report for a problem associated with a transaction,
wherein the seller data further comprises, for each of the plurality of sellers, a seller grade, wherein the seller grade is dependent on a measure of how early the seller has submitted problem reports for problems associated with their transactions for which they accept liability.

According to still another aspect of the invention, there is provided a method for managing the purchase of an item and/or service by a buyer from a seller. the method comprising:
storing in a data store seller data comprising, for each of a plurality of sellers, a seller identifier;
implementing a buyer interface to receive a purchase inquiry from a buyer;
outputting seller offer data for a plurality of sellers;
receiving a purchase request from the buyer accepting a said offer, thereby creating a transaction;
implementing a problem report interface to receive a problem report from a buyer or seller for a problem associated with a transaction, the problem report including an indication of liability for the problem;
implementing a dispute resolution interface if a problem report received from the buyer or seller indicates that the other is liable for the problem, thereby creating a disputed problem; and
automatically referring a disputed problem to an arbitrator, the decision to refer a disputed problem to an arbitrator being dependent on at least one of:
   the number of transactions affected by the disputed problem;
   a guaranteed or underwritten status;
   the presence of a widespread contractual ambiguity requiring clarification; and
   a grade of at least one of the buyer and seller,
wherein the arbitrator determines liability.

According to still another aspect of the invention, there is provided a method for managing the purchase of an item and/or service by a buyer from a seller. the method comprising:
storing in a data store seller data comprising, for each of a plurality of sellers, a seller identifier;
implementing a buyer interface to receive a purchase inquiry from a buyer;
outputting seller offer data for a plurality of sellers;
receiving a purchase request from the buyer accepting a said offer, thereby creating a transaction;
implementing a problem report interface to receive a problem report from a buyer or seller for a problem associated with a transaction and inform the buyer or seller of known problems which are relevant to the transaction;
requesting and receiving further information about the problem from other buyers and sellers; and
notifying other buyers and sellers of the problem.

According to still another aspect of the invention, there is provided a method for managing the purchase of an item and/or service by a buyer from a seller. the method comprising:
storing in a data store seller data comprising, for each of a plurality of sellers, a seller identifier;
implementing a buyer interface to receive a purchase inquiry from a buyer;
outputting seller offer data for a plurality of sellers;
receiving a purchase request from the buyer accepting a said offer, thereby creating a transaction;
implementing a problem report interface to receive a problem report from a buyer or seller for a problem associated with a transaction, the problem report including an indication of liability for the problem; and
implementing a dispute resolution interface if a problem report received from the buyer or seller indicates that the other is liable for the problem, wherein implementing the dispute resolution interface comprises:
   enabling the buyer and seller to enter into a time limited dispute resolution dialogue; and
   providing the buyer and seller with stored information about relevant transactions and the dispute resolution dialogue.

The present invention enables the fastest possible resolution of problems in an online market of multiple transactions of non-standardized goods or services where immediate resolution of a problem is important. Examples of such problems might include (a) a buyer who has purchased fresh flowers from a local seller through an online market and discovered they are mouldy (b) a driver sent to collect a van hired through an online market but who is then denied permission to collect the vehicle by the hirer's security guard (c) a seller of windsurfing lessons through an online market who decides the weather is too rough on a particular day and her lessons must all be cancelled (d) a seller of minibus journeys who finds a passenger has left his seat in an unacceptable condition at the end of a journey.

In all problems impacting on the marketplace to which it is connected the present invention (a) resolves a user's immediate problem as a first priority (b) seeks to act on any wider implications of a user's problem for the benefit of other users %vho may also bc impacted (c) ensures blame is apportioned for a problem whenever possible (d) sees that buyers or sellers who are causing problems and not accepting responsibility are held in the lower grades of a graded market while honest and reliable users are able to rise up to higher grades where their value as a trading partner is likely to be rewarded in the prices paid in subsequent transactions (e) all the above are accomplished in such a way that the system is seen to be fair and just to all users while avoiding the costs typically associated with online dispute resolution.

The present invention is specifically designed for problem resolution in online markets which allow an infinite number of sellers to provide services and goods of an irregular nature with sellers' offerings used to construct precise purchase options according to a buyer's individual needs. Said markets are likely to be characterised by immediate purchasing for the buyer and therefore tend towards the supply of goods and services at short notice. The invention disclosed is economic even when applied to disputed transactions of low value.

### BRIEF DESCRIPTION OF THE DRAWINGS

FIG. 1. shows a completed buyer input screen within a known online marketplace defined by an ability to take in a buyer's requirements and immediately construct options specific to his needs based on broader inputs from any number of sellers:

FIG. 2: illustrates an exemplary screen returned by such a marketplace in response to the buyer input in FIG. 1;

FIG. 3 is a schematic illustration of the communications links required for this known marketplace and which can form the basis of the system of the invention;

FIG. 4. represents the system architecture within the Application Processor 306 and Datastore 307 for the system of FIG. 3;

FIG. 5. illustrates the additional architecture required, to supplement the above underlying architecture, by the present invention;

FIG. 6. is a schematic illustration of the software modules and Datastore components within Problem Server 500;

FIG. 7. illustrates data fields pertaining to each judgment by an arbitrator that is then filed in Case Law Records 685;

FIG. 8a. lists the progression of status codes for each transaction in the system;

FIG. 8b represents the fields of data stored in Alert Records Store 670 about each alert pertaining to a problem likely to impact on multiple transactions;

FIG. 8c. shows the fields of data stored within Alert Records Store 670 for each report by a user of problems relevant to a particular alert:

FIG. 9a. represents the data stored in the Transaction Database Extension created for any transaction for which a problem is reported;

FIG. 9b. is an exemplary embodiment or a seller promotion criteria table as stored in Grading Tolerances Record 655 for each market sector;

FIG. 9c. shows the table by which solution options are selected to a problem by POP Screen Compilation Module 610;

FIG. 9d, is an illustrative embodiment of the market specific text stored in Market Specific Language Records 660 for three market sectors;

FIG. 9e represents a table of standards mandated in the contract between buyer and seller for each grade level in an exemplary market. This is stored in Grading Tolerances Records 655:

FIG. 10. illustrates example categories and types of problems recognised by the present invention;

FIG. 11. illustrates a screen showing a user all the transactions in which they are currently involved in the system and allowing them to report a problem with one or more of said transactions;

FIG. 12. demonstrates a process whereby a problem, once reported, leads to the construction of a specific page of options and information for the user;

FIG. 13a is an illustrative embodiment of such a page returned to a buyer who has reported a problem in a transaction falling within parameters for which an alert is stored in Alert Records Store 670;

FIG. 13b. illustrates the standard page returned to sellers reporting a problem;

FIG. 14a., 14b. and 14c. demonstrates the process whereby a user notifying the system of a complaint is presented with precise options based on their desired solution to the problem. Said sequence runs within POP Screen Compilation Module 610;

FIG. 15a. and 15b show a page that allows a user to refine their specific solution and ensures they attest to the completion of certain tasks designed to facilitate a quick resolution of the problem;

FIG. 16. illustrates a process whereby POP Screen Compilation Module 610 manages the complainant's desired, and feasible, solution to his problem;

FIG. 17a. illustrates a screen returned to a user who may have information that will help Alert Management Module 620 gain further information about a problem likely to impact on multiple users;

FIG. 17b. shows the screen returned to a complainant who claims the problem reported is not their fault;

FIG. 18. illustrates the process whereby details relating to an alert, input by a user who believes a problem they are experiencing is likely to impact on other transactions, is filed within Alert Records Store 670;

FIG. 19 shows the process whereby Alert Management Module 620 seeks further information about a problem likely to impact on multiple transactions;

FIG. 20. illustrates a ‘toolbar’ available to any user who seeks dispute resolution with a counterparty in a problem transaction;

FIG. 21. shows the process whereby a dispute resolution form is assigned to an arbitrator by Arbitration Hub 630; and

FIG. 22. is a representation of the process carried out by Arbitration Prioritization Module 635.

### DETAILED DESCRIPTION OF THE INVENTION

The present invention is most effective in a graded market in which a plurality of sellers are allocated to grades based on factors that might include (a) minimum number of transactions completed (b) minimum number of buyers with whom they have transacted (c) minimum cumulative value of transactions completed (d) maximum number of complaints upheld against them (e) maximum number and value of unresolved disputed transactions. Additionally, higher grades may carry increasingly demanding contractual obligations on the seller in terms of level of service, punctuality and other factors. Sellers are asked if they are willing to contractually commit to these new levels of service before being admitted to a grade for which they qualify. Higher graded sellers are therefore likely to command a premium price. Likewise buyers are graded and are likely to attract lower prices once their honesty and low record of unresolved problems or upheld complaints is established.

The buyer who believes a transaction is not being fulfilled as it should is able to call up a dynamically created Point of Problem (POP) screen which tells him (a:) if there is any wider problem already known to the system that might explain his particular problem (b) what the system is able to do at that time in terms of replacing his transaction or compensating him for non-compliance (c) asks him for his preferred solution to his problem (d) ensures further information is captured so that any wider implications of his problem on other transactions can be acted upon (e) collects a first statement in an attempt to apportion blame for the problem. Similarly a seller can report that she will nut be able to fulfil a particular transaction or transactions because of unforeseen circumstances that are either her fault or outside her control. The present invention will encourage early reporting of such problems and seek to minimize inconvenience for her customer or customers.

Examples of problems likely to impact on other transactions include (a) traffic congestion which stops multiple sellers reaching the place at which they are due (b) area closures, for instance due to a security alert, which has the same effect (c) changed legal requirements for completion of a particular transaction. Reports of problems are weighted and can be investigated by an Alert Management Module. The module benefits from being connected to a market in which users are graded and therefore those known to be reliable and honest, and provided with an incentive to continue such behaviour because of the premium pricing it enables, can be immediately identified. The Alert Management Module is able to (a) request further information from users likely to be in a position to provide further details, temporary workers on their way to an assignment in an area of reported transport problems for instance (b) send a plurality of such reports to another user who will condense them into one cohesive piece of text (c) identify the geographic, market sector and time durations limits of a reported problem (d) identify transactions already booked, and parameters of transactions that may be booked in the future. that require warning about said problem (e) issue warnings to those involved in said transactions (f) automatically construct an offered solution to the problem for those transactions (g) continue to seek information about said problem and its likely duration until it can be declared over.

Where a problem is classified as the fault of the other party in a transaction and the other party denies being at fault that transaction is flagged as a Problem Transaction on the records of both buyer and seller. The number of such problem transactions a user has on their record can inhibit their progression through the grades in the market. There is therefore an incentive to clear such disputed transactions. This can be done through a Dispute Resolution Module which Facilitates a time-limited dialogue between the parties, or a series of statements from one party if the other declines to take part. The resulting dialogue can include emails, records of phone conversations or meetings, scans of relevant documents and inputs from any witnesses. At any point this on screen form can be sent to an Arbitration Hub where a qualified arbitrator will rule on the dispute with all relevant material immediately in front of him. Such judgments are used to downgrade users who fail to deliver to the standard required by the contract for their transaction or those who complain wilfully. The judgements also form a body of opinion that may be called “case law” which the system uses to inform Future complainants.

In existing online markets unresolved problems are often ignored by users and therefore (a) sub-standard traders remain undetected (b) issues of acceptable behaviour within the market remain unclarified (c) requests to resolve a dispute made by one party are ignored by the other (d) there is a cumulative incentive towards mildly dishonest behaviour among users. The present invention includes a system that proactively sorts through unresolved problems within the market and selects those that should be sent for arbitration if a fund for such judgements is to be administered most cost effectively in terms of “cleaning up” areas of problems in the system. Such technology ensures users who ignore attempts at problem resolution, or treat them facetiously, must always fear that their actions will be scrutinized by someone who has power to downgrade them.

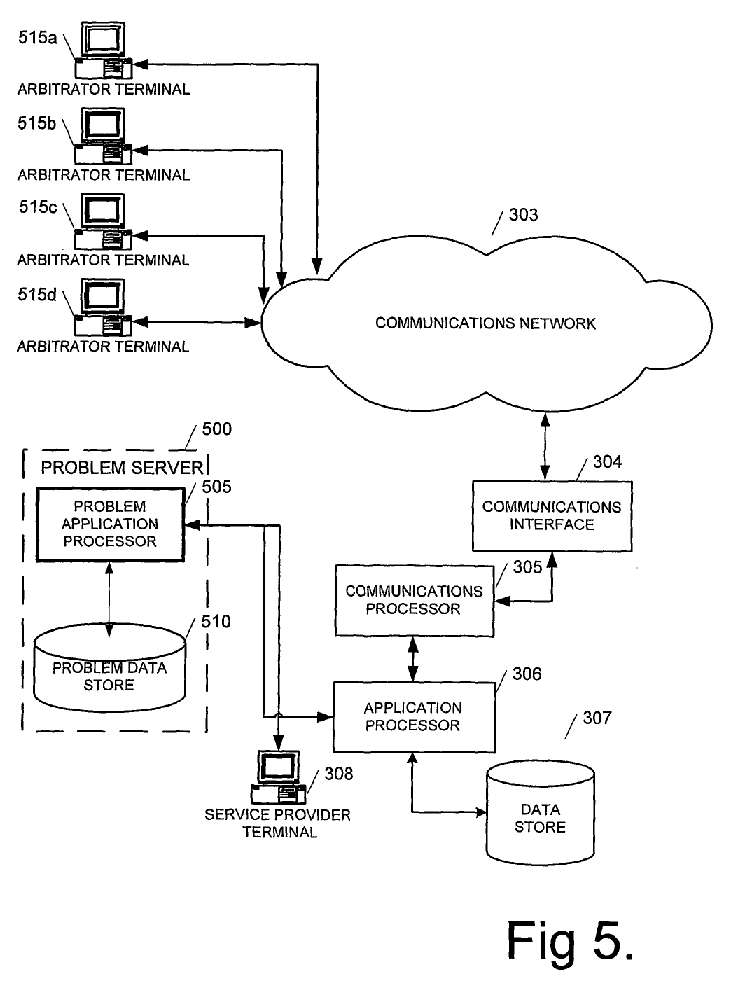

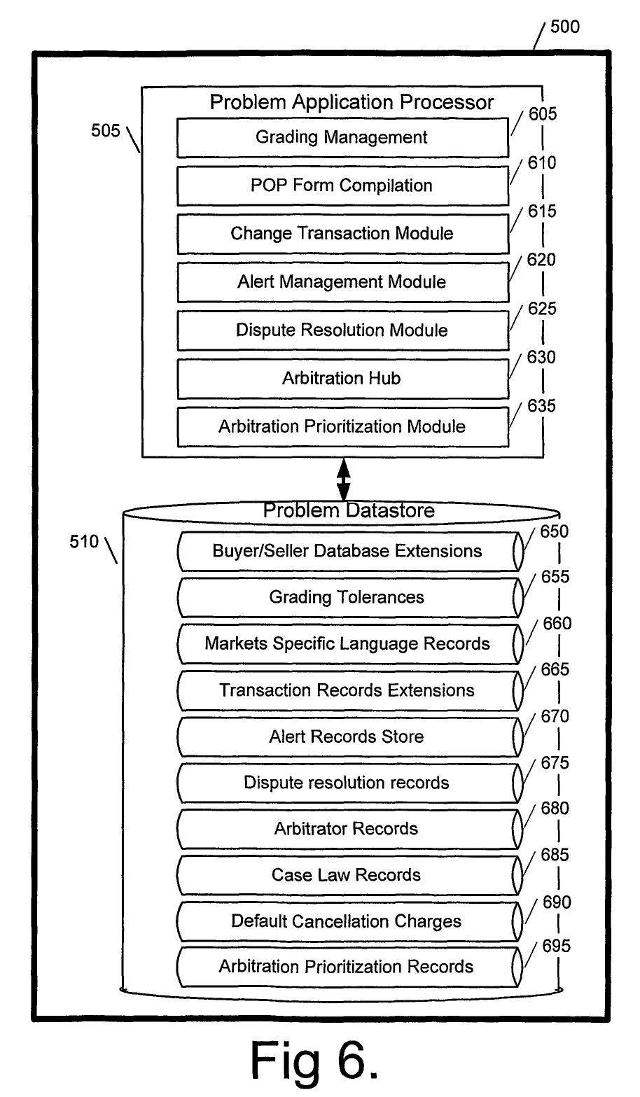

FIG. 5. shows how, in accordance with the present invention, the exemplary underlying architecture for an online market may be supplemented by a distinct server computer to manage all aspects of problems in the market. This piece of hardware may be called “Problem Server”. Problem Server 500 contains Problem Application Processor 505 and Problem Datastore 510. Additionally the system is linked through Communications Network 303 to a plurality of Arbitrator Terminals 515 used by individuals deemed suitable for arbitrating in disputes between buyers and sellers.

Those skilled in the art will appreciate Problem Server 500, Application Processor 306 and Datastore 307 could all be contained within one machine and the architecture described is for illustrative purposes only.

### Description of Software Modules

Problem application processor 505 contains the software modules required to manage all aspects of a problem transaction. These modules will now be described.

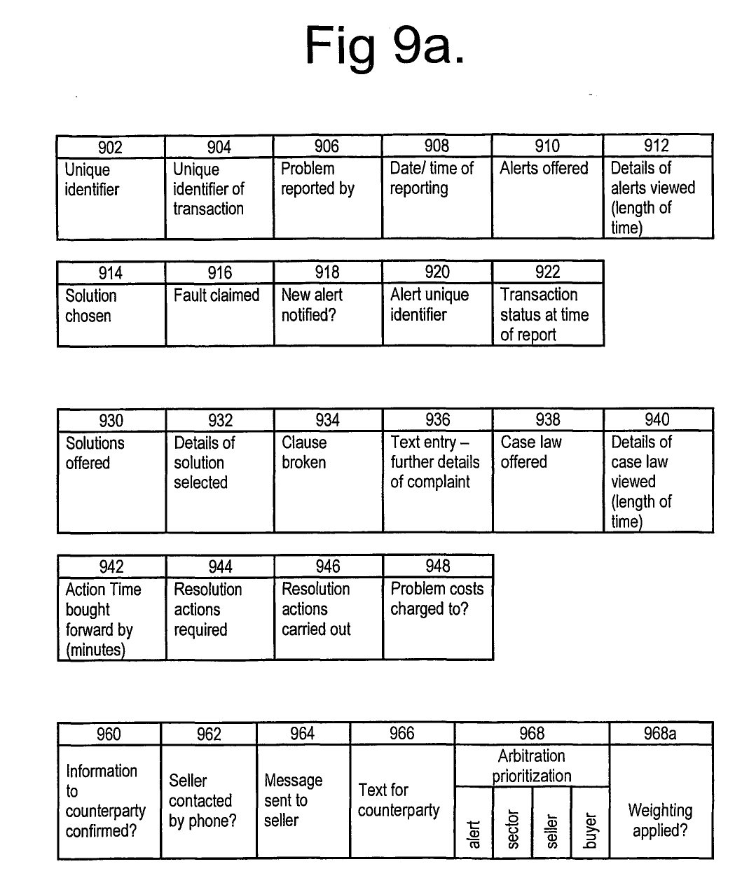

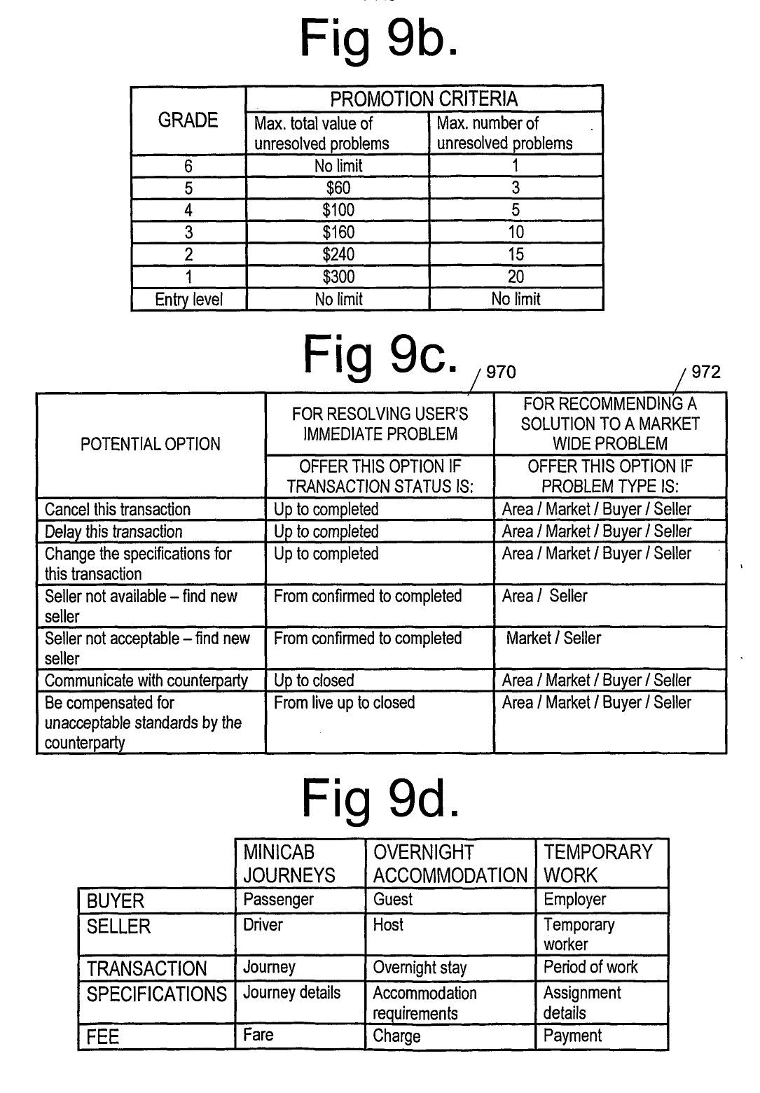

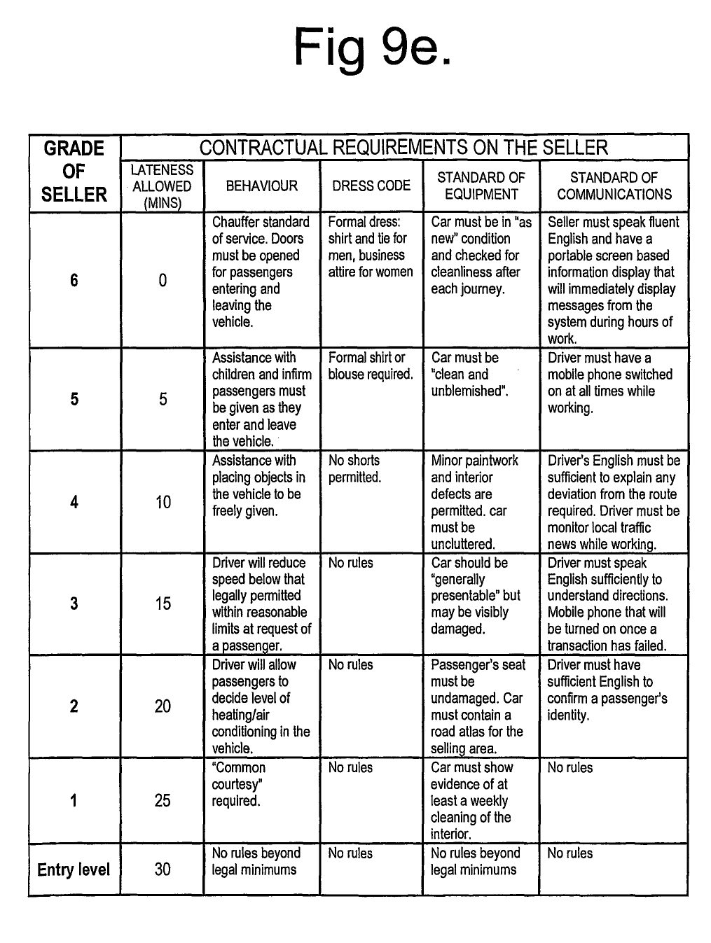

605 Grading Management. This module contains the rules by which system users are graded at any time. In the present embodiment, sellers in the system are graded; they come into the market at entry level and are then promoted higher as their number and value of transactions mount, assuming (a) they have below the permitted level of unresolved problems for the grade for which they otherwise qualify (b) the cumulative value of transactions with unresolved problems does not exceed the amount allowed for sellers in the grade for which they would otherwise qualify (c) they have not been downgraded by an arbitrator (d) they have not voluntarily downgraded themselves. An exemplary embodiment of the rules for grading sellers according to a permissible number of unresolved Problem Transactions for each grade is shown in FIG. 9b. In a preferred embodiment buyers too are awarded a grade according to their record of successful purchases with ascendancy limited by the factors already outlined for sellers. In a further embodiment, users who have initiated dispute resolution or arbitration (both processes being time limited) in respect of a Problem Transaction do not have said transaction counted in terms of their grading level.

610 POP (Point of Problem) Form Compilation module acts in response to a user clicking on an “I wish to report a problem” button relating to a transaction in which they are either buyer or seller. It exists to (a) allow swift resolution of the user's immediate problem using the resources of the wider market if necessary (b) begin the process of capturing statements regarding the failure of a transaction (c) look for early indications of a problem that may impact on other transactions either booked or yet to be booked (d) present details of relevant cases of past arbitration pertaining to the disputed transaction such information stored on Case Law Records 685 within Problem Datastore 510 (e) depositing any information received about wider problems on Alerts Records Store 670 within Problem Datastore 510.

This module compiles the specific information relating to a transaction about (a) what are the contractual obligations on a seller of this grade and a buyer of this grade before a transaction can be considered to have failed for the purposes of guaranteed replacement (b) what are the current replacement options available (c) what alerts pertain to the transaction in which the complainant is involved (d) what further actions must the complainant take to protect their own interests in any subsequent enquiry into their amending the transaction. This module also allows a complainant to amend, cancel or replace a transaction on a “my fault” basis for which they are charged appropriate costs.

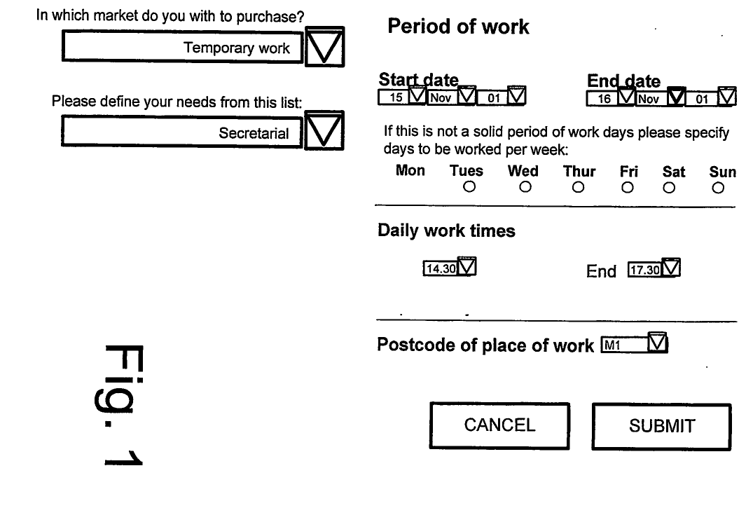

615 Change Transaction Module is able to input requirements for a change into an existing transaction stored in Transaction Database 433 in Datastore 307. This module is able to (a) create a temporary record of the seller's availability times by restoring the availability removed for this transaction to the current user's availability record (b) initiate a potential transaction by inputting the information required for a purchase as shown in manual input form in FIG. 1 (c) calculate the costs of cancellation of any given transaction, in one embodiment such charges are based on a sliding scale relating to the time before or after a booking commences, such rules being stored in Default Cancellation Charges store 690 within Problem Datastore 510 but possibly overridden by individual user preferences. All information compiled by Change Transaction Module can be stored within Transaction Records Extensions 665.

620 Alert Management Module is triggered when any set of weighting figures on Alerts Records Store 670 exceed figures specified through Service Provider Terminal 308. This module is capable of (a) selecting transactions based on geography/sector/timeframe that qualify for flagging as “likely problem transactions” (b) activating warnings of a potential problem to selected users (c) selecting users who will be asked to assess the problem based on qualifications, current geography and reliability (d) receiving reports from such users and refining existing alert.

625 Dispute Resolution Module. A transaction that has been flagged with a problem For which neither buyer or seller will accept responsibility is deemed in dispute. Users are penalised for allowing such unresolved problems to accumulate on their past transactions. Dispute Resolution Module provides a way for such problems to be cleared by either (a) accepting responsibility (b) engaging the other party in a time limited dialogue which can take several forms all of them recorded by this module (c) storing all records of such dialogues in Dispute Resolution Records 675 within Problem Datastore 510 (d) allowing either party to forward the details stored to an arbitrator through arbitration hub 630.

630 Arbitration Hub takes in dialogues referred. by a user or automatically, about disputed transactions from Dispute Resolution Module 625 and manages their time limited assessment by an arbitrator who is recognised as such in Arbitrator Records 680 within Problem Datastore 510. The costs of such arbitration are also managed by this module.

635 Arbitration Prioritization Module assesses outstanding problem transactions and decides which qualify for resolution by an arbitrator at the expense of the system operator or other external source.

### Description of Datastore

Problem Datastore 510 supplements Datastore 307 which holds the information required for buyers and sellers to transact in the underlying marketplace. Problem Datastore contains the following records.

650 Buyer/Seller Database Extensions. Each seller in the system has a record on seller database 431 stored against a unique identifier number. Likewise, each buyer has a record on Buyer Database 432. Within the Problem Datastore these records are extended to encompass specific information required for the problem resolution process. The user's unique identifying code is used to match their record in Problem Datastore with their record in the main database. In its simplest embodiment this datastore holds only an individual seller's table of cancellation charges. based on a sliding scale of percentage or transaction charge determined by period of notice For cancellation. By default the cancellation pricing is taken from Default Cancellation Charges store 690.

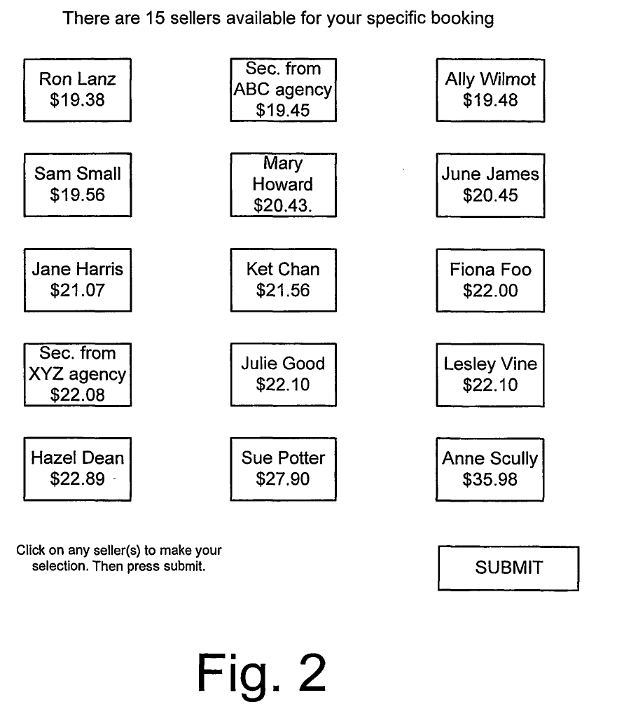

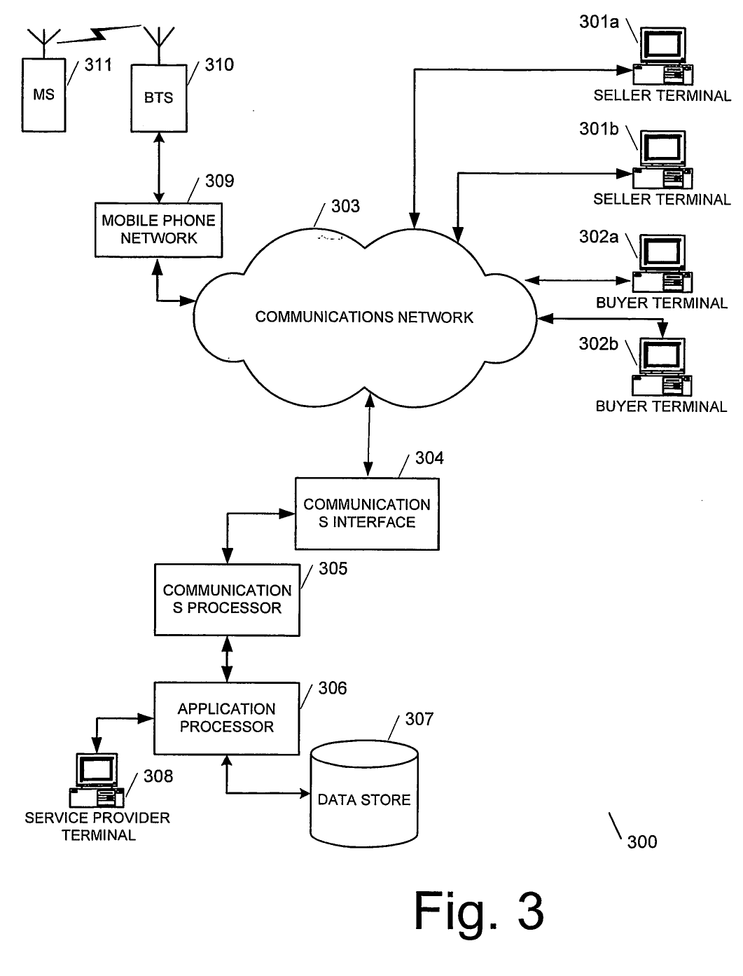

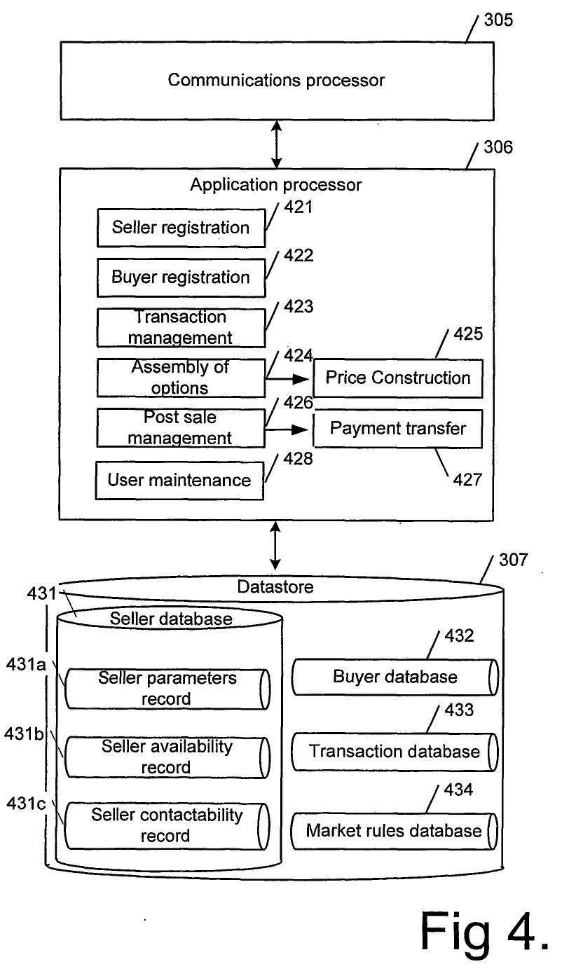

655 Grading Tolerances Records stores rules that govern the promotion of a user through grades in the market, such grades being a possible feature of the display to buyers in any transaction as shown in FIG. 2. Each market sector has a table of Grading Tolerances, an exemplary embodiment for the minicab (unlicensed taxi) journeys market being shown in FIG. 9e. The table may cover (a) permissible standards of punctuality, service, standard of equipment (where there is equipment provided by the seller in a market sector), dress code and communication that become more demanding as a seller moves up the grades (b) the number of unresolved complaints above which a user will not be permitted to stay in that grade (c) the cumulative value of transactions with unresolved complaints attached above which a user will not be permitted to stay in that grade. The information in this table is input through Service Provider Terminal 308.

660 Market Specific Language Records contains a table specific to each market sector which translates generic terms such as “transaction” into a more meaningful term for users in that market. For example “buyer” in the overnight accommodation market sector would be translated as “guest” and “seller” as “host”. A sample embodiment is shown in FIG. 9d. The information in this table is input through Service Provider Terminal 308.

665 Transaction Database Extension contains information specifically relating to a problem reported about a transaction details of which arc already stored in Transaction Database 433. Using the unique identifier in Transaction Database, Transaction Database Extension stores details of a specific problem relating to a specific transaction as shown in an exemplary embodiment in FIG. 9a. One transaction record can have a plurality of Transaction Database Extension fields attached. Each Extension contains the unique identifier code of the Transaction and a unique identifier code for that particular Extension.

670 Alert Records Store is the repository for information about market alerts declared by Alert Management Module 620. Alerts are recorded against at least one of the following (a) a named individual buyer or seller (b) a group transaction involving more than one purchaser who is likely to encounter problems of which the system is already aware (c) transactions within a particular market sector (d) transactions within a particular geographic area. Each alert has a unique identifier code and a status that is one of (a) active (b) dormant (c) closed (d) archived,

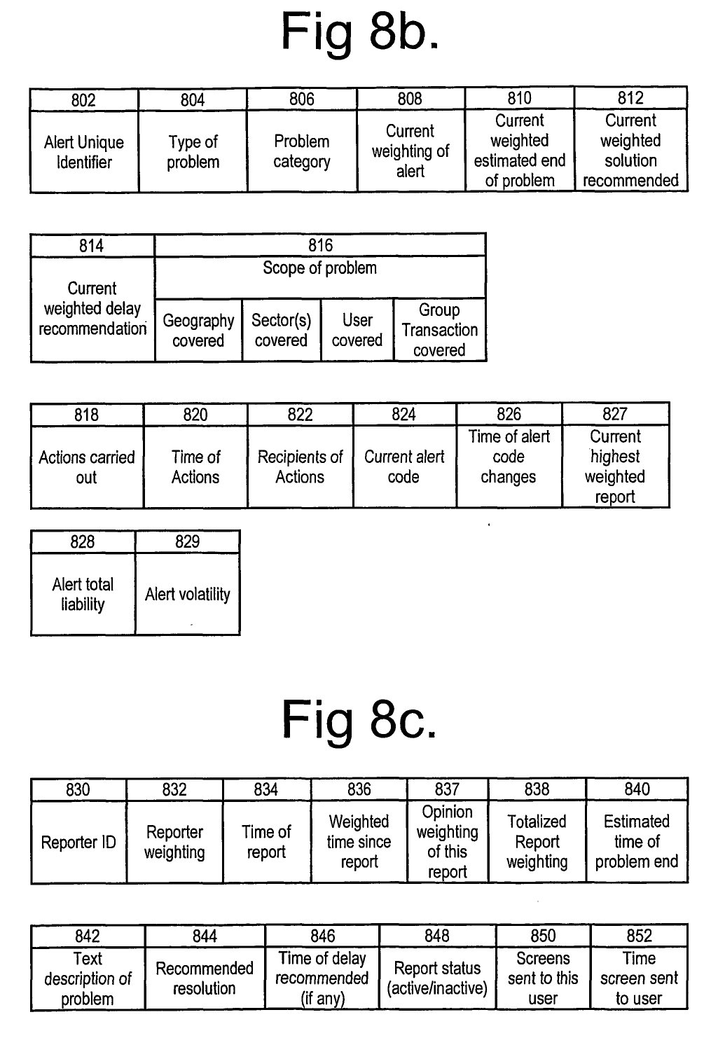

This module also stores information input by users about the problem including (a) text describing the problem (b) estimates of the likely time duration of the problem (c) estimates of geographic range of the problem (d) estimates of the market sectors likely to be affected by the problem. FIG. 8b. represents the information stored about each alert. FIG. 8c. illustrates the information stored about each report within an alert.

675 Dispute Resolution Records. Users wishing to clear an unresolved problem from their records do so through Dispute Resolution Module 625 which allows a conversation to build between the parties, or a plurality of statements to be made by either party. Such inputs are stored in Dispute Resolution Records.

680 Arbitrator Records. Stores (a) a list of individual users qualified to act as arbitrators in resolving disputes between users (b) cases currently being managed by said arbitrators with all inputs recorded for each case (c) payments due to said arbitrators for their work based on a pay scale held within Arbitrator Records and input through Service Provider Terminal 308.

685 Case Law Records. At the end of each arbitration the arbitrator is required to briefly sum up the case and his judgment about it in terms that can be used as the basis for developing case law in terms of standards demanded by the system. Each case is categorised by (a) market sector in which transaction took place (b) grade of seller (c) financial value of original transaction (d) date of original transaction (e) arbitrator's rating of significance of that case.

690 Default Cancellation Charges store. Market Rules Database 434 in Datastore 307 contains the rules and wording by which each market sector operates. The present invention requires that this information be supplemented by a default scale of cancellation charges for a particular sector to be paid to the seller, either by the buyer or by the system's own underwriting fund, when a transaction is cancelled through no fault of the seller.

695 Arbitration Prioritization Records stores the market operator's current rules regarding problem transactions that will be resolved at the expense of a central fund.

### Grading of Sellers and Buyers

The present invention is most useful when applied to a market of multiple sellers who are graded. A possible basic grading table for the underlying market is illustrated in related application WO 02/091100. A preferred embodiment of the present invention provides for additional requirements to be imposed on sellers before they qualify for promotion to a particular grade. For any given grade this limits (a) the number of transactions in which they were involved that currently have an unresolved problem flag on the record in Transaction Database Extensions 665 (b) the total value of such transactions. The means by which such a flag is generated is explained later in this document. If either figure is above the permitted level for a particular grade the seller is denied access to the grade. IF a seller already in a particular grade accumulates unresolved problem transactions exceeding the limit allowable for that grade they are re-designated to the highest possible grade for which they now qualify. This process is managed by User Maintenance Module 428 which may also generate email messages (a) advising a seller they have been downgraded or denied permission to upgrade because of unresolved problems (b) send emails warning users who are coming close to the limit of unresolved problems for their grade.

FIG. 9b. illustrates an exemplary table that governs additional requirements relating to unresolved problems for an exemplary market with an entry level grade and then six further grades through which a seller can be promoted. It will be clear that by incorporating a limit on values of transaction in such a table users are incentivized to resolve problems in the more valuable transactions to the benefit of their counterparty, this in turn increases confidence in the market as i whole. It will likewise be clear that different markets will require different tolerances of unresolved problems to encourage uniform standards across all market sectors. For example a market of small value average transaction size such as Minicab Journeys will have a lower limit for cumulative allowable value of unresolved problem transactions than a market with larger average transaction size such as a market for holidays.

In a further embodiment, standards of service and delivery required in each grade or the market might rise with each grade of seller. As a seller qualifies for a higher grade they are emailed and asked if they are willing to comply with the more demanding requirements of a new grade. Only if they then click on a link offered on their personal user page to indicate acceptance are they then promoted. Such requirements may include (a) punctuality (b) level of service (c) dress code (d) standard of equipment (where the market requires a seller to provide particular equipment, for example a car in the market for Minicab Journeys) (e) communications ability. Thus a buyer choosing to purchase, for example a minicab journey from a grade 5 seller rather than a grade 3 seller, who is likely to be cheaper, would know that the contract mandated a higher level of service. He is therefore entitled to identify a breach of contract if the higher levels mandated for grade 5 are not met as his transaction progresses. By way of example, FIG. 9e. illustrates an exemplary table of contractual requirements for a market in Minicab Journeys.

It will be clear that the foregoing could apply to buyers as well as sellers. Thus any buyer in the system may also move through a number of grades with increasingly demanding restrictions on number and totalled value of transactions which have an unresolved problem flag attached. If such grading requirements for buyers and sellers were identical for each grade it would be easy to attach one overall ranking to any user who may alternate as a buyer or seller. Sellers may be able to stipulate a grade of buyer below which their goods or services are not to be offered as a purchase option or to whom they may be offered but only at an increased price. This allows sellers to avoid buyers who allow large numbers of unresolved transactions to accumulate, possibly indicating that they complain wilfully or repeatedly cause sellers to complain about their behaviour. Thus buyers too are encouraged to resolve their unresolved problem transactions.

### The Point of Problem (POP) Screens

Unlike existing online mediation and arbitration systems, the present invention is designed to be used at any point in the lifecycle of a transaction, not just once it has passed the point where it should have been completed and is known to have resulted in a problem. At any point after a transaction is confirmed, buyer or seller can indicate to the system that there is something they are concerned about or wish to change, in relation to a transaction to which they are committed. This is achieved through displays called the Point of Problem (POP) screens. These related screens are dynamically constructed, based on (a) who is accessing them (b) what stage in its life-cycle the transaction to which they relate has reached (c) what facilities the system itself is able to offer to immediately resolve the problem (d) any information of which the system is aware that might relate to the present problem.

In overview, the POP screens are pursuing three separate processes (a) attempting immediate resolution to the user's problem (b) seeking to establish if the user's problem is likely to impact on other transactions in the system (c) capturing information required to begin allocating culpability for said problem. Each process advances by means of up to three dynamically constructed screens: POP Screen 1, POP Screen 2 and POP Screen 3. The content of each screen is created based on inputs from the preceding screens, searches of databases that are part of the overall system of markets and information about the relevant transaction held within Problem Server 500. The three processes. achieved through a possible three key screens, with possible subsidiary screens. can be summarised in the following table:

| | PROCESS | | |
|---|---|---|---|
| | | SEEKING | |
| | | INFORMATION | |
| | | ABOUT PROBLEM'S | |
| | IMMEDIATE | POSSIBLE IMPACT | ALLOCATING |
| | RESOLUTION OF | ON OTHER | CULPABILITY FOR |
| | THE PROBLEM | TRANSACTIONS | THE PROBLEM |
| INFORMATION | Broad solution desired. | Is this problem likely to | Is complainant claiming |
| CAPTURED BY POP | | affect other | this problem is the other |
| SCREEN 1 | | transactions? | party's fault? |
| INFORMATION | Is one of the detailed | Categorization of the | What attempts have |
| CAPTURED BY POP | solutions offered | problem. | been made to resolve the |
| SCREEN 2 | acceptable? | | problem at the time? |
| INFORMATION | Confirmation of | Specific details. | Any additional details |
| CAPTURED BY POP | instructions carried out | | for the dispute |
| SCREEN 3 | to user. | | resolution process. |

It will be appreciated that not every one of the three processes is applicable to every problem and those that are not are dropped from the dynamically constructed screens. For example, a buyer who simply wishes to change their requirements and accepts responsibility for that decision only needs the Immediate Resolution process. Likewise. a buyer who simply wants to cancel a transaction and accepts responsibility meaning they will pay a cancellation fee, requires only the first screen of the first process. There is no resolution process. For demonstration purposes the processes required for a more complex problem will now be described.

This example supposes a buyer has earlier accessed the page of requirements illustrated in FIG. 1. selected “Minicab Journeys” as his market and responded to questions then asked by the system about pick up postalcode, drop off postalcode, time of pick up required and number of passengers. Additionally he has been able to enter text describing the exact position he will be at in readiness for the pick up time. Such text may read “standing next to the sign outside the Jones & Co building on the corner of Station Road and Blake Street”. The following example assumes the minicab has not arrived at the time it was due. It will be clear that the given example is for explanation purposes only and applies equally to multiple transactions in a plurality of market sectors. Additionally, the following example assumes the system itself funds, within limits, replacements for transactions that fail because of general market problems such as exceptional traffic congestion. In an alternate embodiment the present invention would underwrite only failure which could be shown to be the seller's fault.

The buyer is able lo access a screen illustrated in FIG. 11. which shows all transactions in which he has been involved that have not yet reached the status of “closed” as defined for that market sector in the Market Rules Database Extension as shown in FIG. 8a. He is able to report a problem with any or the transactions shown. Columns 1105 to column 1135 display basic information about the transaction as recorded on Transaction Database 433. Column 1140 allows the full details of a transaction to be displayed including (a) time of booking (b) details of counter party (c) any further breakdown of price charged. Column 1145 allows the user to report a problem with a particular transaction.

Compiling POP (Point of Problem) Screen 1:

Turning now to FIG. 12. this represents an embodiment of the first part of Point of Problem (POP) Screen Compilation module 610 within Problem Application Processor 505. It is activated once a user has, using the screen in FIG. 11. identified a transaction in which they are involved and relating to which they wish to report a problem. The process compiles a screen of information for that user telling him (a) of any existing problems known to the system that might relate to the transaction selected (b) what the system is able to do to resolve the problem if that is what he requests (c) the options from which lie may chose a resolution.

The process starts at step 1205 When the “report a problem” option against a specific transaction is selected using column 1145 on the screen shown in FIG. 11. At step 1210 a problem record is established within Transaction Records Extensions 665 in Problem Datastore 510. Said record is illustrated in FIG. 9a. This record includes the unique identifier code For the individual transaction in Transaction Database 433 and the transaction status at time of reporting. Transaction Database Extension 655 will hold all information pertaining to the problem. At step 1215 the relevant record in Transaction Database 433 is looked up to establish the current status of the transaction, such status codes are shown in FIG. 8a.

If the transaction has live status (meaning the date/time at which it was due to start has been passed but the date/time at which it was due to end has not been reached) step 1220 compiles available options for a replacement seller. It activates a new purchase process by extracting data from Transaction Database 433 about the buyer's requirements but changing the time of requirement to the present. Additionally at step 1220 Transaction Database 433 is consulted to ascertain (a) whether the transaction is guaranteed by the system (b) if the transaction is guaranteed by the system (that is, the system itself will fund the difference in costs of a new seller from its Underwriting Fund) what is the limit on unit cost for a replacement seller? The information for (b) is stored in an underwriting database as described in the application PCT/IB02/01475 listed earlier in this document. If the transaction is guaranteed, any seller options returned by the search, as demonstrated in FIG. 2, with unit cost higher than the limit are rejected. The lowest cost seller of grade equivalent to the original purchase or higher is selected and becomes the Replacement Option. If a transaction is not guaranteed the price and details of the cheapest available seller of equivalent grade to the original seller is stored. This information is recorded on Transaction Database Extensions 665.

At step 1230 the process checks for any relevant alerts stored in Alert Records Store 670 within Problem Datastore 510. An alert is a record of a problem already reported by a user with sufficient weighting to generate an alert that said problem may be expected to impact on other users. The process whereby such alerts are created will be disclosed later in this document. Each alert is designated by at least one of the following parameters (a) postalcodes covered by problem (b) market sector or sectors covered by problem (c) specific sellers covered by problem (d) specific buyers covered by problem (e) specific transaction covered by problem, (this would apply in a grouped purchase for instance where a number of individuals had booked rooms in a hotel where there was known to be a problem this evening). Additionally each alert has a time when it will expire.

If step 1230 discovers more or one current alerts recorded against the market sector, geographic area of seller's base postalcode or place of transaction postalcode, seller, buyer or specific transaction, the alerts' Unique Identifier codes are stored on Transaction Database Extensions 665 at step 1235. In a further embodiment of the present invention the search for alerts would cover not just the postalcode or map reference for the start and end of the transaction but those on a line between the two, said line constructed by journey planning software of the type well known to those in the art. Thus the system is warning users of potential problems that could be encountered on the journey to a place where a transaction was to commence.

At step 1240 the process consults the Options Table represented in FIG. 9c and stored within Default Cancellation Charges store 690. Using the status of this transaction as recorded in Transaction Database Extensions 665 it selects the options that can be presented to the user. At step 1245 the status of the present transaction in Transaction Database 433 is changed to Live—problem reported”. In a preferred embodiment a timer is simultaneously set at step 1245a. If the user registers no further information about this problem in a period defined in Default Cancellation Charges store 690 and input through Service Provider Terminal 308, such period for example being 10 minutes, the status will revert to whatever status would be appropriate if no problem had been reported.

At step 1250 the textual information to be presented to the user is translated using Market Specific Language Records 660 as illustrated by FIG. 9d. This is to make it immediately comprehensible for the user. The final screen comprising (a) any alerts pertaining to this transaction (b) the user's best replacement option (c) the choice of solutions available, is now ready. POP Screen Compilation Module 610 supplements this with (a) a sentence on any report from the counterpart)y in this transaction (b) any current cancellation cost for this transaction as computed using individual cancellation data in Buyer/Seller Database Extensions 650 or default cancellation data in Default Cancellation Charges store 690. At step 1255 the resulting data is sent to Communications Processor 305 and displayed to the user.

Display of POP (Point of Problem) Screen 1:

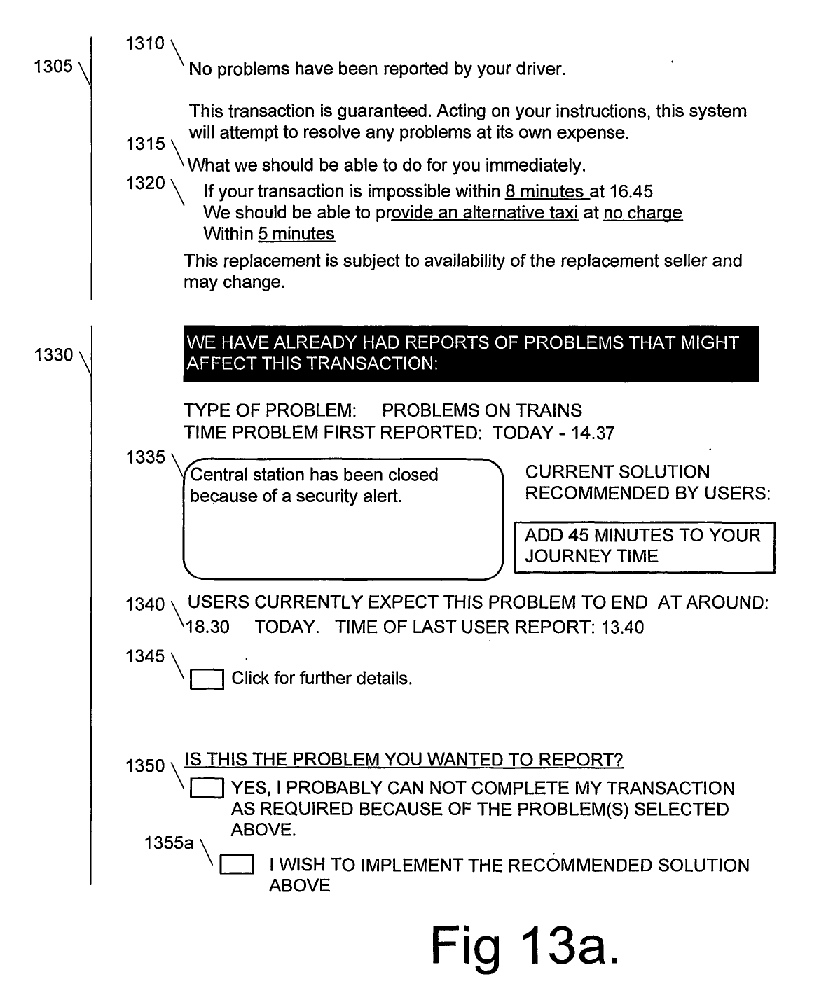

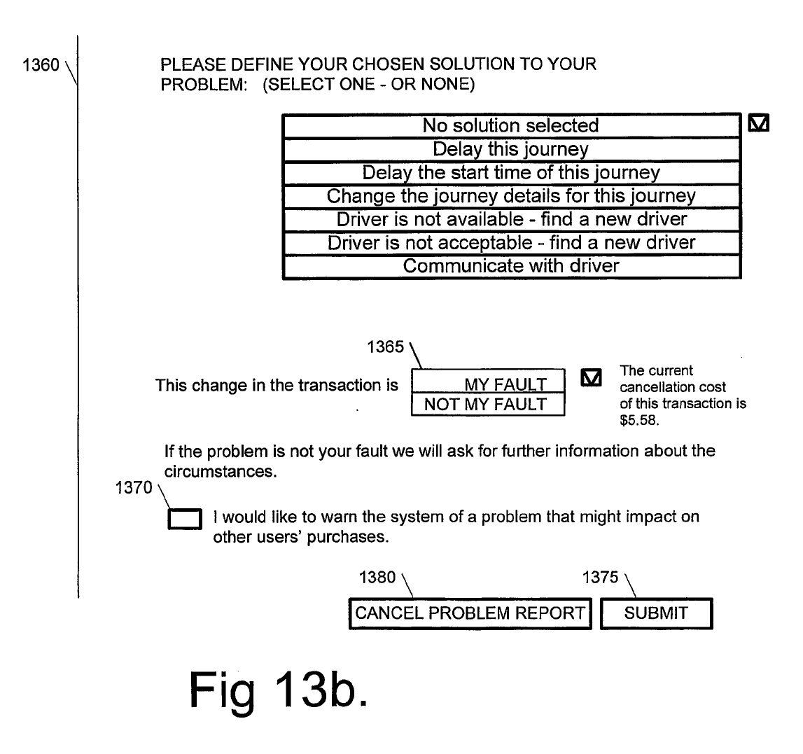

Turning now to FIG. 13a. and 13b. These are an illustrative example of the screen produced, as explained above, in response to a user's report of a problem. This is called Point of Problem (POP) screen 1. FIG. 13a. shows section 1305 which is included at the top of all such screens. It outlines what the system can do to resolve a problem with this particular transaction. Line 1315 is based on the point at which the transaction status will change from “live—before action time” to “live—after action time”. Action Time marks the end of the period of allowed lateness under the contractual terms of that grade of seller as stored in Grading Tolerances 655 and shown illustratively in FIG. 9e. This information is used to automatically change the transaction status as time, relative to the point at which the transaction was due to start, passes. In an alternative embodiment the “allowable lateness” of a transaction might be expressed as a percentage of the overall length of transaction or part of transaction. For example it may be that a Grade 4 seller is allowed up to 10% of the first period of booking to be late. “Period of booking” could be a day's work from start to finish time or, in another illustrative example, the time purchased between check-in and intended departure for a night in the overnight accommodation market.

If replacement of the transaction were not underwritten by the system's own funds the main text in section 1305 might read “we have a replacement seller of equivalent grade available to fulfil this transaction in X minutes for a total cost of $Y. Click if you wish to see a further range of replacement options”. Line 1320 shows the time by which a replacement option could currently be available if purchased.

Line 1310 reports any existing record Transaction Records Extension 665 with the Unique Identifier code for this transaction. Had the counterparty already reported a problem in this example line 1310 might read “the driver of your minicab has reported a problem, click here for details”. By clicking on the link the buyer could see his counterparty's inputs on (a) selected option for resolution (b) any text describing the problem and the intended solution (c) a contact number (telephone or pager for example) by which the counterparty could be contacted.

Section 1330 within FIG. 13a. is the output of one alert, in this case a report of public transport problems in the postalcode area in which the transaction is to take place. The text at line 1335 has been input by a trusted user and stored in Alert Records Store 670 by Alert Management Module 620. Line 1340, a current estimated end time for the problem is likewise taken from a trusted user, or the combined input of trusted users, as will be described later in this document. Button 1345 allows the user to view any additional details held against this problem in Alert Records Store 670. This might include reports from additional users with the time at which each was received.

Line 1350 allows the user to signify that this already known wider problem is the cause of his particular problem. This statement by him will be recorded. along with the unique identifier of the alert, and will sit on his record of unresolved problems. Thus his claim to have been the victim of a particular problem may be challenged in the future and he will be downgraded if falsely claiming to be the victim of a wider problem which could be shown not to impact on his transaction.

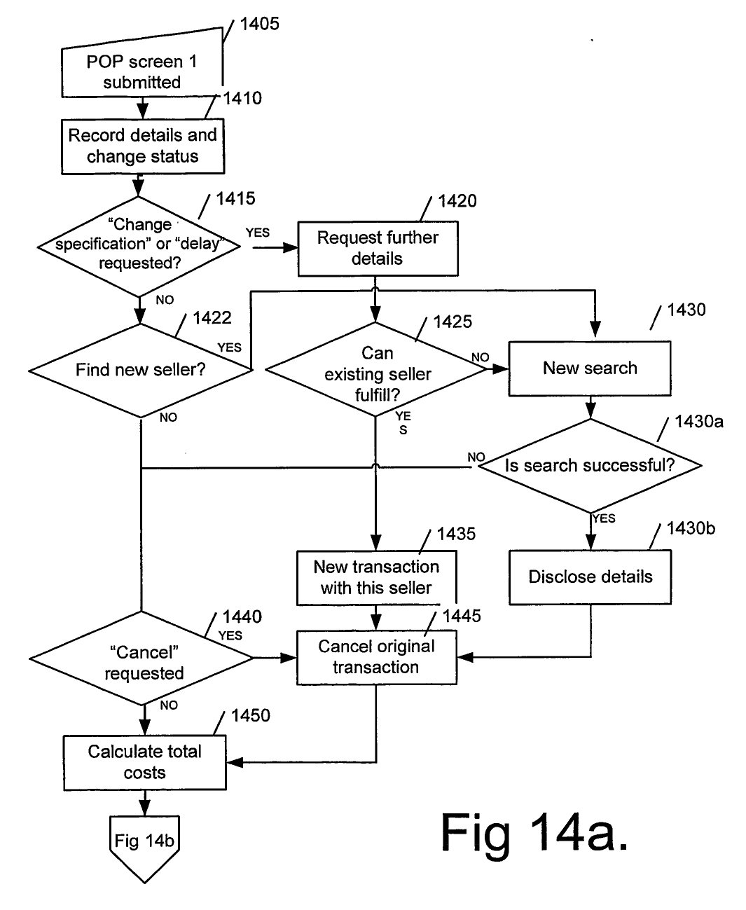

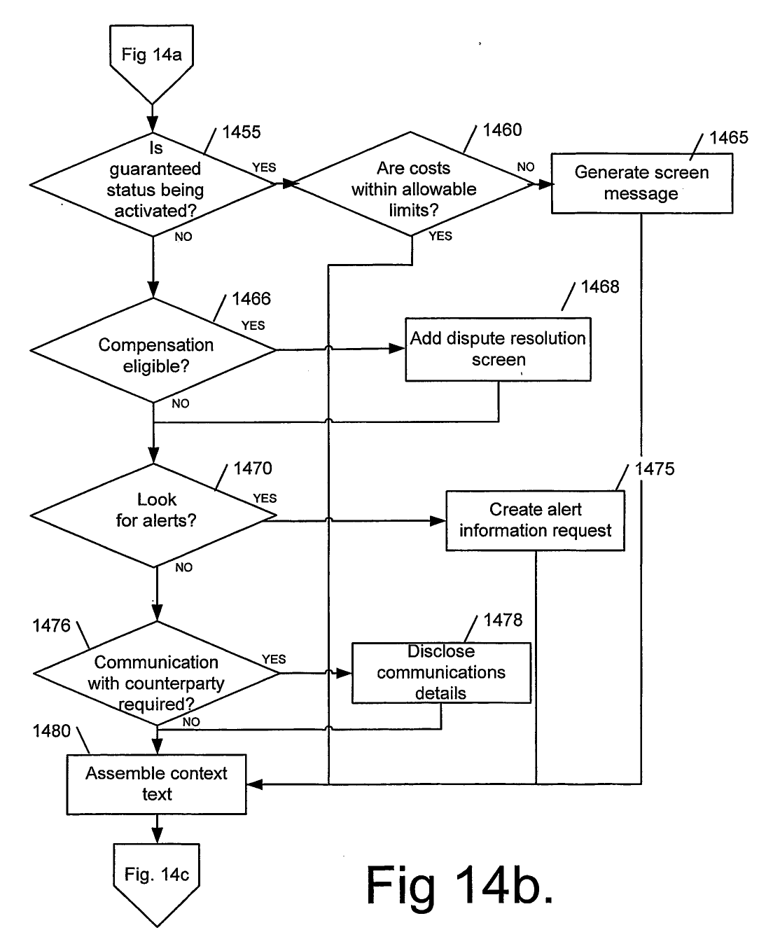

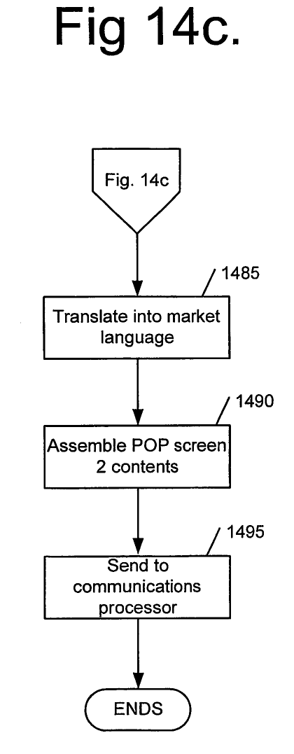

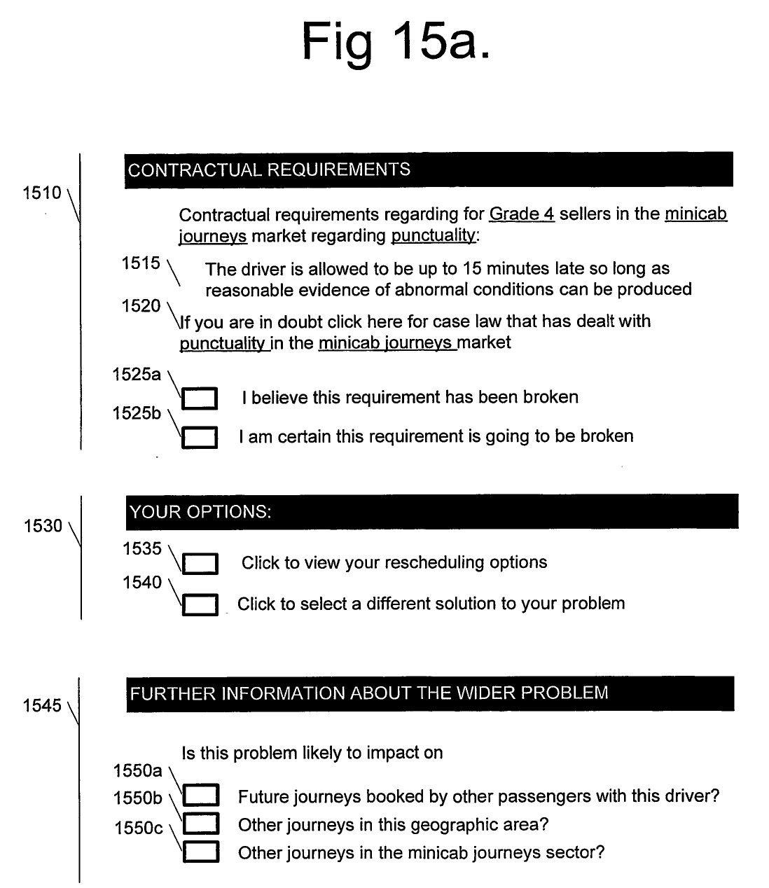

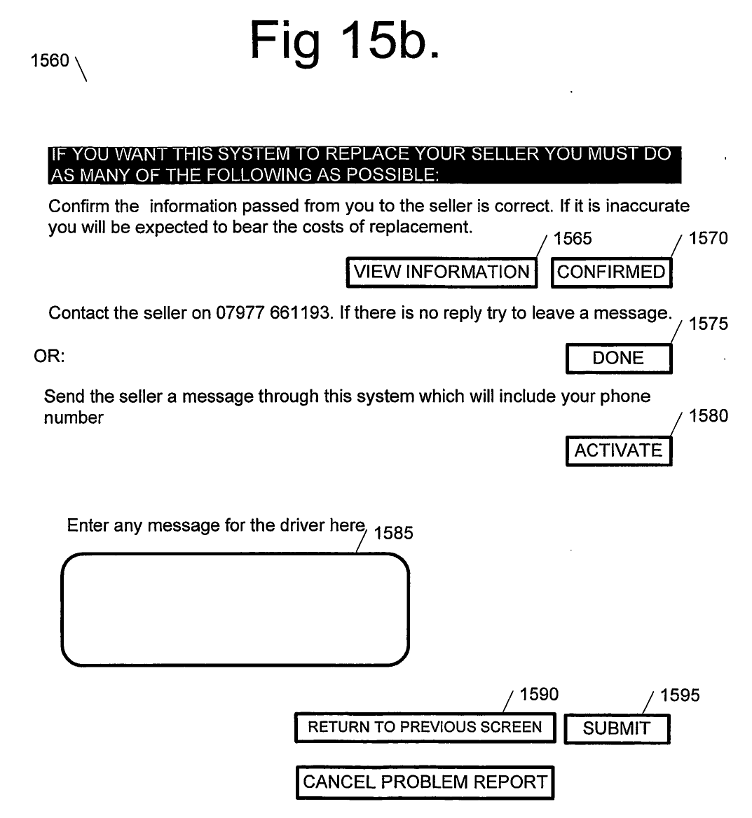

Button 1355a only appears where there is a recommended solution” available. It automatically assumes the desired solution input from POP screen I to be “delay this transaction by 45 minutes” (the recommended solution at this time) thus step 1420 where further information is requested about a desired delay can be omitted from the process shown in FIG. 14a. Once button 1355 has been selected the other part of POP screen 1, as illustrated in FIG. 13b turns to gray and becomes inactive.

Moving now to FIG. 13b. the user is able to select one resolution to his problem from the list compiled at step 1240 in FIG. 12. Furthermore, the user must decide if the problem is his fault (the default setting) or not. Thus, if he has simply changed his mind about what he wishes to buy he can be charged for cancellation of the first transaction and possible replacement by a new purchase with no record of a problem transaction recorded against him. That is a straightforward process, for exemplary purposes this example will continue to deal with a transaction in which the reporting user claims the problem is not his fault.

Line 1370 allows the user to report a problem that might become the subject of an alert. It will be clear that doing so is in the user's interests if they arc claiming a problem is “not my fault”. Their claim may be investigated by an arbitrator and any information from other users about a problem will support their case strongly.

Submit button 1375 sends the form to Communications Processor 305 from where it is routed to POP Screen Compilation Module 610. This triggers the process outlined in FIGS. 14a. and 14b. The purpose of this process is to (a) implement the user's desired solution (b) capture any further information that may help the alert generation process (c) inform the user of what is happening to resolve his problem (d) collect any further data required for apportioning blame for this problem. Button 1380 removes the problem record within Transaction Records Extensions 665 and re-sets the transaction status as it would have been with no problem reported. This button can be selected at any point in the Point of Problem reporting process.

Creating POP (Point of Problem) Screen 2:

FIG. 14a. outlines the processing of a user's inputs to the above screen by POP Form Compilation module 610. This begins the process of creating POP (Point of Problem) Screen 2 for this user. The process starts at step 1405 once submit button 1375 has been clicked. At step 1410 the user's inputs are recorded on Transaction Database Extensions 665 as illustrated by FIG. 9a. If there is already one or more Transaction Database Extensions for this transaction stored in Problem Server 500 (a) an entry input by the buyer is deemed to have dominance over an entry input by the seller in terms of selecting a resolution to the problem (b) the seller's most recent input is deemed to be the one that is acted upon.

The status of the transaction is also changed at step 1410 to one of 3 options based on the circumstances. (a)

If the complainant has selected “reschedule with another seller” or “cancel” in combination with “not my fault” the transaction status is changed to “completed—in dispute”. (b) If the user has selected either of the above in conjunction with “my fault”—status is set at “cancelled”. (c) If user has selected “delay this transaction” or” change the specifications for this transaction” the status is set at live—problem reported.

At step 1415 the process reads the chosen solution by the user. If it specifies “change the specifications for this transaction” or “delay this transaction”, Further details are required. In one embodiment of the present invention this creates a separate screen at step 1420 which presents the user with his original inputs into the screen shown by FIG. 1. that initiated the present transaction. He is asked to change his inputs, in the case of delay by inputting a new time when he wishes the transaction to start, or in the case of changed specification by inputting new requirements. In an additional embodiment, if the present transaction is a Grouped Transaction, an additional query page is generated asking if the problem being reported is going to impact on all other purchasers involved in that purchase from that buyer at that time. If the response is Yes, (a) all further steps assume the entire group of purchasers had filed the complaint and seek the same solution (b) a message is sent to all impacted users announcing the problem (c) a further message is sent to any users who qualify for underwriting about the likely replacement transaction (d) a Grouped Transaction alert is generated with the original reporter given disproportionately heavy weighting to reflect their taking responsibility for rescheduling an entire Grouped Transaction.

At step 1425 Change Transaction Module 615 retrieves the time availability that was removed from the seller's availability diary to enable the present transaction, from Transaction Database 433 and temporarily input back into the seller's availability diary within Seller Availability Record 431b. The new requirement from the buyer is then searched using just the present seller as defined pool of sellers. This is also the process triggered at step 1422 if the problem resolution specifically requires a new seller, for example because the complainant had selected “the counterparty is not acceptable”.

If the search at step 1425 is not successful step 1430 re-runs the search with the pool of sellers as defined in the original transaction. It then selects the best value seller of equivalent grade or above to the present seller and adds details and price to the information stored about this problem on Transaction Database Extensions 665. At step 1430a, if the search for a replacement seller fails to produce a seller an apology message is generated and added to the information to be displayed to the user. Assuming a replacement seller can be found, because this is a replacement transaction and there may be problems to be resolved, communications details of buyer and seller are released to each other so that phone contact can immediately be established. These details are located in Seller Availability Record 431b or Buyer Database 432 and added to the data to 35 be returned to the user at step 1430b.

At step 1445 the original transaction is cancelled with cancellation charges for that seller from Buyer/Seller Database Extensions 650 added to Transaction Database Extensions 665. Likewise the cancellation process can be triggered at step 1440 by a user input in section 1360 of the screen represented by FIG. 13b. which requires a new seller or a cancellation of the transaction. The unique identifier codes of the original transaction and the new transaction are recorded in Transaction Database Extensions 665.

If the existing seller can fulfil the changed requirements at step 1425 the process moves to step 1435. This turns the status of the original Transaction Record in Transaction Database 433 to “Cancelled” with “cancellation fee charged” set at zero. In an additional embodiment of the present invention the cancellation fee could be set at a fixed rate for changed transactions where the same seller can meet the amended requirements, such rate might be 10% of the original transaction charge as input through Service Provider Terminal 308 and stored on Default Cancellation Charges store 690 for each market sector. A new Transaction Record is then created based on the new requirements. The unique identifier codes of the original transaction and the new transaction are recorded in Transaction Database Extensions 665.

If the user has selected “cancel transaction”, step 1440 instructs step 1445 to change the status of the original transaction to “cancelled” and calculate the cancellation charge as above. At step 1450 the combined costs of (a) any new transaction and (b) any cancellation fees from the original transaction are added.

Turning now to FIG. 14b. step 1455 of POP Form Compilation module 610 checks (a) if the complainant is claiming “not my fault” for this problem (b) if so, whether the transaction has guaranteed status, that is the system itself will underwrite the additional costs of replacing the seller within defined limits. This information is contained in the transaction's record in Transaction Database 433. If both these conditions are met, step 1460 checks that the maximum allowable expenditure on replacement as stored earlier is greater than the sum calculated at step 1450. If it is not, a message for the user is generated at step 1465 to be added to the screen returned. An exemplary message might say “we are sorry that we can not reschedule this transaction at this time. Any alternative options must be bought at your expense. This is because our contract for replacement limits the cost of replacement options”.

Step 1466 checks whether this problem requires compensation for specific wrongdoing. This is indicated if the user selected “Be compensated for unacceptable standards” from the list of options for resolution displayed in FIG. 9c. and offered to the user within section 1360 of the screen illustrated in FIG. 13b. If this is the case a first dispute resolution screen as disclosed later in this document is prepared for the user. This enables a dialogue to build between the two parties with possible resolution through agreed compensation or the creation of a problem transaction record.

Step 1470 queries whether this problem should be regarded as a potential contributor to the alert process, that is the user could be reporting a problem which would be likely to impact on transactions beyond his own. It regards a problem as requiring more information about this if any of the following conditions are met (a) the user has clicked on line 1350 on the screen represented in FIG. 13a. (b) the user has clicked on line 1370 on the screen represented in FIG. 13a. (c) the user has selected “not my fault” in line 1365. If any of these conditions are met step 1475 inserts section 1590 in the screen represented by FIG. 15b. into the return form being assembled for the user. If the transaction is a Grouped Transaction, that is it involves one seller and multiple buyers for example seats on a minibus. an alert is automatically generated. If one transaction is in trouble then it is likely others will be also.

Step 1476 checks whether the complainant is required to make efforts to contact the counterparty. This is the case if the user selected “not my fault” at line 1365 within section 1360 of POP screen I as illustrated within FIG. 13b. If so, at step 1478, communications details for the counterparty are disclosed are located within Buyer Database 432 or Seller Database 431 and added to the information that will comprise POP screen 2.

The present invention is intended for markets which offer a contract between parties as part of the original transaction process. Thus, the parts of that contract pertaining to the current problem need to be offered to the complainant so that he is aware of the standards which he is entitled to insist on. Therefore, at step 1480, if the buyer has selected “not my fault” POP Screen Compilation Module 610 reads appropriate data for the level of service for this grade of seller in this transaction as illustrated by FIG. 9b. and stored in Grading Tolerances Records 655. Additionally Case Law Records 685 is scanned for material relevant to this complaint. This generates information enabling the user to (a) identify the clause of his contract with the other party which he believes has been broken (b) put his complaint into a context of the levels of enforceable service for the transaction for which he paid (c) view any relevant case law relevant to his complaint (d) if “Action Time” has not been reached explain the resolution options likely to become available after “Action Time” (e) explain what the complainant must do to have taken every reasonable step before legitimately declaring the present transaction to have failed. The text so assembled forms section 1510 and 1560 of the return screen as illustrated in FIG. 15a.

Turning to FIG. 14c. At step 1485 all the text for POP Screen 2 is translated through Market Specific Language Records 660 to make it specific to this market. At step 1490 the return page is constructed with details of price removed if the transaction is being rescheduled as a guaranteed transaction. At step 1495 the finished page is sent to Communications Processor 305 for transmission to the user.

It will be clear that, if the transaction is to be cancelled, an additional page will need to be generated for the other party. This will (a) inform them of the cancellation (b) detail any cancellation fee to be paid (c) in the case of a buyer cancelling, ask the seller if they wish to re-instate the availability to sell that was removed to enable the present transaction.

Display of POP (Point of Problem) Screen 2:

FIG. 15a. and 15b illustrate the screen produced by the process above. This is POP (Point of Problem) Screen 2. The aim of POP screen I is to understand the user's problem and how he expects it to be resolved. POP screen 2 (a) gives him his specific options for resolving his problem (b) tells him what is required of him if the system itself is to resolve his problem.

POP screen 2 divides into four sections. (a) Section 1510 shows the complainant the contractual requirements of this transaction relating to the buyer if lie is the seller and to the seller if he is they buyer and asks which section he believes been breached by the other party. This section also seeks to establish whether the problem is likely to impact on other transactions within the system. (b) Section 1530 displays the options for resolution. (c) Section 1560 appears only if the complainant has indicated “not my fault” and ensures he takes all reasonable steps to confirm there is a legitimate problem before it is regarded as failed transaction.

It will be appreciated by those familiar with the art that this screen would be very simple for some categories of problems. For instance, if the user had selected the options “cancel this assignment” and “my fault” on POP screen I the returned page would simply confirm the transaction had been cancelled and list the cancellation fee that he would be charged. The following description continues with the example of a buyer whose minicab has not arrived where the transaction is guaranteed by the system. This will illustrate the more complex form of screen POP 2. Each part of the screen will now be described in detail.

Turning first to section 1510. This appears only if the complainant has selected “not my fault” on POP screen 1. Compiled at step 1480 this display table reads information from the grid illustrated in FIG. 9d. which is stored in Default Cancellation Charges store 690 against the market sector in which this transaction took place, for example “minicab journeys”. If it is the buyer complaining the appropriate requirements for the grade of seller in this transaction are shown with the complainant asked to define which clause he believes has been broken. Likewise if it is a seller complaining about a buyer he is shown the contractual requirements on the buyer for that level in the market. Any number of options can be selected, such details becoming part of the problem record in Transaction Database Extensions 665. They can thus be called up by an arbitrator seeking to rule on who is at fault at a later point.

Line 1520 allows a complainant who is not sure if the terms of their contract have been broken to call up relevant case law. This line is displayed only if there is appropriate case law for this market sector, this is checked at step 1480. Such case law is read from Case Law Records 685. The system aims to display a maximum number of cases, such number being defined through Service Provider Terminal 308. An exemplary limit on the number of case law descriptions to be shown might be five. The available case law might be searched in terms of (a) market sector (b) contract clause broken punctuality/level of service/dress code/standard of equipment (if appropriate to that market sector)/standard of communications (c) grade of seller to which the case law pertains. If this produces more than the maximum number of cases the available cases are ranked in order of most recent judgment and the top five returned to a user clicking on button 1515. Such cases open in a separate screen window allowing the user to peruse previous related cases and assess whether an arbitrator would share their view that the contract for purchase had been breached.

Button 1525a allows the complainant to signify that they are confident the contractual terms have been breached. Button 1525b allows them to inform the system that the requirements have not actually been breached but the user has no doubt that they will be.

Button 1535 allows the user to see a version of the screen illustrated in FIG. 2. which shows options for his new transaction. This may take the form of just one option that the system will fund as a replacement. Button 1540 brings up section 1360 of screen 13b and allows the user to change their desired solution to the problem. This will overwrite the information already stored in Transaction Records Extensions 665.

Moving to section 1545. Buttons 1550a,b,c are displayed if a wider problem is signified. They allow the complainant to give more information about a problem that might impact on other transactions in the marketplace. If the present transaction was a grouped transaction this section would include a fourth button “other purchasers from this seller at the same time as my purchase”. Any number of these options can be selected.

It is in a complainant's interest to select one of the buttons within section 1545 if they believe the problem they are identifying could impact on multiple transactions because an arbitrator will then be able to access related reports from other users which should confirm the complainant's account. By selecting this option the complainant is asked for more information which creates a record on Alert Records Store 670 under which all related reports of a problem are also stored and can be accessed by an arbitrator.

Turning now to FIG. 15b. which forms part of the illustrative POP (Point of Problem) Screen 2. If both the following conditions are met step 1480 generates section 1560: (a) status of transaction is “confirmed” or “live” (b) a transaction is classed as “not my fault” by the complainant—regardless of whether this is a guaranteed transaction. Section 1560 shows what the complainant should do if they are to have responsibly dealt with a problem at the time it occurs. Button 1565 allows the user to review the information transmitted to the other party about this transaction as stored on Transaction Database 433. Button 1570 allows the user to confirm they have checked this and it is correct, if it is not they are able to use button 1590 to return to POP screen 1 and select “my fault”. Button 1575 is generated if there is a known phone number or phone numbers for the other party. Such numbers—or other immediate means of contact such as pagers—are displayed and the complainant invited to confirm that they have made every reasonable attempt to resolve the problem through conversation with the other party. Alternatively Button 1580 allows a message to be sent through the system to the other party to which they can respond.

Text box 1585 encourages the user to record any substantial points about their attempts to contact the counterparty. If button 1520 has been selected this text will be among details made available to the counterparty. Submit button 1595 is to be clicked once the form is completed.

Creating POP (Point of Problem) Screen 3:

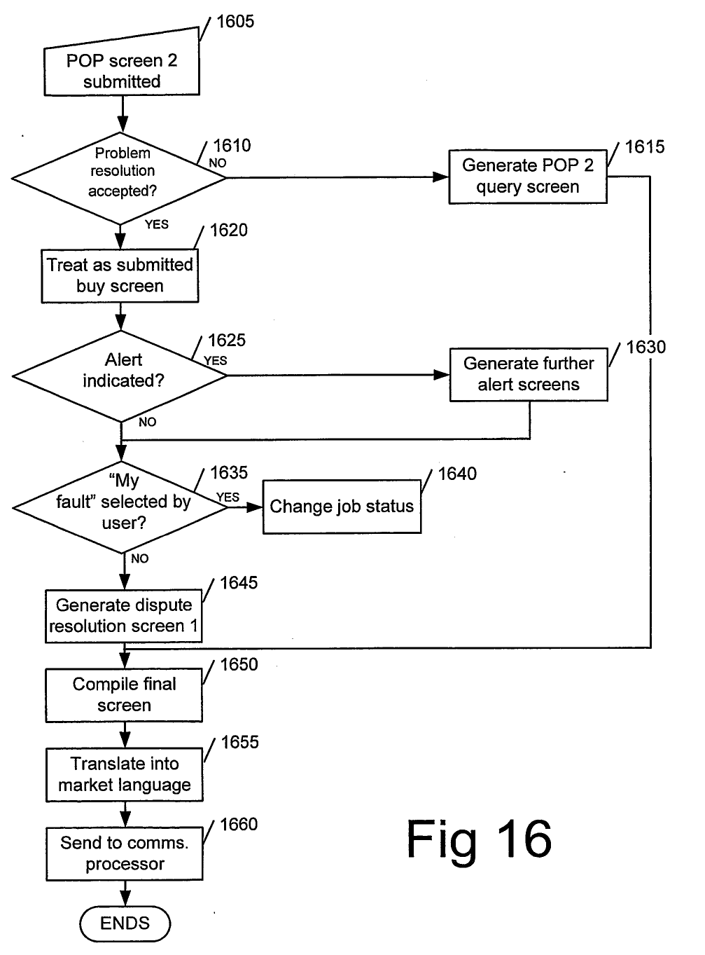

Turning now to FIG. 16. which illustrates the process triggered by submission of the screen just described within POP Screen Compilation Module 610. This process performs a possible three functions: (a) instigating a rescheduling of the transaction either with the existing seller or with a new seller (b) begins the process of registering an alert about a problem that may impact on multiple transactions (c) potentially lodges a “disputed transaction” flag on the record for this transaction, this will need to be cleared by the parties if they are to maintain their record for grading purposes. Each step will now be described in detail.

At step 1605 a completed POP (Point of Problem) screen 2 is received and verified, for example to ensure that if the complainant is claiming “not my fault” they have indicated which clause of the contract they consider to have been breached. Section 1560 does not have to be completed, although it is in the interests of the complainant to do so. All the inputs from the previous screen are stored in the record for this transaction in Transaction Database Extensions 665.

At step 1610 the process checks (a) that a rescheduled transaction was offered in section 1530 of the screen illustrated by FIG. 15a. (b) that one of the options for a new transaction were accepted. If they were offered but not accepted, at step 1615, the user will be offered a new version of the screen shown in FIG. 1. that contains their original entries stipulating a requirement but a start time of “as soon as possible”. Thus the user can change their requirements. In a preferred embodiment, doing so in any way other than time of start will cancel the system's willingness to underwrite a failed, but guaranteed, transaction. This ensures a user can not be the beneficiary of transactions of added value through the underwriting.

At step 1620, if rescheduling is required and an option has been selected, Transaction Management Module 423 is triggered to purchase the new option. This generates further pages that might be required to display to the complainant (a) a contract page for the new purchase (b) “information for your counterparty” page. Both pages are an obvious part of the marketplace underlying the present invention and have been previously described in this document. They are added to the final screen to be returned to the complainant at step 1650.

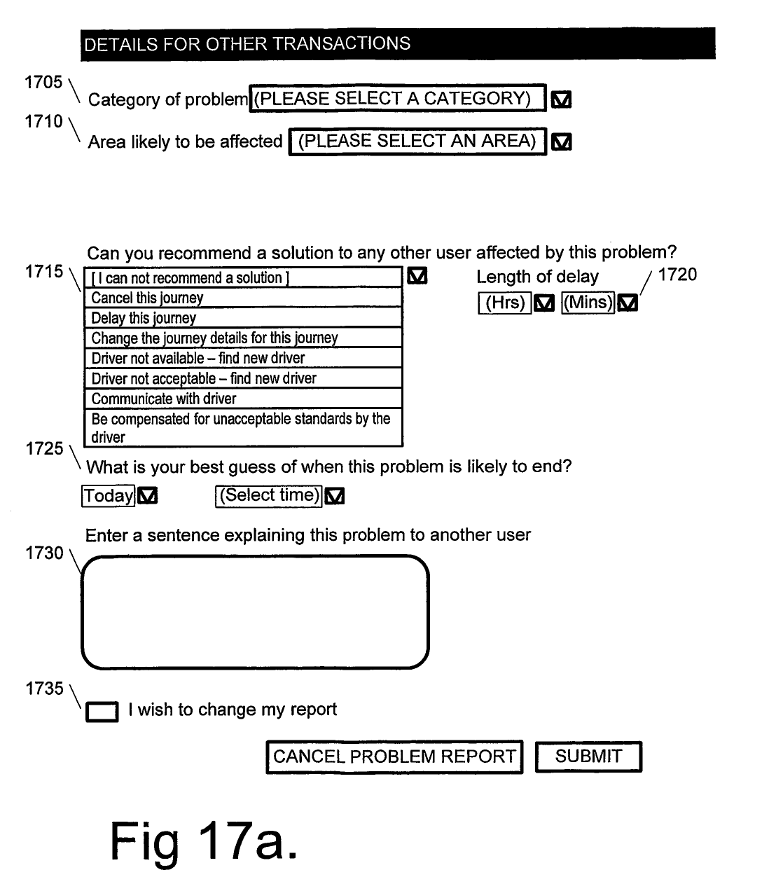

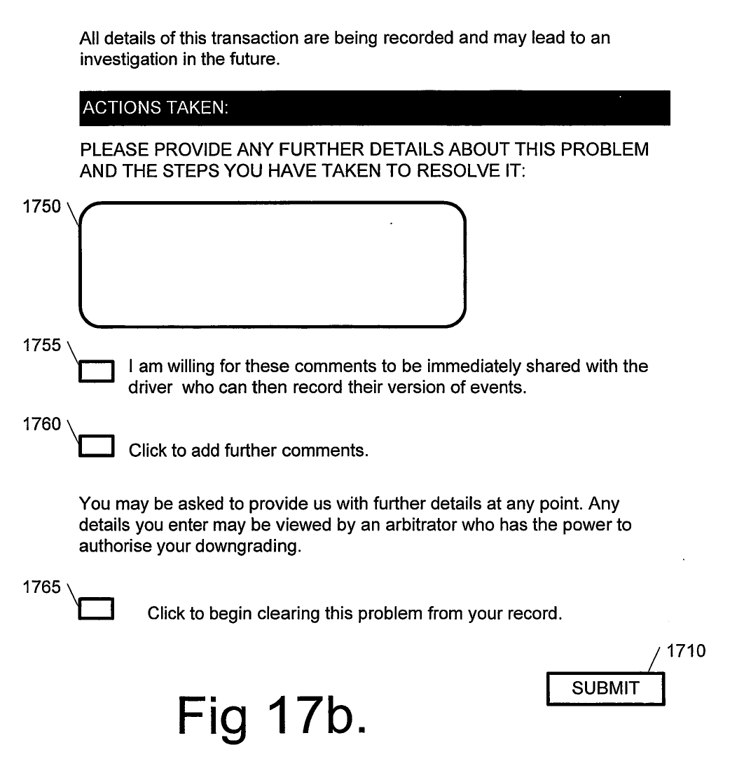

Step 1625 is triggered if the complainant has indicated that their problem may be part of a wider problem that could impact on other transactions. This they did by selecting a button 1525 in the screen illustrated in FIG. 15a. The button or buttons selected dictate the screens returned as will be shown in FIG. 17.

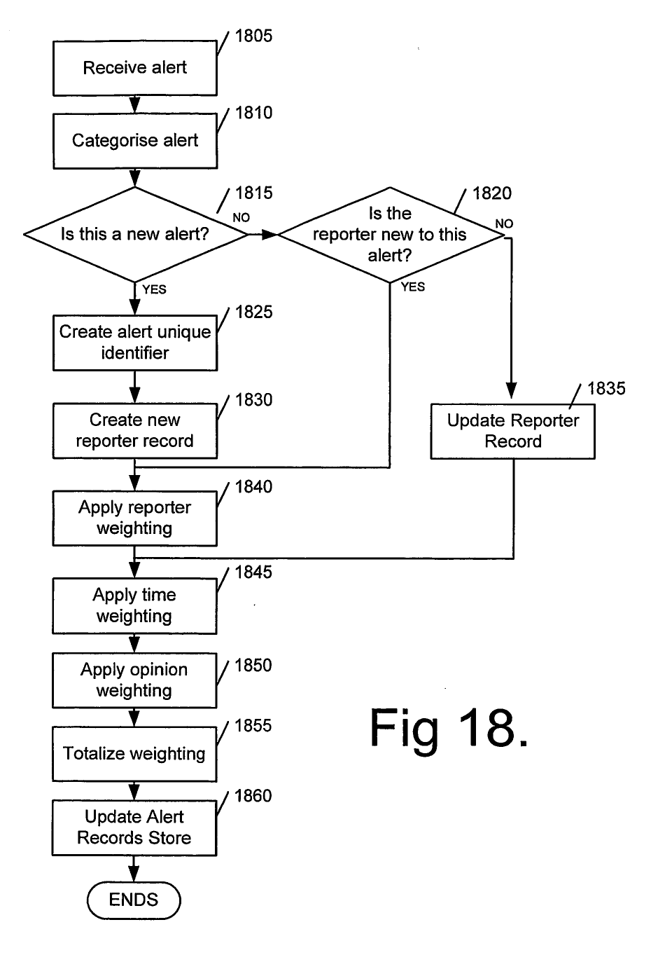

At step 1635 POP Screen Compilation Module 610 reads Transaction Database Extensions 665 to see if “not my fault” is being claimed. If so Dispute Resolution Screen 1 is generated as illustrated in FIG. 18a to be returned to the user. This allows them to clear the problem transaction record that is now stored on one transaction which contains their Unique Identifier code as stored in Seller Database 431 or buyer Database 432.

At step 1645 a screen containing the information so compiled is assembled. A “problem reported, click for details” flag appearing in column 1150 of the each recipient's version of the screen illustrated in FIG. 11. Clicking on the flag brings up the appropriate Dispute Resolution Screen I for that problem transaction as will be disclosed in this document. This allows either party to see details of a complaint including (a) when filed (b) by whom filed (c) resolution requested (d) actions claimed to have been taken to resolve the problem as input through the screen in FIG. 15b. If the complainant has selected button 1520 signifying they are willing to have all details passed to their counterparty in the transaction that user is also allowed access to any text entry input by the complainant in box 1585.

At step 1650 POP Screen Compilation Module 610 passes the completed screen through Market Specific Language Records 660 as described earlier in this document. The finished screen is sent to the user via Communications Processor 305 at step 1655.

Displaying POP (Point of Problem) Screen 3:

The process Just described produces POP Screen 3. This is illustrated in FIG. 17a. and FIG. 17b. It contains (a) a request for any further information about a problem that the user is signifying could impact on transactions other than his own this is illustrated in FIG. 17a (b) a box allowing the user to input any further immediate information about the failed transaction to be stored within Transaction Records Extensions 665. This is illustrated in FIG. 17b.

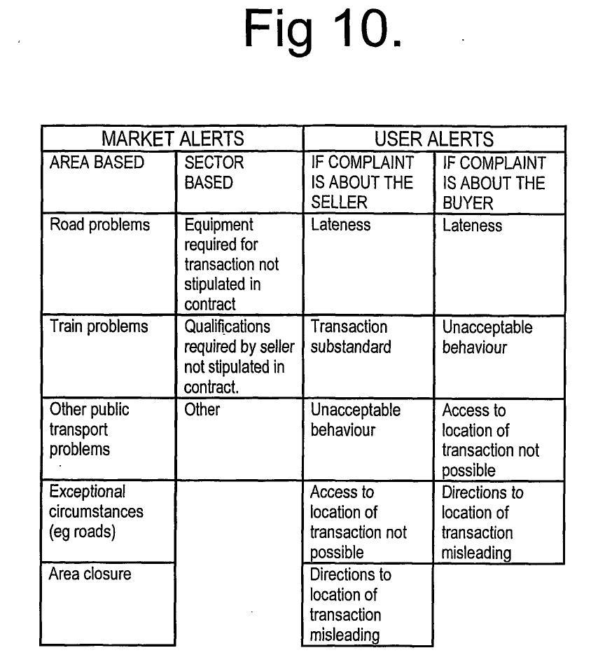

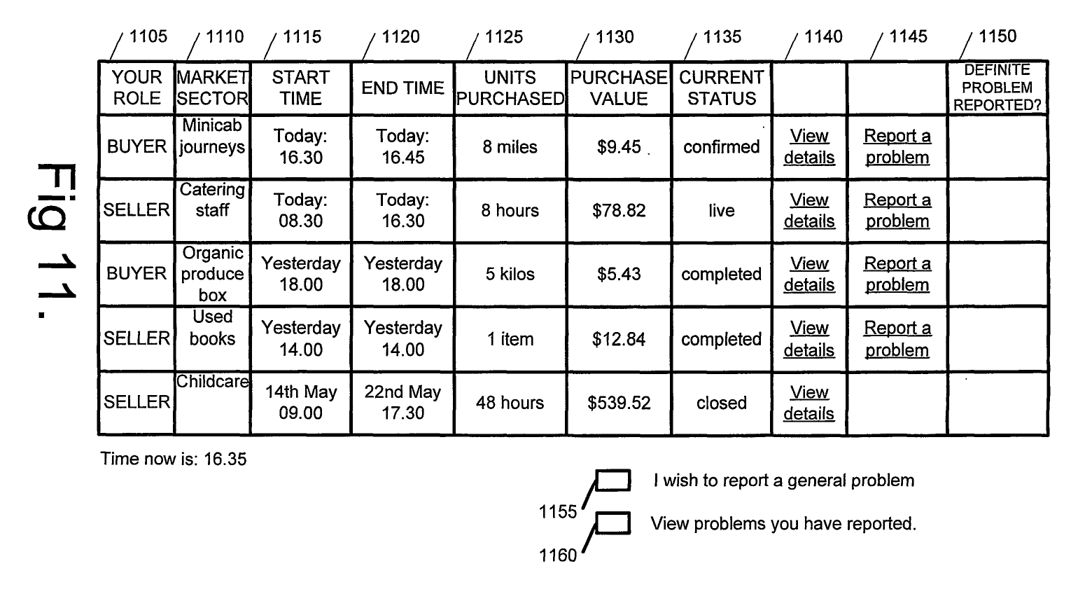

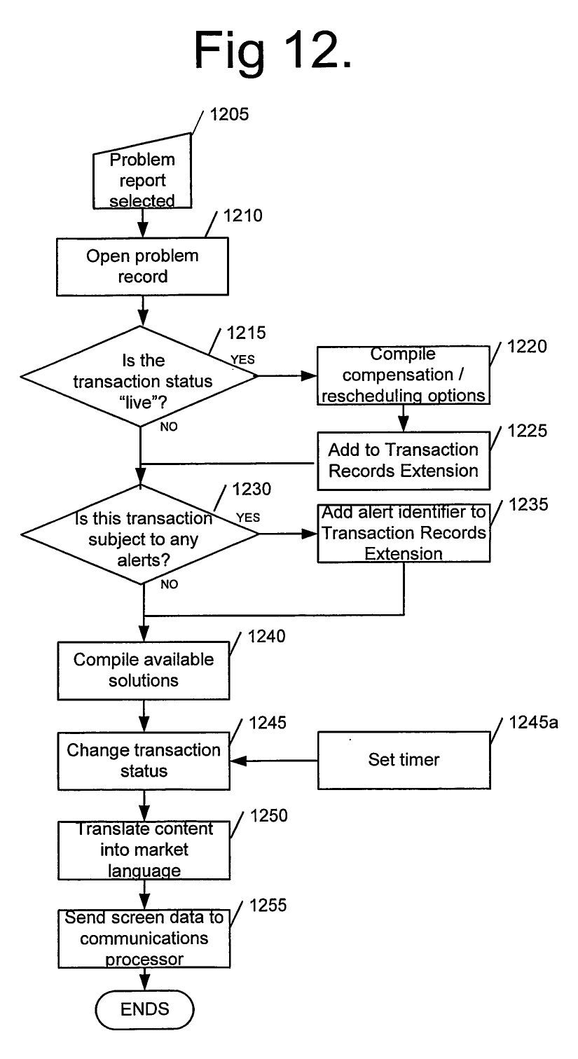

Turning to first to FIG. 17a. This is used to input further information about the wider problem of which the user asserts his particular problem forms part. Such inputs are used by Alert Management module 620 to compile alerts about known current problems. The user's definition of the type of problem has already been input in section 1545. At line 1705 he is asked to further categorize the problem. The options from which he may chose are shown illustratively in FIG. 10. In the present example the user has indicated that the problem is likely to affect others in the same geographic area. Thus it is a problem of type “area”, the user is therefore offered the categorizations in the column below. Categorizations for the other types of problem are shown in relevant columns. A grouped transaction for which a user is reporting a problem carries the categorizations for seller problem.

Additionally, in line 1710, the user is asked to input the geographical area that they believe will be affected. Such inputs might take the following forms (a) a reading from a GPS (Global Positioning System) module within the communications device used by the complainant (b) a list of place names in the country of operation with a database that converts them to map reference points (c) a list of postalcodes to be likewise converted to map references for distance calculation purposes (d) technology such as that offered at www.multimap.co.uk which allows a user to find their location on a map and then converts a selected location to a postalcode or map reference. Similarly, if they were reporting a Sector Based problem they would be offered a list of all market sectors as stored in Market Rules Database 434 and asked to select the ones they believed to be affected.

Selection box 1715 invites the user to recommend a solution. The options to be offered are dictated by the type of problem and are read from column 972 in the table illustrated in FIG. 9c. If the user selects “delay this transaction” line 1720 appears asking For a recommended time of delay based on the user's understanding of the problem. At line 1725 the user is asked for an estimate of when the problem will end based on the information they currently possess. The first selection offers “today” then the option to select any date up to, perhaps, 3 months in the future. The second box allows a time to be input based on selection from perhaps, 15 minute increments of a 24 hour clock. At 1730 the user is asked to put in a simple description of the problem that will make sense to another user. Button 1735 appears only after the first time a user has completed the screen shown in FIG. 17a.

Turning now to FIG. 17b. This section of the screen is added if a user is claiming a problem is not their fault.

Text box 1750 invites text entries about the problem that are then date/time stamped and stored within Transaction Records Extensions 665 and can be accessed by an arbitrator. Button 1755 allows a user to show they are willing to share such inputs with the other party which will be regarded favourably by an arbitrator. Button 1760 allows further text boxes to be entered and likewise time stamped and stored if new information emerges. Button 1765 allows the user to begin the Dispute Resolution Process, that will be described below, for this transaction. Submit button 1770 sends the completed page to POP Form Compilation module 610 which deposits the inputs in Transaction Records Extensions 665. This completes the process within POP Form Compilation module 610.

From this point on the user is able to access details of the problem by accessing the “problem reported” flag against that transaction in the screen represented in FIG. 11. Column 1150 flags any transaction which is registered as a problem transaction within Transaction Database Extensions 665. By clicking on the flag a user is able to view (a) the latest information on any relevant alerts that reached Code A, B, C or D during the period from beginning of booking to end of booking stored in Alert Records Store 670, the information being presented in a form illustrated generally in section 1330 of FIG. 13a. (b) any information input by the user about this transaction that is stored in Alert Records Store 670, this is output in the form of the screen illustrated in FIG. 17a. with the content frozen as of the last entry only button 1735 is interactive and this can be used to call up a blank version of the screen shown in FIG. 17a for a user who wishes to file a new report (c) any text input by their counterparty which the counterparty is willing to share at this stage (d) the screen illustrated in FIG. 17b.

In a further embodiment of the Point of Problem process a user can activate a problem report using a telephone. Thus, on ringing a central number For reporting problems with transactions and identifying themselves through (a) caller line identification or (b) inputting a code the user would be able to go through the following steps. (a) receive list of current transactions and select one by voice or key input, the default being “most recent” (b) select from a list solutions, the default being “seller unacceptable—select new seller” or “buyer not acceptable” if the seller is reporting a problem (c) select “my fault” or not my fault, the default being “not my fault” (d) receive automated referral to a replacement transaction or referral to a call center operator who provides details already loaded onto the screen in front of them using the inputs thus far. It will be appreciated this embodiment is particularly useful for very low value or phone based transactions such as a market for telephone directory services.

### Seller Reporting of Problems

It will be appreciated that in many of the exemplary markets listed there will be occasions when the seller in an already confirmed transaction becomes aware that he is not going to be able to complete said transaction as specified in the contract. Examples might include, without limitation, (a) a temporary worker en-route to an assignment whose car breaks down irreparably (b) the provider of industrial storage capacity whose premises are rendered insecure by a break in (c) the hirer of a commercial vehicle whose previous hirer has returned the vehicle in a non roadworthy condition. The prior art in online dispute resolution tends to deal with only transactions that have failed in the past there is little provision for transactions in which at least one party knows the transaction is going to fail at some point in the future. The present invention allows a seller to report a problem through the same processes as a buyer with possible rescheduling and dispute resolution initiated as already outlined.

The present invention provides for technology that allows reporting of a problem from the time a transaction is confirmed to the point at which it is due to start. As already outlined, in some circumstances Problem Server 500 may reschedule a transaction that is failing. This is likely to incur additional overheads which increase with proximity to the time the transaction is due to start, there therefore exists a need to strongly incentivize users to report a problem as soon as they become aware of it. In most market sectors it is more likely the seller will become aware of problems that prevent a transaction starting, not the buyer.

A seller is able to report a problem with a transaction once it is confirmed using column 1145 on the screen represented by FIG. 11. This initiates the Point of Problem process described above. The following applies only if the user reporting the problem selects “not my fault” at line 1365 within the screen represented by FIG. 13b.

In a further embodiment, of the present invention once a seller has completed the Point of Problem process for a transaction that has not reached its start time or is within, for example, 4 hours after its start time, a number of Problem Notification Points are awarded by POP Form Compilation Module 610 and stored within an additional column in Buyer/Seller Database Extensions 650. The number of points awarded is based on the time of reporting relative to the start time of the transaction as stored in Transaction Database 433. Setting of numbers of points is achieved through Service Provider Terminal 308, an exemplary table of points is shown below with each reported transaction allocated to the appropriate row furthest down the table:

| Time relative to | | |
|---|---|---|
| assignment start | | No. of Problem |
| that problem is | | Notification Points |
| reported | | awarded |
| >24 | hours before | 0 |
| <24 | hours before | 10 |
| <16 | hrs before | 20 |
| <8 | hrs before | 30 |
| <4 | hrs before | 50 |
| <2 | hrs before | 60 |
| <1 | hr before | 70 |
| <30 | mins before | 80 |
| <15 | mins before | 90 |
| | within start time | 100 |
| <15 | mins after | 110 |
| <30 | mins after | 120 |
| <45 | mins after | 130 |
| <60 | mins after | 140 |
| <1 | hr 15 after | 150 |
| <1 | hr 30 mins after | 160 |
| <1 | hr 45 mins after | 170 |
| <2 | hours after | 180 |
| >2 | hrs after | 200 |

Thus, for each transaction that a seller reports a problem at, or around, the start time there is a number of points added to their personal record. Said record can then limit the user's ascension through grades in the market through a formula that limits the maximum number of Problem Notification Points allowable in any given grade. However, such points need to be progressively wiped off a user's record relative to their number of successfully completed transactions or heavy users who have occasionally been unreliable will be penalised. There is therefore a table within Grading Tolerances 655 that controls (a) the maximum number of points allowable in any grade (b) the rate at which they are expunged from a user's record as other transactions are completed successfully. A sample table is shown below:

| | Maximum number | One completed |
|---|---|---|
| | of PNP's allowed | unit of sale |
| Seller | for sellers in that | expunges this no. |
| Grade | grade | of PNPs |
| 6 | 100 | 1 |
| 5 | 125 | 1.5 |
| 4 | 150 | 2 |
| 3 | 250 | 4 |
| 2 | 300 | 6 |
| 1 | 400 | 10 |
| Entry | No limit | |
| level | | |

A user who exceeds her maximum number of Problem Notification Points is automatically downgraded by User Maintenance module 428 to the highest grade permissible for the number of points outstanding. As sellers rise through the grades they are increasingly incentivized to report problems with transactions at the earliest opportunity because the system tolerates less points and they take longer to remove from the record. This limits overheads for the system while making rescheduling of failed transactions, so buyers are not let down, more likely.

### Storing Alerts

The present invention encourages complainants to input details of any problem that is likely to impact on other transactions apart from their own. By doing so they are able to have their claims verified independently by other users who were also affected. Examples of problems likely to have a wider impact might include (a) traffic congestion delaying journeys on which transactions depend (b) exceptional weather conditions making an area inaccessible or a planned activity impossible (c) a seller who starts to repeatedly mislead buyers (d) a buyer who is repeatedly breaking the contractual requirements of his purchases for example by abusive behaviour that appears to not be an isolated incident.

Alert Management Module 620 categorises and groups such reports of problems, weights the reports according to the known reliability of the person reporting and the elapsed time since the problem was first reported. It is therefore able to maintain a datastore of categorized problems with their geographic or market sector(s) identified and with weighted estimates of when the problem is likely to end. Each new report adds to the system's knowledge of a problem and its likely duration. Alert Management Module 620 is able to further refine the data about a particular problem by asking users likely to know about a problem but who have not reported it to provide data, possibly with financial inducement to do so. Acting on this knowledge the system can carry out functions which benefit the market as a whole including (a) warning users already committed to transactions likely to be impacted by a problem (b) warning users seeking to book a transaction in the future that is likely to be impacted by a problem (c) beginning to reschedule transactions that will be affected even before the buyer or seller have reported a problem. (d) identifying problems, such as a regulatory matters, that require official attention or attention by the system operator. It will be appreciated that the processes described could happen extremely quickly, within minutes, for example in response to a major incident which threatened a large number of transactions.

The user reporting a problem is termed the “reporter”. A problem which is likely to impact on other transactions generates an “alert” that is filed in Alert Records Store 670. The process by which an alert might be filed is shown in FIG. 18. and will now be described in detail. Data relating to alerts is stored in Alert Records Store 670 which has a field for each alert for which an exemplary illustration is provided in FIG. 8b. and a further field for each reporter who has reported a particular problem. This field is illustrated by way of example in FIG. 8c.

### Recording Information About a Possible Alert

When a user reporting a problem through the POP (Point of Problem) screens clicks to signify that his is a problem likely to impact on other users all details are stored by POP Screen Compilation Module 610 which then sends the alert data to Alert Records Store 670 at step 1805. At step 1810 the alert is categorised in terms of on whom the complainant believes it will impact. This information, input through screen section 1545 in FIG. 15a., translates into a record in section 804. The live types of alert are shown in the appropriate column of FIG. 10. The alert information is then further categorised in terms of the grounds for complaint offered in the appropriate column of FIG. 10. and selected by the reporter in selection box 1705 within the screen represented by FIG. 17a. This is stored in column 806 Thus an alert might be of the type “area problem” categorized as “train problems”. The scope of the problem reported is then filed in column 816. For a geographic problem this is recorded as a set of map references or postalcodes around the area identified by the complainant and extending in a radius of a figure decided by system operators and input through Service Provider Terminal 308 such figure might be one mile.

At step 1815 the system is able to see if this is a new alert. It does this by checking all alerts listing their status as “current” in column 824. If the newly received alert matches the type, categorization and at least part of the scope of an existing alert it is deemed not new. In that case the process moves on to step 1820 which checks if the complainant already has already filed one or more alerts about this problem. This is done by seeking to match the reporter's Unique Identifier stored on Buyer Database 432 or Seller Database 431 with a reporter ID in column 830 of the table represented in FIG. 8c. If there is a previous alert filed by this user all previous alerts filed by that individual have their status changed to “inactive” and a new record is created as described below with status “active” at step 1835. If this is the first time the reporter has reported on this alert the process moves to step 1845.

Assuming the alert is a new one a unique record within Alert Records Store 670 is opened as represented in FIG. 8b. with a unique identifying code created for column 802. Columns 804, 806 and 816 are then populated. A record for this first reporter is then created, said record being illustrated in FIG. 8c, at step 1830. This record includes, in column 840, the time when this reporter believes the problem will end. If no time is given there may be a table of default entries for such problems input through Service Provider Terminal 308, such table designed to create a framework within which a problem might reasonably be expected to conclusively intensify or diminish. An example of that table might be:

| | | | | | |
|---|---|---|---|---|---|
| TYPE OF | Area | Sector | Buyer | Seller | Group |
| PROBLEM | | | | | |
| DEFAULT | 90 minutes | 8 hours | 4 hours | 4 hours | Time the |
| ESTIMATED | | | | | problem |
| DURATION | | | | | transaction is |
| OF ALERT | | | | | due to end |

At step 1840 the reporter weighting is added to column 832. In a simple embodiment such %weighting could be a factor of the user's grade on the system, for example the grade would translate into a weighting factor thus:

| | | | | | | | |
|---|---|---|---|---|---|---|---|
| GRADE OF REPORTER | Entry level | 1 | 2 | 3 | 4 | 5 | 6 |
| WEIGHTING FACTOR | 1 | 2 | 3 | 4 | 6 | 8 | 10 |

The purpose of this weighting is to ensure Alert Management Module 620 takes reports from users known to be reliable, and with valuable grading to lose if they file careless reports, more seriously. It will be appreciated that the weighting factor could be varied to accentuate or diminish the difference between users who have attained high grade status and those that have not.

It is also important that reports be time weighted so that a report that may be out of date by hours or days is valued less highly than one that is only minutes old. This could be achieved in numerous ways. In a preferred embodiment time weighting is based on segments of time since the first report generating this alert. As each new division of time is entered the weighting accorded to reports received within that division are weighted higher than those received in previous segments. The following table serves as an example with each report allocated to the furthest left column possible.

| | | | | | | | | | | | | |
|---|---|---|---|---|---|---|---|---|---|---|---|---|
| Time | <02 | <05 | <10 | <20 | <35 | <55 | <80 | <120 | <240 | <1440 | <10080 | >10080 |
| elapsed | | | | | | | | | | | | |
| since first | | | | | | | | | | | | |
| report (in | | | | | | | | | | | | |
| minutes) | | | | | | | | | | | | |
| Time | 1.2 | 1.4 | 1.6 | 1.8 | 2.0 | 2.2 | 2.4 | 2.6 | 2.8 | 3.5 | 4.0 | 6.0 |
| weighting | | | | | | | | | | | | |
| applied to | | | | | | | | | | | | |
| report filed | | | | | | | | | | | | |
| in this time | | | | | | | | | | | | |
| segment | | | | | | | | | | | | |

It will be apparent that alerts notified in the early minutes of a problem will be devalued by reports that come in later as the situation should be more clear to the reporters. Beyond 1440 minutes (24 hours) it is likely that a problem is becoming particularly entrenched and the latest information, which includes estimated end of problem time, needs to be weighted to reflect its more long term outlook. Similarly a problem that lasts beyond 10,080 minutes (7 days) needs inputs after that point to be weighted particularly heavily because the early information is likely to be increasingly irrelevant.

Alternative ways of weighting a report relevant to time might include (a) calculating proximity to an estimated problem end time as input by a plurality of users (b) increasing the weighting with each new report filed pertaining to a particular alert (c) using a percentage increase in time from first filing so that, for example. a report at the time it is filed is weighted at 100% (10% being the time the first report was riled) but that percentage declines as the time since first report increases. This last solution is more precise than the time segments illustrated above, but requires more processing power as all time weightings need to be constantly recalculated. However, it will be obvious to those skilled in the art that the table above could be increased in length to offer many hundreds of increments making the weighting more precise.

Any report, other than the first to create an alert, can be accompanied by the user's opinion of this problem. This factor is important because it allows a reputable user to quickly downgrade the weighting of an alert. Any user offered a page notifying them of an existing alert such as that shown in section 1330 of FIG. 13a is asked to give their opinion of the alert with selections that are then weighted by the system possibly including:

| | OPINIONS OFFERED | WEIGHTING |
|---|---|---|
| 1 | I am not in a position to comment on this problem | 1 |
| 2 | This is an unusually serious problem | 4 |
| 3 | This is a serious problem | 2 |
| 4 | This is some evidence of the problem but I do not | −0.5 |
| | consider it serious | |
| 5 | There is a problem but it is not the one reported | −1 |
| 6 | I can see no evidence of this problem | −1 |
| 7 | It is unlikely this problem exists | −2 |
| 8 | This is clearly a facetious alert | −5 |

A user selecting option 5 is then given a screen that creates a new alert as illustrated in section 1545 of FIG. 15a followed by the appropriate screen for the type of problem being reported as shown in exemplary form in FIG. 17a. The opinion weighting input through the table above is stored in column 837, by default the entry in that column is 1. Users receiving the table above are reminded that other users are also likely to be giving their view of the problem. Thus, if a user is not impacted by a problem but claim they are as a means of escaping a contractual obligation, it can be shown that an arbitrator will be able to view the responses of other users who might have indicated the problem was not serious. A user who seeks to utilize an alert as an excuse for non-performance will therefore be exposed and is likely to be downgraded.

Thus, each report has a report weighting, time weighting and opinion weighting. The two are totalised at step 1855 as in this example with the final calculation recorded in column 838 in FIG. 9a.:

| Reporter | | Time | | Opinion | | Total weighting |
|---|---|---|---|---|---|---|
| weighting | | weighting | | weighting | | for this report |
| 4 | X | 1.8 | X | 2 | = | 14.4 |

It will be clear that the relationship between the three rates of weighting need to be selected to find the optimum balance between new reports and reports from users known to be reliable. The rates can be changed by inputs from Service Provider Terminal 308.

At step 1860 the new report is factored into the weighted total score of this alert as represented in the fields within Alert Records Store 670 as represented in FIG. 8b. This comprises (a) updating the total weighting of all reports pertaining to a particular alert as stored in column 808, this is the sum of all figures stored in column 838 for reports with status set at “active” (b) weighted assessments of the likely end of the problem, its solution and any likely delay transactions input by users are stored. This requires the updating of columns 810, 812 and 814. (c) updating of Alert Total Liability in column 828, this is the total amount by which the transactions that have failed with the failure attributed to the present alert are underwritten by the system's underwriting fund as disclosed in PCT/IB02/01475 described earlier (d) the alert's volatility rating as held in column 829. This counts the number of times a report with a positive weighting is followed by a report with negative weighting, or vice versa. Thus this column reflects the degree of confusion among users reporting this alert: a low number suggests unanimity, a high number shows changing opinions as reports come in.

The process of updating will now be described. Column 810 stores an estimated end time for the problem to which this alert pertains. It is calculated by (a) multiplying the report weightings of all active reports with an end time offered in column 840 (b) converting each estimated time from hours/minutes to hours and percentages of an hour—any estimated times of more than a day away have 24 hours added to the hour figure at this point (c) totalling the weightings (d) totalling the hours and percentages of hours (e) dividing the totalled hours by totalled weightings (f) converting the resulting hours/percentage of hours figure back into hours/minutes. This process is repeated every time a new report is received and is demonstrated in the following table.

| | REPORT 1 | REPORT 2 | REPORT 3 | REPORT 4 | REPORT 5 | REPORTS 6 | TOTALS |
|---|---|---|---|---|---|---|---|
| Report | 5.2 | 3.1 | 4.1 | 7.1 | 8.1 | 2.1 | 29.7 |
| weighting | | | | | | | |
| Est. time | 18.20 | 19.35 | 18.35 | 18.05 | 17.75 | 18.00 | |
| of end | | | | | | | |
| Est. time | 18.33 | 19.58 | 18.58 | 18.08 | 17.75 | 18 | |
| as hours/% | | | | | | | |
| Weighting × hours/% | 95.316 | 60.698 | 76.178 | 128.368 | 143.775 | 37.8 | 542.135 |

| | |
|---|---|
| WEIGHTED EST. TIME AS HRS/% | 18.2537 |
| WEIGHTED EST. TIME AS HRS/MINS | 18.15 |

Moving to column 812 this is populated by comparing the total report weightings of reports advocating a particular solution a selected by users from a list such as that illustrated at selection box 1715 within FIG. 17a. The solution with the highest ranking is entered into column 812. If two or more solutions have equal weightings that which appears highest in the list is recorded. If the preferred solution is “delay transaction” column 814 is compiled from weighted recommendations of delay times as explained for compiling a weighted figure for column 810. Finally, column 824 “current alert code” is updated and column 827 changed if the new report supplants an existing report as the highest weighted. Alert code is related to total report weighting and is explained in the next section. The process of storing information relating to an alert is then complete. Further columns illustrated in FIG. 8b and 9a relate to actions carried out by Alert Management Module 620 in response to an alert and are explained in the next section.

It will be clear that some alerts will overlap on each other. For example it may be that traffic hold ups are reported in one part of a city and an alert is established after the first report is received. The scope of this alert is deemed to be a cluster of map references within, perhaps, a mile radius of the location identified in that initial report. Any reports about traffic problems based on a map reference within that cluster are therefore deemed as relating to that original alert. It may then be that further hold ups are reported at 1.5 miles from the area originally identified. As they are likely to impact on the same transactions and are possibly part of the same problem on the roads two or more adjoining alerts within a limit defined through Service Provider Terminal 308 may be merged to become one alert with combined weighting.

### Actions Initiated by Alert Management Module 620

The online markets for which the present invention is designed may be characterised by (a) users who are ranked by reliability (b) system knowledge of when a user has committed to being contactable by the system (c) records of all transactions completed by a user as buyer or seller (d) knowledge of the whereabouts of users who have committed to a transaction at a particular location through the system. It is therefore possible to establish a list of users who have most need to know about a particular alert and can most usefully be asked for further information about an alert. This is the core of the “research” function within Alert Management Module 620.

Such research helps to build a more accurate picture of the problem behind an alert on which the action can be taken. Such action may include (a) warning users in appropriate current transactions (b) inserting a warning into the booking of future transactions likely to be impacted by the problem (c) withdrawing the system's underwriting of failed transactions. Balanced against the need to draw on the widest pool of reporters however; the response to each alert needs to be proportionate to its weighting. Users do not want to receive communications about problems that are indiscriminate. Therefore the number of users to be queried about a particular problem rises with its weighting.

Thus Alert Management Module 620 requires protocols for increasing intervention in a problem as the weighting of the alert increases. Users who are most relevant to an alert are identified and questioned. They are able to (a) enter “negative” reports which decrease the weighting (b) enter “positive” reports which increase the weighting possibly triggering a next level of action (c) not respond which leaves the weighting unchanged. The level of action is dictated by the current code of alert which is determined by the current total weighting of an alert.

The table dictating such patterns of action is stored in Alert Management Module 620 with data input from Service Provider Terminal 308. An illustrative example of the table is shown below:

| | | | INITIATE |
|---|---|---|---|
| | TOTAL WEIGHTING | | QUESTIONING ON |
| | REQUIRED FOR THIS | | MAX. NUMBER OF |
| ALERT CODE | CODE | ACTIONS | USERS: |
| 0 | <12 | None | 0 |
| A | 12 | Warnings on present | 5 |
| | | transactions | |
| B | 24 | Warnings on Future | 10 |
| | | transactions | |
| C | 48 | Send to super-user for | 20 |
| | | assessment. | |
| D | >96 | Withdraw underwriting | 50 |

| | |
|---|---|
| DORMANT | The problem to which the alert pertains is deemed to be over but the alert can |
| | be revived to a previous alert status if appropriate additional reports are |
| | received. |
| CLOSED | The alert is deemed to be over but the reporters may still be held to account |
| | for their reports. |
| ARCHIVED | The problem to which the alert pertains is deemed to be completely over. |

In this embodiment the weighting required to trigger Alert status A is 12, the weighting that would immediately be allocated to a report from a top graded user. Thus a report of problems from a user with impeccable reliability and much to lose from misuse of the system prompts Alert Management Module 620 to seek out further details which may increase the weighting very quickly. One further report from such a user will then escalate the alert code further. Once an alert reaches a new code level two processes are triggered (a) warnings to those engaged in transactions likely to be affected by the problem (b) research among qualified users to seek a more refined weighting. Both processes escalate with the alert code. The warning process will be described first and is outlined

The warning process will be outlined first. This is in two parts (a) identifying users likely to be affected by the problem to which the present alert pertains (b) sending out warnings which also request further information.

Users likely to be affected are defined by the type of problem as defined in column 804 of Alert Records Store 670 as represented in FIG. 8b. For example if it is an area based problem the system searches for users who are about to begin a transaction or end a transaction in that location. The search for users likely to be affected, all based on data stored in Transaction Database 433 is illustrated in the following table:

| TYPE OF | | | | |
|---|---|---|---|---|
| PROBLEM | DEFINITION OF APPROPRIATE RECIPIENTS | | | |
| Area | 1. Users at beginning of a transaction in defined area | | | |
| | 2. Users at end of a transaction in defined area | | | |
| | within a percentage of the current estimated duration of | | | |
| | the problem, such time input through Service Provider | | | |
| | Terminal 308. For example: | | | |
| | CODE A | CODE B | CODE C | CODE D |
| | 20% | 40% | 60% | 100% |
| Sector | Users with transactions pending in this sector that start | | | |
| | within percentage of alert estimated duration input through | | | |
| | Service Provider Terminal 308 and related to the code of | | | |
| | alert. For example: | | | |
| | CODE A | CODE B | CODE C | CODE D |
| | 20% | 40% | 60% | 100% |
| Buyer | Sellers with a purchase scheduled from this buyer within | | | |
| | percentage of alert estimated duration input through Service | | | |
| | Provider Terminal 308 and related to the code of alert. For | | | |
| | example: | | | |
| | CODE A | CODE B | CODE C | CODE D |
| | 20% | 40% | 60% | 100% |
| Seller | Buyers with a purchase scheduled from this seller within | | | |
| | percentage of alert estimated duration input through Service | | | |
| | Provider Terminal 308 and related to the code of alert. For | | | |
| | example: | | | |
| | CODE A | CODE B | CODE C | CODE D |
| | 20% | 40% | 60% | 100% |

| | |
|---|---|
| Group | All other individuals sellers/buyers who are part of this |
| | group transaction. |

The list once assembled is cleaned of any user who has already been warned of this alert as stored in column 822 of Alert Records Store 670. Those users now need to be warned of a problem pertaining to the transaction which they have booked. This warning takes the form of a screen headed “we are receiving reports of a problem that might impact on one of your future transactions”. It then lists the transaction details as exemplified by an individual row of the table shown in FIG. 11. A screen as represented in section 1330 of FIG. 13a is assembled followed by a selection of “your opinion of this alert” as illustrated above plus a screen inviting inputs about the likely solution as illustrated in FIG. 17a. This screen is sent to each user to be warned with the list of recipients stored in Alert Records Store 670.

It will be appreciated that, in the case of problems relating to a buyer or a seller, there is a danger of individual users being labelled by unjustified reports that they were letting their counterparties down in transactions. In a preferred embodiment of the system a user alert, that is an alert about repeated problems with an individual buyer or seller is first sent to the user concerned. Proof of sending is recorded in a way familiar to those in the art and the matter is treated initially as part of the dispute resolution process offered by Dispute Resolution Module 625. Only if the user declines to react to that message within a stipulated timeframe is the alert code changed from 0 to that dictated by its combined weighting. In an alternative embodiment a neutral authority such as an arbitrator might be notified of an alert code rising against an individual user and be empowered to contact the user directly then, if not satisfied, downgrade them on the system with their transactions rescheduled by POP Screen Compilation Module 610.

Thus, the process above contacts users likely to be impacted by a wide scale problem and invites them to feed response into the system. All responses will be filed and weighted according to the process outlined in FIG. 18 thereby honing the system's knowledge about a particular problem.

It may be that there is not the transactions currently in hand that will produce users likely to be informed about the problem to which an alert relates. It may be for instance that there are no individuals currently engaged in a transaction which would allow them to provide information about a traffic incident. However, there may be users who are contactable, but not engaged in a transaction immediately threatened by the problem, who can provide further information. They will not necessarily have the incentive to report a problem accurately because it will not impact on a problem transaction in which they are involved so financial inducement may be offered to encourage them to report. For this reason the process to now be described is secondary to communication with those likely to be directly impacted by a problem. Any reporter might be informed that any information reported to be spurious could lead to a dispute with possible arbitration which can lead to downgrading on the system.

### Targeting Users Not Impacted by a Problem for Research Into an Alert

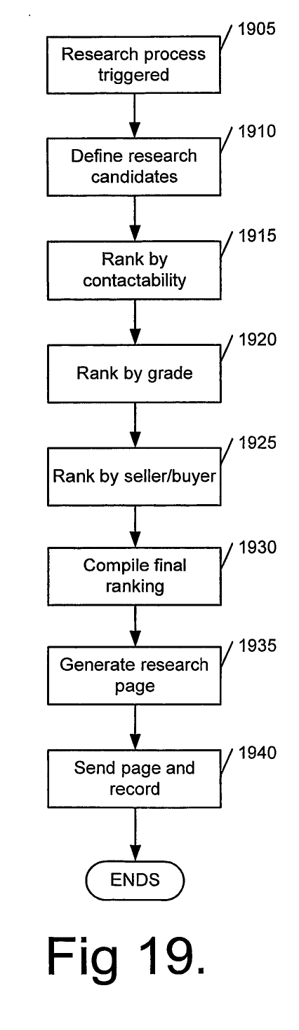

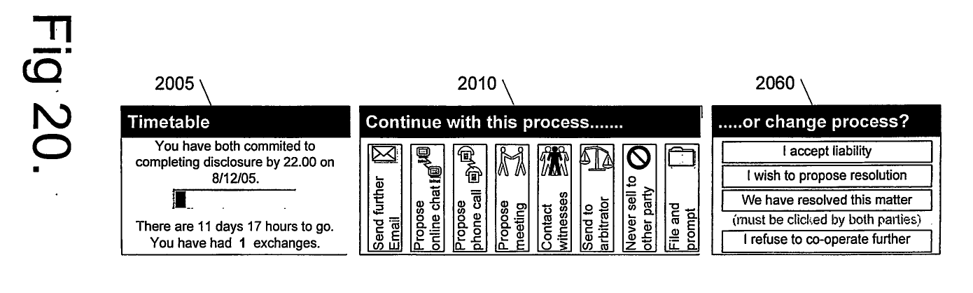

Turning now to the secondary process by which Alert Management Module 620 generates further information about an alert if it is not able to immediately locate users engaged in transactions who will probably be affected. FIG. 19. represents one embodiment of the process. The process is triggered at step 1905 when an alert code moves upwards and less than the required messages have already been generated and sent.

At step 1910 a list of appropriate users most likely to be able to provide information is complied. This list depends on the type of problem as defined in column 804 for this alert. The appropriate users and where data identifying them is stored is shown in exemplary form in the table below.

| TYPE OF | | DATA TO BE |
|---|---|---|
| PROBLEM | RESEARCH CANDIDATES TO BE SEARCHED | SEARCHED |
| Area | Users at beginning of a transaction in defined area | Transaction Database |
| | Users at end of a transaction in defined area | 433 |
| | Users based at postalcode in the transaction area not | Seller Database 431 |
| | on a transaction | |
| | Users in mid transaction at a postalcode in the | |
| | defined area | |
| | Mobile sellers (taxi drivers for instance) who are | |
| | known to be for hire within the area and might be | |
| | paid to look at the alleged problem and report | |
| | (Then rank for proximity) | |
| Sector | Users with largest number of sales or purchases in that sector | Transaction Database |
| | in defined period | 433 |
| Buyer | Most recent sellers to that buyer in the sector to which the | Buyer Database 432 |
| | complainant and the buyer were transacting | |
| Seller | Most recent buyers from that seller in the sector to which the | Seller Database 431 |
| | complainant and the seller were transacting | |
| Group | All other individuals sellers/buyers who are part of the group | Transaction Database |
| | | 433 |

If this process generates no returns the process is terminated with details recorded in columns 818, 820 and 822. Assuming one or more returns, the resulting list is first cleaned of any user already contacted about this problem as listed in column 822 and the list of appropriate users' Unique Identifier codes is stored temporarily. Users on that list who are contactable most quickly are the most useful so, at step 1915, Seller Contactability Record 431c for each user is searched with the list then ranked. Those who are currently contactable are ranked 0, those who will be contactable within half an hour at 0.5, those within an hour at 1 and so on.

The list now needs to be sorted by grade of user so that the most reliable come to the top. This might be achieved at step 1920 by scoring user grades as follows:

| | | | | | | | |
|---|---|---|---|---|---|---|---|
| USER GRADE | 6 | 5 | 4 | 3 | 2 | 1 | Entry level |
| SCORE | 1 | 2 | 3 | 5 | 8 | 12 | 20 |

Additionally, it is preferable to question sellers, who have a more demanding relationship with the system, than buyers. Therefore at step 1925 each seller on the list is scored at 0 and each buyer at 3. Scores for each user on the list are then totalled and the list ranked by those scores, with the lowest scores at the top, at step 1930. Assuming said list is longer than the maximum number of recipients required, the required number of users to question for the appropriate alert code is then selected from the top of the list.

A screen about the alert with request for information, to be received by web browser, mobile phone screen or other communications device as dictated by the user's Seller Contactability Record 431c is compiled at step 1935. Its component parts are (a) section 1330 of the screen shown in FIG. 13a which outlines the problem and offers text entry from the highest weighted report currently stored plus outputs from columns 810 812 and 814 (if a delay is currently the preferred solution) (b) a selection box of options relating to “your assessment of the problem”, as illustrated above (c) a screen as illustrated at FIG. 17a. which seeks the user's input into recommended solutions.

At step 1940 the page is sent to Communications Processor 305 and the code alert on which it was based recorded in column 818 in Alert Records Store 670 as represented in FIG. 8b. The time of action is recorded in column 820 and Unique identifier codes for the recipients are stored in column 822. Any replies received are filed according to the process already demonstrated in FIG. 18.

Participants in the process just described may be rewarded with a small payment from the system operator's account within the system through Payment Transfer Module 427 to the user's account on completion of a report. Such financial inducement could be merited for the operator because of the savings on costs associated with the underwriting of failed transactions.

In a preferred embodiment, potential buyers inputting details in the requirements screen as illustrated in FIG. 1 whose requirements indicate that a resulting transaction is likely to be impacted by a problem pertaining to a current alert are warned before booking. As part of the search for sellers process Transaction Management Module 423 would ensure Alert Records Store 670 is searched to see if details on a buyer input screen as shown in FIG. 1 come within any alerts of code B or above but not dormant, closed or archived. If they do, the buyer is offered the appropriate warning screen of the type illustrated in section 1330 of FIG. 13a before progressing to the output screen illustrated in FIG. 2. In a further preferred embodiment the system might withdraw underwriting of all future transactions that fall within the geographic, sector or entity definitions of any alert above a certain code. This ensures the system's underwriting costs are curtailed while a large scale problem lasts.

In another preferred embodiment Alert Management Module 620 is able to instantly call on “super-users” working from any location. These are individuals who sell their services to the system through a specialised market sector. They undertake to research a problem and quickly input an authoritative overview. In this embodiment, such users might be presented with the contents of all report screens and asked to prepare an overview. They might telephone local police authorities, consult news outlets or investigate sector problems with an appropriate trade body. Within a given time frame, they then input a version of the screen shown in FIG. 17a. and are accorded a user weighting of perhaps 25. This ensures their input becomes the definitive record until a number of reliable reporters challenge it later.

It will be appreciated that any user should be able to report a problem to the system even if they are not involved in a transaction to which it relates. They do this with button 1155 on the screen represented by FIG. 11. Said button produces a screen which asks if this is a problem defined by area, sector, buyer or seller, this is followed by the appropriate version of the screen shown by FIG. 17a but includes the option of entering a start time for the problem. This might be used for example by someone reporting a forthcoming road closure. Additionally, any user who has contributed information about a problem that they now realise was wrong can change that information by selecting button 1160 on the screen represented by FIG. 11. This button produces a list of alert headings in which that user is listed as a reporter the alert heading comprises (a) type of problem from column 804 in Alert Records Store 670 as shown in FIG. 8b (b) problem category from column 806 (c) the time at which the individual's last report was filed taken from column 834 in FIG. 8c. Because each new report from an individual turns their previous reports to “inactive” status as stored in column 848 they are able to add their full weighting to changed information. This is in the user's interests if their reports are read by an arbitrator because they can show that they acted promptly to inform the system of a changed situation.

It will be clear that Alert Management Module 620 needs a way of deeming an alert no longer in force so its status can be downgraded. The circumstances in which this can happen are (a) the alert weighting in column 808 becomes a negative figure because of credible user reports that there is no longer a problem (b) the current weighted end of problem time in column 810 has been passed.

There will be circumstances in which information about a problem relating to an alert is confused and users could be inputting contradictory information. Similarly there can be problems which remain in force but are not encountered by users for some period of time because no relevant transactions occur. It is undesirable that alerts are closed and the same problem then reported as a new alert which may initiate warnings and requests for information to users who have already received messages about the previous alert which pertains to the same problem. There therefore exists a need for a period in which the problem relating to an alert is believed to be over and there is no proactive messaging about the alert by Alert Management Module 620 but the alert can be resuscitated if new reports are received. An alert about a problem now deemed to be over is therefore designated dormant for a percentage of its overall duration time, that is its time from first report received to either of the two conditions for it being deemed no longer in force above being met. Said percentage being input by Service Provider Terminal 308. For exemplary purposes, such figure may be 80%. The alert would then be considered Closed for perhaps 4 weeks before being archived.

In a further embodiment of the reporting system described the system may count failure to report by a user who would be likely to do so if impacted as evidence for downgrading an alert's weighting. Thus, if users identified in a transaction and sent warnings do not respond that user may be deemed to have reported “I can see no evidence of this problem” as shown in the table of opinions of an alert. The justification for this is that (a) users do not necessarily have time to complete a form where they can see no problem (b) there is a clear incentive for the user to report a problem if they are impacted (c) if transactions are continuing unaffected by the problem it is clearly unimportant.

In an additional embodiment a high volatility rating, relative to number of reports received, pertaining to one alert could trigger the sending of all details to a super-user for clarification of the confusion. An example threshold might be if the volatility rating exceeded 30%.

In a further embodiment, the alert process may be used to trigger alerts to relevant sellers who may wish to enter the market, or change their pricing, in response to an alert. For example Alert Management Module 620 may be programmed to warn minicab drivers using the system within a given radius of an alert about rail problems, Drivers may chose to be available for journeys in that vicinity while the alert lasts.

### Resolving Problem Transactions

It will now be clear that (a) certain transactions on Transaction Database 433 will be flagged as having failed with neither buyer or seller accepting responsibility (b) through its underwriting of failed transactions the system itself may have carried the financial cost of replacing a railed seller or unacceptable buyer in those transactions (c) users are motivated to resolve such Problem Transactions because their existence inhibits the user's promotion through grades maintained by the system. such grades demonstrating a problem free track record that makes the user more attractive to counterparties.

An example of the process whereby either user can clear a problem transaction from their record will now be outlined. Said process is implemented by Dispute Resolution Module 625 with data stored in Dispute Resolution Records 675. It is centered on an interactive form that builds as dialogue between the parties develops. The form can be forwarded to an arbitrator at any point by either party. Objects of the process described include compelling the user seeking to resolve the problem to (a) provide full details of their own experience relating to the problem (b) interrogate the other party in a reasonable way, the response of the other party being recorded by the system (c) to forward the form to an arbitrator once they believe their case has been established (d) limit their inputs to clear and simple statements (e) complete the process within a pre-agreed timeframe.

Any user can access a list of problem transactions in which they were either buyer or seller by means of the screen illustrated in FIG. 11. Once a problem is reported column 1145 for that transaction reads “Problem Transaction”. By clicking on that column the user is presented with a page that offers the following sections giving the user an overview of the problem:

| | CONTAINS DATA FROM |
|---|---|
| | TRANSACTION DATABASE |
| SECTION | EXTENSIONS 665 COLUMNS: |
| The problem that was | 906, 908, 934, 936, 916 |
| reported | |
| Solution sought | 914, 932 |
| Solution carried out | 946, 948 |
| Actions at the time of | 942, 960, 962, 964, 966 |
| problem | |
| Context of this problem | 938 |

Thus the user is reminded of the problem and how it was resolved together with all pertinent actions by the complainant and information recorded by both parties at the time. If he wishes to resolve this problem he is asked if he will agree to a standard time period for dialogue between the parties, such time period being input through Service Provider Terminal 308 and being for example 14 days. If he does not accept this time period he is able to enter an extension of up to 100% and type in a justification for doing so. His counterparty is granted the same option when first presented with the form. During this agreed time a dialogue can build between both parties but the form they ire Using will be frozen once the time period ends. This is to ensure reasonableness and prompt replies by both parties.

Once he accepts the timetable a toolbar or options appears as illustrated in FIG. 20. This toolbar determines the next step in the dialogue and comprises 3 sections (a) section 2005 shows the time remaining in the timetable for conversation and the number of exchanges so far (b) section 2010 offers the options for a next step in this dialogue (c) section 2060 allows either user to end the dialogue in a variety of ways.

The options available to either user to build further dialogue through section 2010 are explained below:

| | |
|---|---|
| Send | Creates a text entry box in which the user can enter the reason why they believe the fault is |
| message | the other party's. Clicking on a submit button adds that message to the form. |
| Propose | The user is asked to input a range of times when they would be available for an online |
| online chat | conversation using technology such as MSN messenger with the other party. If |
| | counterparty accepts the invitation and specifies a time, said conversation would be |
| | triggered at the agreed time by Dispute Resolution Module 625 inviting both parties to join |
| | at the time they agreed with the resulting conversation recorded in Dispute Resolution |
| | Records 675. |
| Propose | The user is asked to input a range of times when they would be available for a telephone |
| phone call | conversation with their counterparty. If counterparty agrees to a time the initiator of this |
| | option is then presented with a box and asked to type in their record of the conversation, |
| | counterparty is then invited to respond to that record with their own text entry. In an |
| | additional embodiment such calls would be connected through VOIP technology as is well |
| | known in the art and recorded within Dispute Resolution Records 675. |
| Propose | The user is asked to input a range of times and locations when they would be available for |
| meeting | a meeting with their counterparty. If counterparty agrees to a time the initiator of this |
| | option is then presented with a box and asked to type in their record of the conversation, |
| | counterparty is then invited to respond to that record with their own text entry. |
| Contact | Clicking on this option brings up a form with the following fields (a) name of witness (b) |
| witnesses | email for witness (c) phone contact for witness if any (d) relationship of witness to events |
| | under dispute. Witness contact details are thus common knowledge to both parties. Either |
| | user can then send a question to a witness, said questions and their responses becoming an |
| | additional row in the dispute resolution form. |
| Send to | This option can only be selected if the counteryparty has had the last word. A user can not |
| arbitrator | enter a text message and then select “send to arbitrator”. All text sent to the arbitrator must |
| | have been viewed by the other party who would have the option of responding. Selecting |
| | this option sends the form to the arbitration hub as described in the next section of this |
| | document. |
| Never sell to | This can be selected by either party at any time and ensures the counterparty is entered onto |
| other party | either Seller Database 431 or Buyer Database 432 for that user, said record being used by |
| | Transaction Database 433 to exclude that seller from returns in any search by that buyer. |
| File and | The user may not have time to respond at present and is able to select a time when they |
| prompt | wish the system to remind them to respond. |

In a further embodiment either user may be able to scan a document, for instance handwritten instructions that formed part of the instructions to a seller, that is then added to the dialogue with the counterparty's response to the document.

The options for either user to conclusively end the process using selections in section 2060 are explained below:

| | |
|---|---|
| I accept liability | The user is treated as having selected “my fault” in section 1365 of FIG. 13b. The |
| | billing for cancellation of the old transaction and booking of a new one is assigned to |
| | the user with Payment Transfer Module 427 raising an invoice or seeking a transfer of |
| | funds as mandated for the appropriate market sector. |
| I wish to propose | A negotiation process is entered into by the two parties to arrive at a cash settlement. |
| resolution | Techniques for such online discussions are well known to those in the art. |
| We have | If both parties click on this button the dispute is deemed to be over and fault as |
| resolved this | currently allocated. This option is not made available where the system itself has |
| matter | picked up the costs of a failed transaction. |
| I refuse to co- | This option is available for a user who believes their counterparty is pursuing a |
| operate further | specious complaint. Once clicked it ensures no further communication about this |
| | transaction will be sent to that user. The counterparty must then decide whether to send |
| | the form to an arbitrator or let it lie on their record as an unresolved transaction. |

Thus by using section 2010 the users are building the form as a series of chronological entries or proposals by either party. For example if the user sends a message to the other party their message becomes one row in the form and is sent to the other party who is able to select any button form sections 2010 or 2060. Their entry then becomes a second row, and so on as the form builds. The date and time of each entry is recorded in Dispute Resolution Records 675 and displayed on the form. Either user can access the form at any time and add a new entry, even if the last entry was theirs, but neither can delete or amend any existing entry.

At each step in the dialogue both users are reminded of (a) the contractual obligations on sellers to deal with disputes in a particular way that becomes increasingly demanding as they rise through the grades (b) that either side can send the form to an arbitrator at any time (c) that case law exists which can be viewed for background information.

A user involved in one or more of these dialogues at the present time is reminded of such dialogues every time they log on to the system. An amended version of the screen illustrated by FIG. 11 is presented to the user, such screen containing only those transactions for which a dispute resolution dialogue is in progress with transactions listed in order of least time left before the end of time period. An additional column might signify “new entry by other party” for convenience.

In a grouped transaction that is disputed, all buyers and the seller are able to initiate a dispute resolution form. Once such a form is initiated all other buyers and the seller are able to make entries and any of them can forward the form to an arbitrator with the form continuing for the other users until the timer expires. The arbitrator is able to access the most up to date version of the form.

In a further embodiment of the Dispute Resolution process the opening screen could warn each user of the economic consequences of being found to be at fault in this dispute. It would do this through he following steps (a) reading user's current grading and grading to which they would be likely to be demoted according to “case law” inputs if judged at fault in this dispute (b) calculating averaging seller unit price or average buyer unit price for the grade they are currently in (c) calculating averaging seller unit price or average buyer unit price for the grade to which they would probably be demoted (d) multiplying the difference by their average number of units sold over a specified period.

There will be times when a buyer wishes to complain about one of a group of sellers but is not clear which is at fault. For example a guesthouse owner might let out five rooms and find that the occupants of one of those rooms had damaged the house's communal area. In a further embodiment of the above Dispute Resolution process Dispute Resolution Module 625 would automatically direct the process towards the highest grade of the five buyers that night with other users automatically contacted as witnesses. This would be supported by a contractual understanding that high grade users were expected to drive dispute resolution where problems occurred.

### The Arbitration Process

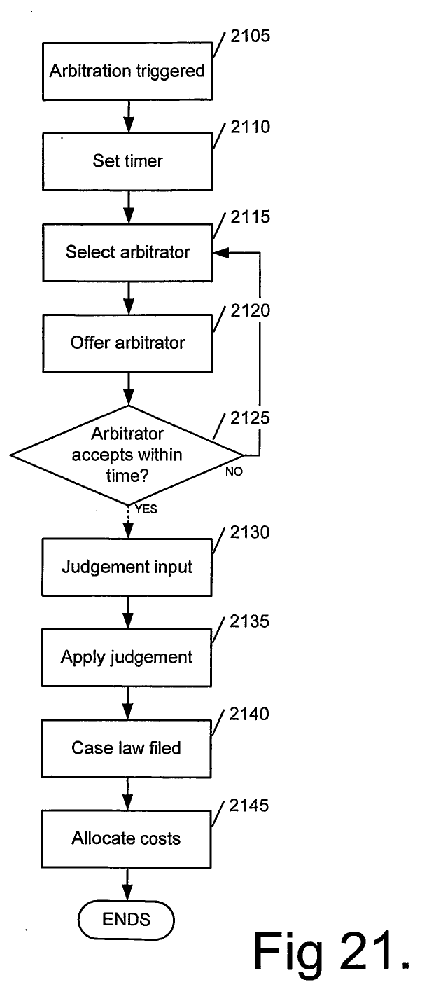

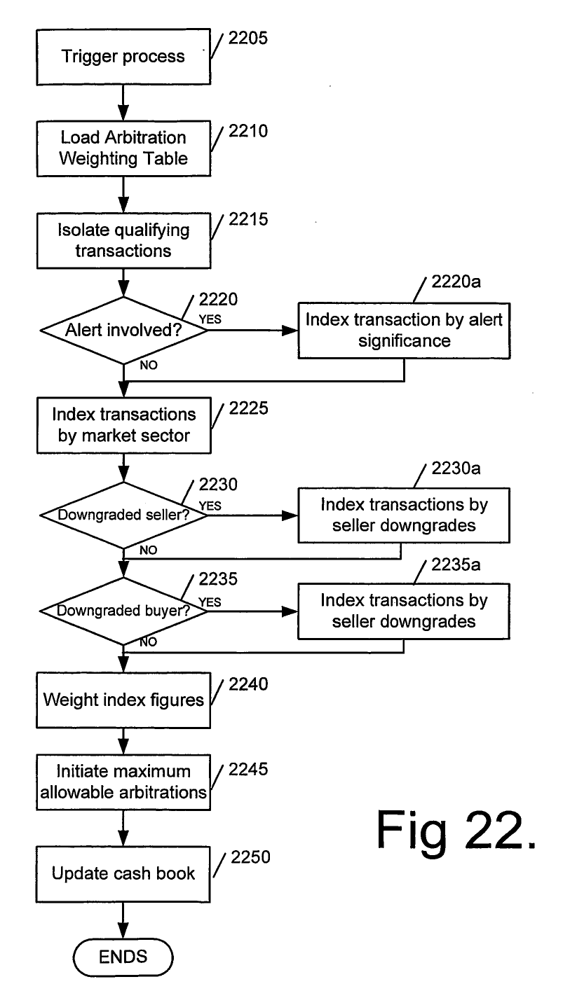

FIG. 21. explains the process by which dispute resolution forms, comprising one or more entries by one or more parties in a dispute can be cleared by arbitration. The process starts at step 2105 when the arbitration process is triggered for a particular disputed transaction.

As already stated, this can be initiated by either party. Additionally a transaction that has been underwritten by the system may automatically be sent to arbitration within a fixed time period input through Service Provider Terminal 308. For example, if a transaction that was underwritten by the system has failed and neither buyer or seller has started the dispute resolution procedure within 14 days of its of its status in Transaction Database 433 changing to “completed” arbitration may automatically be triggered. In a further embodiment arbitration may be triggered automatically when the time period for dispute resolution on an underwritten transaction has been exhausted. The logic for this is that the system has to find and downgrade the traders who cause failed transactions to minimise such transactions which drain its underwriting fund which thereby requires replenishment through a levy on all transactions pushing up costs in the market.

At step 2110 a timer is set within which the case must be resolved, this is to minimise unresolved cases which create uncertainty in the market. A sample period might be 10 days before judgment. At step 2115 Arbitration Hub 630 consults Arbitrator Records 680 to select the most appropriate arbitrator for this case. In its simplest form this might consist of a “GEMs” type market in which qualified arbitrators, able to prove their status with a log on and password, are able to list their availability for handling cases and sell their services competitively with Arbitration Hub 630 selecting the best value individual at the present time. In a preferred embodiment, said market in arbitration services is split into arbitration of each of the five types of problem (area, sector, seller, buyer, group) so that arbitrators specialise in one type for greater knowledge and consistency. Alternatively arbitrators might be designated by the market sector in which they are deemed suitable to judge so that standards are consistent across each individual sector.

At step 2120 the arbitrator selected is contacted and asked to confirm that there is no reason they should decline this case, having personal knowledge of either party for instance would qualify them for resigning the case. Assuming the arbitrator accepts within a time limit that might for example be 24 hours from offer, at step 2125, said arbitrator then has access to (a) the full transaction details as stored on Transaction Database 433 (b) all details input during the original problem reporting as stored on Transaction Database Extensions 665 (c) all inputs by either party to the dispute resolution form as stored in Dispute Resolution Records 675 (d) all relevant precedents stored in Case Law Records 685 (e) any relevant alerts in force at the time of the transaction as archived within Alert Records Store 670 (e) full details of all reports pertaining to an alert related to the present transaction.

Thus the arbitrator has a uniquely detailed instant overview of the transaction and the state of the market in which an alleged problem occurred. In judgment he has to select between the following options (a) buyer breached contract (b) seller breached contract (c) the wording of system contracts is at fault (d) no party is at fault.

It will be appreciated that contracts for transactions must absolve users of responsibility if they do everything required to resolve a problem at the time it occurs. For instance a seller in the minicab market can not be held responsible for delays due to a traffic incident if he is able to show (a) evidence of such incident, for example on a local traffic website (b) that he did everything possible to warn the other party that failure was imminent.

Before inputting judgment the arbitrator is able to conduct a dialogue with either party by email, telephone, or other means. The dispute resolution form adds new rows to accommodate his inputs. If judgment is not input by timer expiry time the arbitrator is deemed in breach of his contractual requirement and his payment might be withheld in proportion to his lateness with subsequent disciplinary proceedings possibly instigated by the system which allows another arbitrator to judge on an arbitrator's failure.

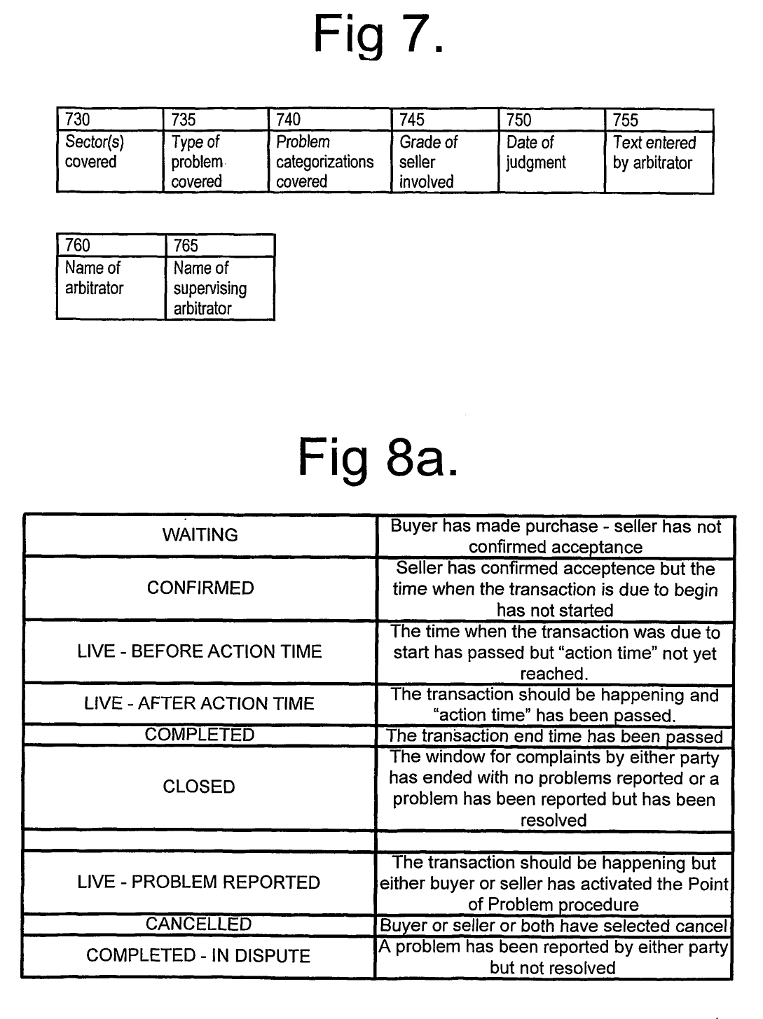

At step 2130 judgment is input by the arbitrator. Punitive costs may be issued against one of the parties with payment due to the system underwriting fund for initially funding a replaced transaction. Any failure to pay within a given timeframe could result in downgrading. That judgement is then notified to the parties at step 2135 with any downgrading of users applied by User Maintenance Module 428. The status of the transaction within Transaction Database 433 is changed to its status if no problem was present. At step 2140 the arbitrator is required to supply a brief paragraph of text about the judgment and why he reached his decision. This is catalogued, without details that identify either party, in Case Law Records 685 as exemplified in FIG. 7. The arbitrator is then paid at the rate at which he was hired at step 2145 with Payment Transfer Module 427 transferring value from a central arbitration fund.

It will be appreciated that the super-users who provide instant oversight on a particular alert and arbitrators may be the same pool of individuals. All would be (a) trusted by the system to take an overview on issues affecting a particular market (b) able to sell themselves competitively to the system with information provided about times of demand and supply in their area of speciality (c) held to account against a particularly demanding contract by the arbitration system in case of careless or inaccurate entries.

It will be appreciated that the chief benefit of the arbitration system outlined above is likely to be a realisation by users that it is better to accept responsibility for errors and underperformance rather than attempting to push the costs of a failed transaction onto either a counterparty or an underwriting fund for failed transactions.

### Compulsory Arbitration Process

It will be clear that not all problem transactions will be sent by one of the parties to arbitration. However, arbitration is important. The system can only maintain standards if disputes are judged impartially and with reference to a code of contractual expectations interpreted in the light of past decisions that are available to all users. This consistency of judgement combined with predictable timetabling of dispute resolution requires professional arbitrators rather than volunteers. The costs of paying a professional arbitrator to look at all disputed transactions would be prohibitive. It is therefore preferable that there be a way of cost effectively sending only those Problem Transactions that potentially destabilize the markets the most to arbitration, possibly at the System Operator's expense.

A problem transaction, one that failed with neither side accepting responsibility, sits on the record of both buyer and seller involved possibly with payment frozen. Either party may clear the transaction by paying for it to go to an arbitrator, probably after provoking some sort of response, or lack of response, from the other party captured in the dispute resolution form already described. But many users will be loathe to pay for arbitration if they believe themselves not to be at fault. The decreasing tolerance for unresolved problem transactions as a user climbs the grades provides an incentive for users to clear such transaction but may not be enough to prompt users to fund arbitration.

It is in the market operator's interest that problem transactions be resolved so that users realise they can not escape responsibility for (a) failure to deliver according to contract or (b) wilful complaining. Additionally, the market operator may be bearing costs associated with replacing failed transactions and thus have an incentive to identify individual users who are causing those failures. Thus users should be aware that not only their counterparty might send a problem transaction in which they are involved to arbitration, but so might the system itself. This creates an incentive for all concerned in a problem transaction to follow reasonable proscribed processes if they believe themselves innocent.

There therefore exists a need for a module which in affect “patrols the market”, deciding which problem transactions will be selected for arbitration at the market operator's expense. In its simplest embodiment said module would select problem transactions randomly. In a preferred embodiment it calculates which problem transactions should be resolved to most effectively (a) clear grouped problem transactions, for instance when a number of problem transactions are related to a group purchase or an alert (b) clear the market operator's liabilities for funding replacement transactions where no blame has been established (c) create new “case law” where there appears to be ambiguity in interpretation of contracts that could reoccur (d) maintains faith in high grade users in a graded market, thereby justifying the premium likely to be charged by such users (e) encourages all users to take problem reporting and dispute resolution seriously because they never know whether a human arbitrator, with power to downgrade the user, is going to read their entries about a problem transaction in which they have been involved at some future point.

The process runs at times determined by rules explained below. It ranks all current problem transactions in order of importance based on the criteria outlined and purchases arbitration for the topmost based on the funds it has available. This offers the market operator a straightforward pay off: the more cash they are willing to put into the fund for arbitration the more the market is “cleaned” of unresolved problem transactions. The process is run by Arbitration Prioritization Module 635 within Problem Application Processor 505.

Rules governing the process are input through Service Provider Terminal 308 and held within Arbitration Prioritization Records 695. Said rules include the maximum cost of an arbitration and the amount of cash to be allocated to arbitration each time the process is triggered. This might be (a) a set figure (b) a percentage of turnover within the system in the interval since the last time the process was triggered (c) a figure that rises with the overall percentage of problem transactions compared to successful transactions within the system (d) the sum of a levy imposed on all, or specified, transactions within the system.

The process of prioritizing Problem Transactions within the system for arbitration will now be described in detail with reference to FIG. 22. At step 2205 the enforced arbitration process is triggered. This could be (a) manually through Service Provider Terminal 308 (b) by a timer so that, for instance, the module sweeps the system once a day or once a week (c) when problem transactions as a percentage of successfully completed transactions exceed a percentage input through Service Provider Terminal 308 (d) when the total monetary value of all problem transactions exceeds a figure input through Service Provider Terminal 308.

At step 2210 Arbitration Prioritization Module 635 loads current arbitration prioritization rules held in Arbitration Prioritization Records 695. In its simplest embodiment this is simply the amount or cash that can be spent on arbitration within this run of the process. The process must now rank all outstanding Problem Transactions that are not being resolved. That is they: (a) do not currently have a dispute resolution process within the timer settings in progress (b) are not already being considered by an arbitrator. It does this at step 2215. Having isolated said Problem Transactions the Arbitration Prioritization Rules may specify additional rules, for example that transactions involving both buyer and seller below a particular grade be excluded so the process focuses on transactions where an expectation of high standards must be maintained. Thus a list of qualifying Problem Transactions is isolated. These transactions must now be indexed according to the importance that they be resolved.

At step 2220 Transaction Records Extensions 665 for each transaction is scanned to check if box 920 as illustrated in FIG. 9a contains an alert reference number signifying the user related this problem to an alert. If so, at step 2220a, the transaction must be indexed based on the importance of resolving that alert. This process (a) reads alert volatility from Transaction Records Extensions 665, information being held in column 829 as represented by FIG. 8b. (b) multiplies volatility figure by total alert liability as stored in column 827 (c) multiplies this figure by the most recent Totalised Report Weighting for that user's reports within that alert. Thus a particularly high figure signifies an alert that could have been costly to the market operator, where there was considerable differences of opinion between users who should have been impacted by the alleged problem and the individual user strongly asserted there was a significant problem. This index figure is added to Transaction Records Extensions 665 within column 968 as represented by FIG. 9a.

In an alternative embodiment Problem Transactions involving an alert would be weighted for proximity to the alert “going negative”. Thus a report would be weighted by the total opinion weighting that followed it. The aim is to isolate users who were the last to claim they couldn't complete their transaction before a problem was judged over by other users. This creates an incentive for users to try to find their way round problems that generate alerts.

At step 2225 the process divides the list of qualifying transactions into market sectors. It then calculates qualifying transactions as a percentage of all transactions within the whole market in the period since this process last ran. That percentage is then recorded next to each qualifying transaction in Transaction Records Extensions 665 within column 968. A higher figure at this stage indicates the Problem Transaction is indicative of several such problems within a market that may require “case law” to further clarify what can be reasonably be expected of buyer and sellers at particular grades. In an additional embodiment step 2225 could break qualifying transactions down by type of problem, or category of problem, as illustrated in FIG. 10. thereby producing percentages that isolated and weighted specific problems within market sectors.

Step 2230 and 2235 prioritize key transactions involving individual users who are not resolving their Problem Transactions but could reasonably be expected to by their counterparties. A user who exceeds the tolerance for unresolved Problem Transactions pertaining to their grade has the choice of (a) resolving Problem Transactions with the dispute resolution process and, if that doesn't work, with arbitration which it should be in the user's interest to fund so they can continue in a premium grade. However, some users will chose to ignore Problem Transactions and they will be downgraded automatically by the system after a period that might be for example 5 days. Ideally, these transactions need to be resolved to protect the counterparties.

Thus, at step 2230, the process reads Seller Database 431 and checks if the seller has been downgraded since the last time the process ran. Where this is the case, at step 2230a, it indexes each transaction involving that seller by multiplying (a) the number of grades by which the individual was demoted (b) the Allowable Liability as stored in Transaction Records Extensions 665, column 952 (FIG. 9a). The Allowable Liability figure is the maximum sum the system's underwriting fund would have paid to compensate the wronged party or reschedule the failed transaction. In the case of a group transaction the Allowable Liability to each buyer is totalled. This figure is added to column 968 as before. Thus a seller who has allowed a large number or high value of Problem Transactions to accrue without action incurs a high figure.

Step 2235 and 2235a repeat the above process with the buyer involved in a transaction. It reads Buyer Database 432.

Thus, within Transaction Records Extensions 665 column 968 there is now up to four potential index FIGS. relating to the importance of each qualifying transaction being resolved for the benefit of all market users. It will be appreciated that these figures may need to be weighted before ranking the list because (a) some of the calculations above will produce very large figures, the indexing based on alerts for instance could produce a three digit figure, while the unweighted market sector index figure is likely to be a single digit number, thus figures need to be equalised for valid weighting (b) the market operator may wish to weight the selection of transactions to be resolved towards particular kinds of problem at different times. This can be achieved by inputting new figures for multiplication into the weighting table through Service Provider Terminal 308.

The weighting table is stored in Arbitration Prioritization Records 695 and applied at step 2240. An exemplary table is shown below:

| | | MARKET | | |
|---|---|---|---|---|
| | ALERT | SECTOR | SELLER | BUYER |
| | VOLATILITY | PROBLEMS | DOWNGRADES | DOWNGRADES |
| | INDEX | INDEX | INDEX | INDEX |
| UNWEIGHTED | 132 | 1.6 | 30 | 0 |
| INDEX FIGURE | | | | |
| MULTIPLY | 1 | 100 | 2.5 | 1.5 |
| INDEX FIGURE | | | | |
| BY: | | | | |
| FINAL INDEX | 132 | 160 | 75 | 0 |
| FIGURE | | | | |

Thus the transaction above has a total weighted Arbitration Prioritization Index of 367 (the final index figures totalled). This figure is stored within column 968 with column 968a amended to show the weighting has been applied.

It is now clear that Arbitration Prioritization Module 635 has produced a list of transactions that could qualify for paid arbitration and produced a prioritization figure for each one. At step 2245 it takes the cash available and divides it by the maximum cost of arbitration, both figures loaded from Arbitration Prioritization Records 695 at step 2210. The resulting figure, rounded down to a whole number, is then the number of Problem Transactions to be resolved by the process at this time. Starting with the transaction with the highest Prioritization Index the process works down the list initiating compulsory arbitration up to the maximum permissible number. The records in column 968 and 968a are then wiped.

The process of initiating compulsory arbitration involves the following steps (a) the dispute resolution opening screen is sent to all parties involved in the transaction with a notice telling them that the form will be sent to an arbitrator once the timer has completed, the timer starting immediately (b) authorising Payment Transfer Module 427 to pay the cost of arbitration using funds from a compulsory arbitration account.

At step 2250 the accounts of the compulsory arbitration account are updated to show (a) total committed costs of arbitration (b) remaining funds. It will be clear that not all the arbitrations commissioned will cost the full amount budgeted and there will be a surplus accruing in this account. Using Service Provider Terminal 308 the market operator can dictate whether the surplus is (a) kept as a surplus for transfer to another account at any point or (b) added to the compulsory arbitration fund the next time Arbitration Prioritization Module 635 is triggered.

One benefit of the process so described is that Problem Transactions can be selected for compulsory arbitration some time after they occurred. If problems build up in a particular market sector or one party in a transaction starts to allow unresolved problems to accrue then a particular problem can qualify. Thus, users can not assume a problem that they ignore will never trouble them.

In a further embodiment, problem transaction weightings might factor in the current number and value of problem transactions of the two parties involved. Thus a seller who incurs a problem transaction flag in one of their transactions stored in Transactions Records Extensions 665 because of a dispute with a buyer who has a large percentage of outstanding problem transactions compared to successful transactions has their problem transactions weighted less than a seller with an otherwise identical problem transaction involving a buyer with a low percentage of problem transactions. Likewise a user with an already high percentage of outstanding problem transactions might incur increasingly heavy weighting as new problem transactions are incurred. Users are thus made even more cautious of “using up” their quota of acceptable problem transactions for a particular grade.

In a further embodiment, users may be weighted for the time they take to resolve problem transactions. Thus a user who immediately initiates the dispute resolution process incurs a lower weighting on outstanding problem transactions than one who consistently waits for the other side to begin the process.

In an alternative embodiment of Arbitration Prioritization Module 635, step 2215 would include Problem Transactions currently engaged in a dispute resolution process but not yet at arbitration. If said transactions then qualified for paid arbitration it would inform the users involved and forward the dispute resolution form automatically when the timer expired.

In a further embodiment of the above, the qualifying transactions would attract only a portion of the funds required for arbitration, perhaps 50%. This would encourage those users who believed themselves to be innocent to provide the additional funding for arbitration while spreading the available funds over the maximum number of qualifying transactions.

Descriptions of the system above have assumed a wide ranging system of markets. The invention applies equally to a narrow range of markets, for example a market for secretarial services with sectors covering medical, legal, educational and commercial secretaries as a system of markets.

In above described embodiments of the system the Internet, and more specifically web technology, is used for communication between a central computer system and the buyers and sellers. However, it is not necessary to implement the invention using the Internet and the system may, for example, be implemented on local or wide area networks, wireless mobile communications networks, cable tv networks and the like. Similarly, the terminals used by the buyers and sellers for communicating with the central computer system may comprise mobile phone handsets, personal digital assistants, inter-active televisions and the like. Likewise, as it is well known to those skilled in the art, the processing for performing the functions described above may be shared between machines in ways other than that shown in the illustrated embodiments.

No doubt many other affective alternatives will occur to the skilled person and it will be understood that the invention is not limited to the described embodiments and encompasses modifications apparent to those skilled in the art lying within the spirit and scope of the claims appended hereto.

1. A transaction management system for managing the purchase of a service by a buyer from a seller, the system comprising:
a data store for storing seller data comprising, for each of a plurality of sellers:
a seller identifier;
a seller grade dependent on at least one of the number of successfully completed transactions involving the seller and the number of disputed problems associated with transactions involving the seller; and
seller offer data indicating at least one service offered for sale and an availability record for the service;
a program store storing processor implementable instructions; and
a processor coupled to the data store and to the program store for implementing the stored instructions; wherein the stored instructions comprise instructions for controlling the processor to:
implement a buyer interface to receive a purchase inquiry from a buyer, the purchase inquiry comprising a plurality of purchase criteria;
output seller offer data for a plurality of sellers able to meet the purchase criteria; and
receive a purchase request from the buyer accepting a said offer, thereby creating a transaction;
wherein the data store is further for storing transaction data comprising, for each of a plurality of transactions, a transaction identifier, a transaction status, a buyer identifier and a seller identifier;
wherein the stored instructions further comprise instructions for controlling the processor to implement a problem report interface to receive a problem report for a problem associated with a transaction;
and wherein the data store is further for storing problem data comprising, for each of a plurality of problems associated with transactions, a problem identifier, a transaction identifier and a problem report received by the problem report interface.

2. The system of claim 1, wherein the plurality of purchase criteria include a service requirement and a date and time range requirement for the service.

3. The system of claim 1, wherein the problem report interface is implemented to receive the problem report from a buyer and, at the request of the buyer, to create a replacement transaction for the buyer.

4. The system of claim 1, wherein the problem report interface is implemented to create a replacement transaction for the buyer by:
receiving an updated purchase inquiry from the buyer, the purchase inquiry comprising a plurality of updated purchase criteria;
outputting seller offer data for a plurality of sellers able to meet the updated purchase criteria; and
receiving a purchase request from the buyer accepting a said offer, thereby creating a replacement transaction.

5. The system of claim 1, wherein the transaction data further comprises, for each of the plurality of transactions, a guaranteed or underwritten status, and wherein the problem report interface is further implemented to create a replacement transaction for the buyer in dependence on the guaranteed or underwritten status of the problem transaction.

6. The system of claim 1, wherein the data store is further for storing seller extension data comprising, for each of a plurality of sellers, a seller identifier and cancellation charging data, and wherein the stored instructions further comprise instructions for controlling the processor to award compensation to the seller in dependence on the cancellation charging data for the seller.

7. The system of claim 1, wherein the data store is further for storing alert data comprising, for each of a plurality of alerts, an alert identifier, an alert status and a description of a known problem, and wherein the problem report interface is further implemented to notify the buyer or seller of alert data which is relevant to the problem.

8. The system of claim 1, wherein the problem report interface is further implemented to receive an indication of whether the problem will affect other transactions as part of the problem report.

9. The system of claim 1, wherein, in the case of a disputed problem, the dispute resolution interface is implemented to receive problem related information from the buyer and seller and to make the problem related information available to the buyer and seller.

10. The system of claim 1, wherein, in the case of a disputed problem, the dispute resolution interface is further implemented to enable the buyer and seller to enter into a time limited dispute resolution dialogue, and wherein the problem data in the data store is updated to cancel the problem if the dispute resolution dialogue resolves the problem within the time limit.

11. The system of claim 1, wherein, in the case of a disputed problem, the dispute resolution interface is further implemented to enable the buyer or seller to refer the problem to an arbitrator, and wherein the arbitrator determines liability.

12. The system of claim 1, wherein, in the case of a disputed problem, the stored instructions further comprise instructions for controlling the processor to automatically refer a disputed problem to an arbitrator, wherein the decision to refer a disputed problem to an arbitrator is dependent on at least one of:
the number of transactions affected by the disputed problem;
a guaranteed or underwritten status of the transaction;
the presence of a widespread contractual ambiguity requiring clarification; and
a grade of at least one of the buyer and seller; and
wherein the arbitrator determines liability.

13. The system of claim 1, wherein in the case of a disputed problem, the stored instructions further comprise instructions for controlling the processor to:
implement an arbitrator interface to receive a judgement from the arbitrator, the judgement comprising an indication of liability; and
notify the buyer and the seller of the judgement received from the arbitrator.

14. The system of claim 1, wherein the data store is further for storing case law data comprising a plurality of judgements for disputed problems and problem related information for the problems.

15. The system of claim 1, wherein the stored instructions further comprise instructions for controlling the processor to, provide relevant case law data to buyers, sellers and arbitrators.

16. The system of claim 1, wherein the stored instructions further comprise instructions for controlling the processor to:
determine the other transactions which will be affected by the problem on the basis of the problem report; and
notify buyers and sellers of the other affected transaction of the problem.

17. The system of claim 1, wherein the stored data relating to problem transactions comprises a measure of how early the seller has submitted problem reports for problems associated with their transactions for which they accept liability.

18. The system of claim 1, wherein the data store is further for storing buyer data comprising, for each of a plurality of buyers, a buyer identifier and a buyer grade, and wherein the buyer grade for each buyer is dependant on stored data relating to problem transactions.

19. The system of claim 1, wherein, the stored instructions further comprise instructions for controlling the processor to generate a contract between the buyer and the seller of a transaction, the terms of the contract depending on at least one of a buyer grade and a seller grade of the buyer and seller respectively.

20. A transaction management system for managing the purchase of an item and/or service by a buyer from a seller, the system comprising:
a data store for storing seller data comprising, for each of a plurality of sellers, a seller identifier;
a program store storing processor implementable instructions; and
a processor coupled to the data store and to the program store for implementing the stored instructions; wherein the stored instructions comprise instructions for controlling the processor to;
implement a buyer interface to receive a purchase inquiry from a buyer;
output seller offer data for a plurality of sellers; and
receive a purchase request from the buyer accepting a said offer, thereby creating a transaction;
wherein the stored instructions further comprise instructions for controlling the processor to implement a problem report interface to receive a problem report for a problem associated with a transaction, and wherein the seller data in the data store further comprises, for each of the plurality of sellers, a seller grade, wherein the seller trade is dependent on a measure of how early the seller has submitted problem reports for problems associated with their transactions for which they accept liability.

21. A transaction management system for managing the purchase of an item and/or service by a buyer from a seller, the system comprising:
a data store for storing seller data comprising, for each of a plurality of sellers, a seller identifier;
a program store storing processor implementable instructions; and
a processor coupled to the data store and to the program store for implementing the stored instructions; wherein the stored instructions comprise instructions for controlling the processor to;
implement a buyer interface to receive a purchase inquiry from a buyer; output seller offer data for a plurality of sellers; and
receive a purchase request from the buyer accepting a said offer, thereby creating a transaction;
wherein the stored instructions further comprise instructions for controlling the processor to;
implement a problem report interface to receive a problem report from the buyer or seller for a problem associated with a transaction, the problem report including an indication of liability for the problem;
implement a dispute resolution interface if a problem report received from the buyer or seller indicates that the other is liable for the problem, thereby creating a disputed problem; and
automatically refer a disputed problem to an arbitrator, the decision to refer a disputed problem to an arbitrator being dependent on at least one of:
the number of transactions affected by the disputed problem;
a guaranteed or underwritten status;
the presence of a widespread contractual ambiguity requiring clarification; and
a grade of at least one of the buyer and seller,
wherein the arbitrator determines liability.

22. A transaction management system for managing the purchase of an item and/or service by a buyer from a seller, the system comprising:
a data store for storing seller data comprising, for each of a plurality of sellers, a seller identifier;
a program store storing processor implementable instructions; and
a processor coupled to the data store and to the program store for implementing the stored instructions; wherein the stored instructions comprise instructions for controlling the processor to;
implement a buyer interface to receive a purchase inquiry from a buyer;
output seller offer data for a plurality of sellers; and
receive a purchase request from the buyer accepting a said offer, thereby creating a transaction;
wherein the stored instructions further comprise instructions for controlling the processor to;
implement a problem report interface to receive a problem report from the buyer or seller for a problem associated with a transaction and inform the buyer or seller of known problems which are relevant to the transaction;
request and receive further information about the problem from other buyers and sellers; and
notify other buyers and sellers of the problem.

23. A transaction management system for managing the purchase of an item and/or service by a buyer from a seller, the system comprising;
a data store for storing seller data comprising, for each of a plurality of sellers, a seller identifier;
a program store storing processor implementable instructions; and
a processor coupled to the data store and to the program store for implementing the stored instructions; wherein the stored instructions comprise instructions for controlling the processor to;
implement a buyer interface to receive a purchase inquiry from a buyer;
output seller offer data for a plurality of sellers; and
receive a purchase request from the buyer accepting a said offer, thereby creating a transaction;
wherein the stored instructions further comprise instructions for controlling the processor to;
implement a problem report interface to receive a problem report from the buyer or seller for a problem associated with a transaction, the problem report including an indication of liability for the problem;
implement a dispute resolution interface if a problem report received from the buyer or seller indicates that the other is liable for the problem, wherein the dispute resolution interface is implemented to:
enable the buyer and seller to enter into a time limited dispute resolution dialogue; and
provide the buyer and seller with stored information about relevant transactions and the dispute resolution dialogue.

24. A method for managing the purchase of a service by a buyer from a seller, the method comprising:
storing in a data store seller data comprising, for each of a plurality of sellers:
a seller identifier;
a seller grade dependent on at least one of the number of successfully completed transactions involving the seller and the number of disputed problems associated with transactions involving the seller; and
seller offer data indicating at least one service offered for sale and an availability record for the service;
implementing a buyer interface to receive a purchase inquiry from a buyer, the purchase inquiry comprising a plurality of purchase criteria;
outputting seller offer data for a plurality of sellers able to meethe purchase criteria; and
receiving a purchase request from the buyer accepting a said offer, thereby creating a transaction;
further storing in the data store transaction data comprising, for each of a plurality of transactions, a transaction identifier, a transaction status, a buyer identifier and a seller identifier;
implementing a problem report interface to receive a problem report for a problem associated with a transaction;
further storing in the data store problem data comprising, for each of a plurality of problems associated with transactions, a problem identifier, a transaction identifier and a problem report received by the problem report interface.

25. The method of claim 24, wherein implementing the problem report interface comprises receiving the problem report from a buyer and, at the request of the buyer, creating a replacen˜nt transaction for the buyer.

26. The method of claim 24, wherein the implementing the problem report interface further comprises:
receiving an updated purchase inquiry from the buyer, the purchase inquiry comprising a plurality of updated purchase criteria;
outputting seller offer data for a plurality of sellers able to meethe updated purchase criteria; and
receiving a purchase request from the buyer accepting a said offer, thereby creating a replacement transaction.

27. The method of claim 24, wherein the transaction data further comprises, for each of the plurality of transactions, a guaranteed or underwritten status, and wherein implementing the problem report interface further comprises creating a replacement transaction for the buyer in dependence on the guaranteed or underwritten status of the problem transaction.

28. A method for managing the purchase of an item and/or service by a buyer from a seller, the method comprising:
storing in a data store seller data comprising, for each of a plurality of sellers, a seller identifier;
implementing a buyer interface to receive a purchase inquiry from a buyer;
outputting seller offer data for a plurality of sellers,
receiving a purchase request from the buyer accepting a said offer, thereby creating a transaction; and
implementing a problem report interface to receive a problem report for a problem associated with a transaction,
wherein the seller data further comprises, for each of the plurality of sellers, a seller grade, wherein the seller grade is dependent on a measure of how early the seller has submitted problem reports for problems associated with their transactions for which they accept liability.

29. A method for managing the purchase of an item and/or service by a buyer from a seller, the method comprising:
storing in a data store seller data comprising, for each of a plurality of sellers, a seller identifier,
implementing a buyer interface to receive a purchase inquiry from a buyer;
outputting seller offer data for a plurality of sellers,
receiving a purchase request from the buyer accepting a said offer, thereby creating a transaction;
implementing a problem report interface to receive a problem report from a buyer or seller for a problem associated with a transaction, the problem report including an indication of liability for the problem;
implementing a dispute resolution interface if a problem report received from the buyer or seller indicates that the other is liable for the problem, thereby creating a disputed problem; and
automatically referring a disputed problem to an arbitrator, the decision to refer a disputed problem to an arbitrator being dependent on at least one of:
the number of transactions affected by the disputed problem;
a guaranteed or underwritten status;
the presence of a widespread contractual ambiguity requiring clarification; and
a grade of at least one of the buyer and seller,
wherein the arbitrator determines liability.

30. A method for managing the purchase of an item and/or service by a buyer from a seller, the method comprising:
storing in a data store seller data comprising, for each of a plurality of sellers, a seller identifier;
implementing a buyer interface to receive a purchase inquiry from a buyer;
outputting seller offer data for a plurality of sellers;
receiving a purchase request from the buyer accepting a said offer, thereby creating a transaction;
implementing a problem report interface to receive a problem report from a buyer or seller for a problem associated with a transaction and inform the buyer or seller of known problems which are relevant to the transaction;
requesting and receiving further information about the problem from other buyers and sellers; and
notifying other buyers and sellers of the problem.

31. A method for managing the purchase of an item and/or service by a buyer from a seller, the method comprising:
storing in a data store seller data comprising for each of a plurality of sellers, a seller identifier;
implementing a buyer interface to receive a purchase inquiry from a buyer;
outputting seller offer data for a plurality of sellers;
receiving a purchase request from the buyer accepting a said offer, thereby creating a transaction;
implementing a problem report interface to receive a problem report from a buyer or seller for a problem associated with a transaction, the problem report including an indication of liability for the problem; and
implementing a dispute resolution interface if a problem report received from the buyer or seller indicates that the other is liable for the problem, wherein implementing the dispute resolution interface comprises:
enabling the buyer and seller to enter into a time limited dispute resolution dialogue; and
providing the buyer and seller with stored information about relevant transactions and the dispute resolution dialogue.

32.-72. (canceled)
